(19) United States
(12) Patent Application Publication
(10) Pub. No.: US 2004/0268104 A1
(43) Pub. Date: Dec. 30, 2004

(54) General purpose fixed instruction set (fis) bit-slice feedback processor unit/computer system

(76) Inventor: Benjamin Jonathon Cooper, Boulevard, CA (US)

Correspondence Address: Benjamin Jonathon Cooper, 39204 Opalocka, Boulevard, CA, 91905, US

(21) Appl. No.: 10/490,964

(22) PCT Filed: Sep. 16, 2002
(86) PCT No.: PCT/US02/29534

Related U.S. Application Data
(60) Provisional application No. 60/326,170, filed on Oct. 1, 2001.

(51) Int. Cl. G06F 9/00

(52) U.S. Cl. 712/245

(57) ABSTRACT

A computer system wherein the FIS processor unit, as well as part, or all, of the FIS processor unit's support chips have been constructed in such a way as to shift the emphasis of design away from the use of logic gate technology (i.e. AND gates, OR gates, NOR gate and the like) and placing the said emphasis of design exclusively, or almost exclusively upon that of the use of a unique form of memory technology; i.e. specially designed mirco-memory circuits, to be called core memory circuits, that are then linked together to create a new form of lookup tables and a new form of memory-based finite state machines.

That these new forms of lookup tables and memory-based finite state machines will be able to accomplish what, up to now, has been accomplished circuits composed of large numbers of logic gates: that of the carrying out all of the various functions necessary to accomplish all of the various instructions that compose the instruction sets of the present-day FIS microprocessors, be they specialized FIS processors or general-purpose FIS processors). In addition, this shift in the design and construction of FIS processor units and its support circuitry, be it specific or general, will allow a whole new range of instructions to incorporated into these new FIS processor unit. These new instructions will these said FIS processors to accomplish a wide new range of mathematical and algorithmic functions: instructions that are now not found in the instruction sets of any of the various present FIS processor units manufactured from a multiplicity of logic-gated circuits consisting of AND and/or OR gates, shift registers, flip-flops and the like. This expansion of the processor will allow the overall capacity of computer systems around these said FIS processors to expand substantially.

### BACKGROUND OF THE INVENTION

1. Technical Field

This invention relates to general purpose FIS processor units, as well as general purpose FIS microprocessor units, and the computers that are built around them.

2. Background Art

Since the conception of the first electronic computers in the late 1930's and early 1940's, one of the great determining factors in the development of these devices and the industry that they gave rise to has been is the cost of the hardware. On examining the history of this industry one soon discovers that the influence of this significant determining factor in the design of computers was more profound and more pronounced the closer one comes to the origins of this industry, that of the first electronic computers constructed in the late 1930's.

As to just how influential this factor has been in the advance of this device, consider one particular epic in the development of the computer, that of the early 1970s. During this epoch of computer development an adage was occasionally passed about in this industry; an adage that gave clear expression to the magnitude of the costs of computer hardware at that particular time. And that adage was,

“A mill a meg!

And what this meant was that to buy but one megabyte of 16 bit RAM, an individual, or more likely an institution, would need to pay roughly one million 1970's dollars to acquire that product. That was just one megabyte of memory. As for the rest of the components needed to have a fully functioning general purpose FIS computer system—that of a general purpose FIS processor unit, large drum hard disks, tape backup and the like—these additional components carried a comparable price to that of the RAM memory. So during the early to mid 1970's, a 16-bit computer that contained 5 megabytes of RAM and that ran at 20 megahertz would cost approximately six to eight million dollars. This was the cost of the “hardware.” Then when the cost of the “software” that was needed to make the system a viable machine—operating system, data analyzing and graphing programs and the like—the total cost for the whole of the system would have been around ten million dollars.

This was the average cost of computers in the early to mid 1970's. But on examining earlier periods of development of computers, one finds that the ratio of cost to performance climbs, and climbs exponentially. As a result of these astronomical costs and the low performance of this hardware in the early stages of development in this industry, the founders of this industry—those computer engineers that built the first electronic computer systems—did whatever they could to minimize the amount of hardware used and maximize its performance.

And as for the evolution and development of the very core of these machines, that of the general purpose FIS processor unit, it was in no way except form the powerful dictates set down by the cost of hardware. Because of this, the developers of the early generations of the general purpose FIS processor units quickly and most forcefully learned that the most effective way to produce a cost effective general purpose FIS processor unit was to construct it out of a multiplicity of logic circuits such as AND or OR gates, flip-flops, etc,. The first logic circuits they built were constructed out of the only active electronic components available to them at that time; that of the electromechanical relay and the vacuum tube.

Then in the late 1940's several geniuses at Bell Labs created out of the concepts of quantum physics the first solid state transistor. Once this device was created, it was not long before it was replacing the vacuum tube as the active component of the general purpose FIS processor unit. Then after roughly a decade of use and advancement of discrete solid-state transistors, the engineers determined how to place more than one electronic component (i.e. transistor, resistor, capacitor and the like) onto a single semiconductor crystal such as silicone. This was done by way of photolithography; a process inspired by the much older photographic technology. Then once this latter method was in use, the building of general purpose FIS processors began to change, and change quickly. Once this method of photolithography was set into motion, the electrical engineers improved and advanced it; making ever more intricate and ever more involved integrated circuit chips with the passing of time. Until, during the late 1960's, when a group of men at Intel Corporation were able to place enough circuits on a single chip to create an entire general purpose FIS processor unit. This gave birth to the first microprocessor.

And once created the microprocessor began to evolve rapidly, following in lock step the improvement of the photolithographic technology. It was soon recognized by many in the computer industry that this pattern of improvement could be continued for many decades to come. In fact, one of the founders of the Intel Corporation, Dr. More, explicitly identified this pattern and stated it as follows: That the logic circuit based processor would double in computational power every eighteen months.

But always in this ever advancing trend towards ever more intricate and powerful general purpose FIS processor units, from those first made from discrete units to those produced upon a single chip, the fundamental factor of “hardware” costs played an ever present, ever important role in what was done and what was not done by the engineers. It always caused them to strive to optimize the use of the then available “hardware” resources.

This then was one of the major lines of development in the electronics industry that took place over the last three quarters of a century and which is important to the device being presented in this patent.

But there was another line of development in the overall electronics industry that took shape during this same period of time and which, to the device being discussed in this patent application, is of great importance. That development was the development of the specialized computer, as distinguished from the general purpose computers built around general purpose FIS processor units. These specialized machines were, in general, built up around the concept of bit-slice (feedback) programming, also know as bit-state programming; a very specialized form of programming that is, in many ways, the most elemental and most rudimentary type of programming known to man; a programming technology that comes closest to mimicking that of the most basic computing concepts set down by Dr. Turing in the 1930's. Because it is so basic and so elemental, this type of programming is one of the most powerful types of operationally realizable programming technologies known to man.

As for the nature of this programming technology, it consists of nothing more than writing a sequence of code (which, up until now, has been in a binary form) wherein each step in the progress of the program is determined from two inputs. The first input is that which is provided from the “outside” world. Generally, this is done by converting one or more analog electronic signals into a digital format which is then fed directly into the “computer” (i.e. the addressing lines for a memory chip). As for the second type of input into this special type of program, it consists of the binary code itself; that is, part, if not all, of the binary code of the previous step is fed back into this computer system as part of the addressing value for the next location in memory to be read; that is, the next step in the program. This action of taking some of the output and using it as input to the same memory circuits introduces into the system what is called feedback.

However, in order for this type of computer to be useful, not only does it have to receive and respond to inputs from the “outside” world, the system using bit-slice feedback programming must also, in some way, provide a means to affect the “outside” world. In bit-slice feedback programmed computers, the task of influencing the external world is accomplished by the simplest of means; having a part of the binary output from the memory chip serve as an electronic signal that will cause, when it is necessary, the required changes to take place in the “outside” world—a signal that, in most of the previous uses of this technology, involved passing it through a digital to analog converter before sending it to the rest of the system.

Now as for the base minimum hardware requirements to produce such a bit-slice feedback computer, it consists of four components: a memory chip, a hold register (in some cases the hold register can be dropped from the system if the memory chip can be controlled by a clock input without developing feedback instability), a clock and a circuit board.

For creating this particular type of computer, the computer engineers who designed them followed a very specific line of reasoning; a line of reasoning that began by clearly identifying the very specific goals and aims that these computers needed to accomplish. Then, once they had done this, the computer engineers would create flow charts that determined how the specialized computers would accomplish the particular task that this computing machine would need to fulfill. Then once the flow charts had been produced, the engineers would then assign the appropriate binary code to each point, or node, on their flow charts. Then after this had been done the engineers would then enter their code, generally in binary form, into memory circuits (in this type of computer system nonvolatile memory circuits was preferred over that of volatile memory circuits). Then they would mount their programmed chips onto electronic circuit boards that contained the rest of the electronics of their specialized computers. Once this was done, these computer systems were then ready to carry out whatever specialized functions they had been designed to do.

As for why this type of circuit was created in the first place, there were five basic reasons for it:

1. This type of circuitry was far easier to design and construct than analog electronic systems. The latter systems, analog electronic systems, were the first type of electronic feedback control systems that were ever built. But in so far as feedback control systems are concerned, it was, and still is, true that bit-slice feedback programmed computers are far more proficient in this type of task than are analog electronic systems when a certain amount of “logical” functionality needs to be built into the system.

2. In the early days of the computer industry, these types of computers—bit-slice feedback programmed computer—were the only kinds of computers that could be made to operate in small, confined spaces with limited power supplies and limited cooling systems.

3. In the early days of microprocessors, computers based upon bit-slice feedback programming were, in general, faster in their operations for specialized tasks than were microprocessors.

4. In those cases where computers were applied to specialized tasks, the hardware requirements were, in general, far less for bit-slice feedback programmed computers than they were for computers built around general purpose FIS microprocessors.

5. Specialized computers built around bit-slice feedback programming—since they were built around memory circuits rather than active logic circuits placed on semiconductor chips—required less power to operate when all else was equal (i.e. the same transistor technology was used in both, for example).

These then have been the reasons why, in the past, bit-slice feedback programmed devices, bit-state memory devices, have been preferred in specialized tasks over both analog electronic systems and that of computers built around the early generations of the general purpose FIS processor units.

Finally, there is one other device that has been developed and used to modest degree in the electronics industry for the last thirty years—what in this patent application will be called a bit-mapping process device. This type of device has been used, up until now, for two primary functions. The first usage has been to reduce the number of bits that needed to be fed from one subsystem to other subsystems within a given digital electronic system. The second usage has been to translate many different internal states, many different combinations of bits, within a given system into just one specific outgoing internal state or specific combination of bits. This latter type of process is often called, in relational database systems, as the many to one function.

But now there is a third usage to which this type of device, a bit-mapping process device, can be applied and which is vitally important to the general purpose FIS processor unit that is being identified as new in this patent application. Which is to quickly and effectively answer all manner of mathematical and algorithmic questions as well to provide answers to all types of bit byte and word manipulations.

As for the nature of the bit-mapping process, it consists of one or more memory circuits (generally nonvolatile in nature) being linked together both in parallel and in stages and the said memory circuits being properly preprogrammed. These linked memory circuits can, with the proper programmed memory values, be used to translate various input states into another set of output states.

And in closing this short history of the prior art for this new device, the primary distinction between bit-slice feedback programming devices and bit-mapping devices needs to be made. The main distinction between them is that feedback is used in the first but not in the second.

### DISCLOSURE OF INVENTION

This now brings us to the discussion of the device that is being submitted for patent approval in this patent application: The use of bit-slice feedback programming not to produce a specialized computer to do specialized task, as it has been used in the past, but to use this technology in conjunction with the bit-mapping technology to create a wide range of fully functional general purpose FIS processor units for use in both special purpose and general purpose computer systems; a general purpose FIS processor unit that will require little in the way of logic circuits such as AND or OR gates, flip-flops and the like except in the addressing systems of the memory circuits, which can, if necessary, be replaced by comparator circuits. Also, a few logic gates may be needed in the few shift registers, hold registers, and/or counting registers that may be required to carry out a few of the basic functions within this system, such as preventing overrun in the feedback loop of the bit-slice feedback memory devices.

Now to produce such a product, to produce a general purpose FIS processor unit in accordance with claims (2) and (6) listed below, what is needed here is to amalgamate what has, up to now, been two very diverse developments in the electronics industry: That of the development of the basic concepts of the general purpose computers—a device that, up to now, has been built around general purpose FIS microprocessor units constructed out of a multiplicity of logic circuit—and that of the specialized computer that has been constructed from bit-slice feedback programming and bit-mapping processes.

And as to why these three products in the electronics industry—the general purpose computer, the bit-slice feedback programmed device and the bit-mapping process device—have not, as yet, been amalgamated into one system, but are now capable of being so amalgamated, is principally due to the above mentioned influence that hardware costs have played in the development of the general purpose computer in general, and the general purpose FIS processor unit in particular. For to be able to produce a fully functional 16-bit general purpose FIS processor unit using only bit-slice feedback programming and bit-mapping processes, and not by way of a multiplicity of logic circuits, has, up to now, been perceived as requiring many megabytes of RAM or ROM.

Until very recently, the cost of this amount of memory was far too prohibitive to make this type of device possible. For example, as it was mentioned above, in the early to mid 1970's to build a 16-bit general purpose FIS bit-slice feedback processor unit, the perceived costs were in the neighborhood of ten million dollars—much more than a general purpose FIS processor unit constructed from a multiplicity of logic circuits such as AND or OR gates, flip-flops and the like cost during the same period of time. So such a general purpose FIS processor based exclusively upon the use of bit-slice feedback programming and bit mapping processes, and not upon logic circuitry, could not have successfully competed during that era with the general purpose FIS processors that were actually built at that time; even though the general purpose FIS processor units based upon “software” would have been and still are vastly superior in many regards to that of general purpose FIS processor units constructed from logic circuitry. Or so it was perceived.

So during the era that gave rise to the first microprocessors, that of the early 1970's, the general purpose FIS processor industry was one that was dominated by general purpose FIS processor units built from a multiplicity of logic circuits consisting of AND and/or OR gates, shift registers, flip-flops and the like. Then as the microprocessors matured, the ratio between the cost of general purpose FIS microprocessors based on a multiplicity of logic circuits and that of the cost of memory continued, for many years, to appear to favor the use of logic circuits over that of bit-slice feedback programming and bit-mapping processes.

But now, after thirty years having past since the introduction of the first general purpose FIS microprocessors, and with all of the advances that have taken place in the manufacturing of integrated circuits, the price of 16-bit memory, as well as 32-bit, 64-bit and 128-bit memory, has now dropped into the price range that the apparent barrier of cost to creating a processor unit constructed solely from memory has now disappeared. In fact, with the present costs memory, the cost to mass produce a bit-slice feedback general purpose FIS processor unit of claims (2) and (6) would, if ten or twenty megabytes of memory are needed, be equal to, if not far cheaper than that of the present generation of general purpose FIS microprocessors that use a multiplicity of logic circuits such as AND or OR gates, flip-flops and the like to create their functionality.

But what has actually has happened, once the design of this type of general purpose computer system was set into motion, it has turned out that an integer based 128-bit fully functional general purpose FIS processor unit can be constructed using less than a million CMOS gates. So the truth of the matter is, this extremely powerful type of computing technology, once the initial misconceptions are overcome, was a technology that could have been used in design and construction of general purpose computing devices as soon as it was developed, somewhere in the 1960's or 1970's. But the perception of cost served as a suppressant and prevented this from happening.

### BRIEF DESCRIPTION OF THE DRAWINGS

FIG. 1 is the most rudimentary overall block diagram that can be drawn of a general purpose FIS computer system as viewed from the perspective of the general purpose FIS processor unit;

FIG. 2 is a basic conceptual block diagram of the internal structure of a general purpose FIS processor unit built along the lines of claims (2) and (6) below;

FIG. 3 is a 16-base adder for the integer addition circuit;

FIG. 4 is the bit-slice feedback circuit for the 128-bit Integer Adder;

FIG. 5 is the Carry Over Output circuit for the 128-bit Integer Adder;

FIG. 6 is the overall layout of the 128-bit Integer Adder;

FIG. 7 is the Ones Generator;

FIG. 8 is the Basic Twos Complement Unit;

FIG. 9 is the Twos Complement Bit-Slice Feedback Memory Controller;

FIG. 10 is the Twos Complement Output Circuit;

FIG. 11 is the Basic Comparator Unit;

FIG. 12 is the overall circuit layout of the Comparator Circuit;

FIG. 13 is the Basic Shift Left/Right Rotate Left/Right Unit;

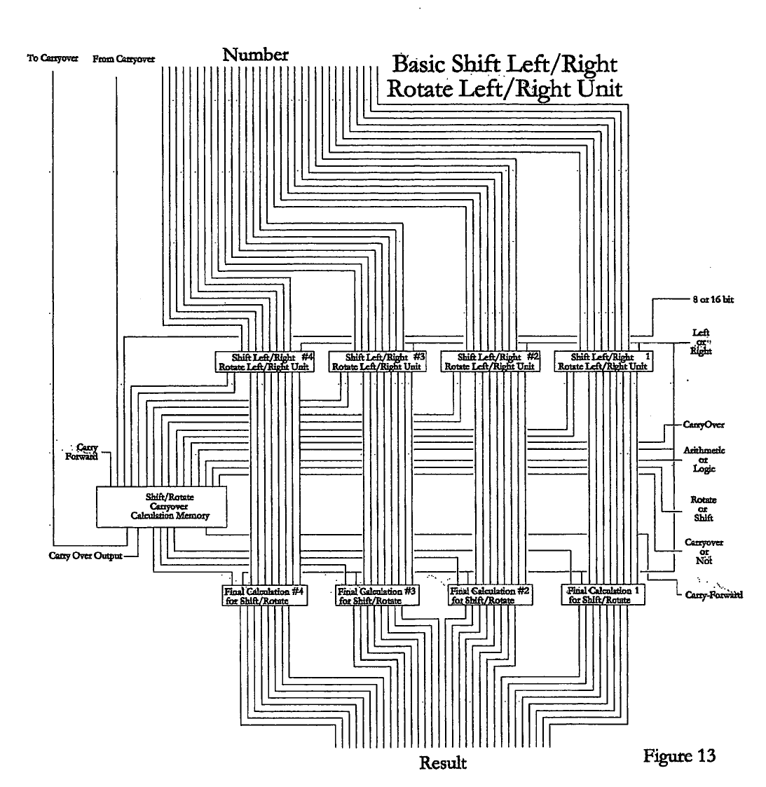

FIG. 14 is the Rotate/Shift Bit-Slice Feedback Memory Controller;

FIG. 15 is the overall circuit layout for the Rotate/Shift Circuit;

FIG. 16 is the Basic Logic Unit;

FIG. 17 is the overall circuit layout for the Logic Circuit;

FIG. 18 is the Basic Bit-Manipulation Unit;

FIG. 19 is Bit-Manipulation Bit-Slice Feedback Memory Controller;

FIG. 20 is the overall circuit layout for Bit-Manipulation Circuit;

FIG. 21 is the Memory/Processor Interface for the Control Lines;

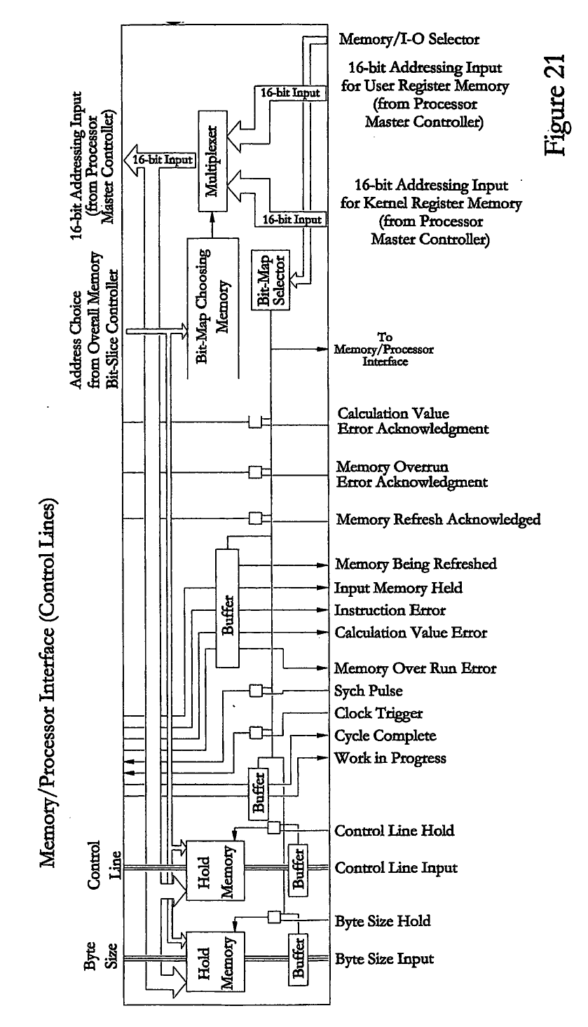

FIG. 22 is the Memory/Processor Interface for the Data Lines;

FIG. 23 is the layout for the RAM;

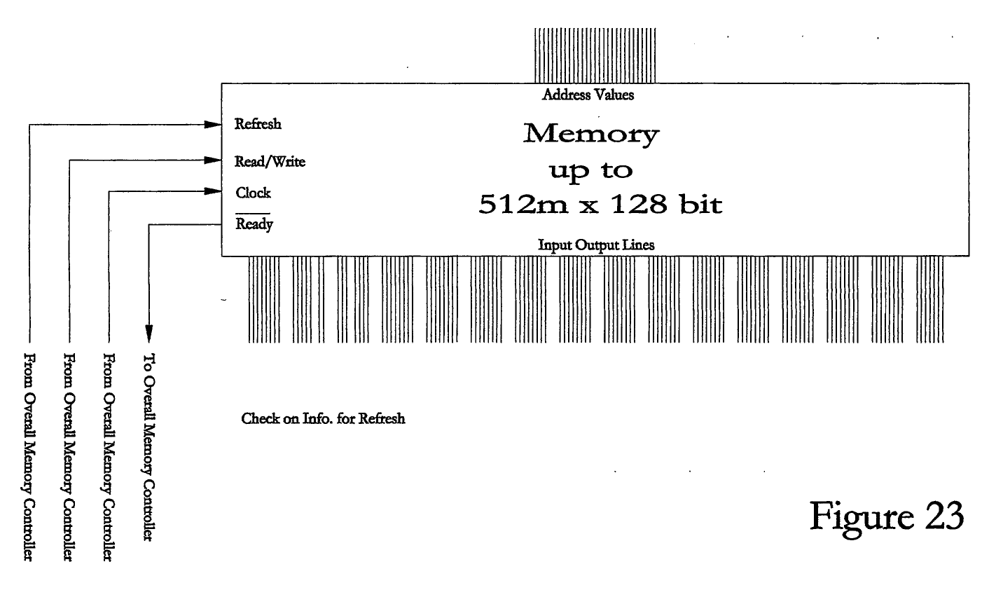

FIG. 24 is the Overall RAM Addressing/Accessing System;

FIG. 25 is the Addressing/Accessing Bit-Slice Feedback Memory Controller;

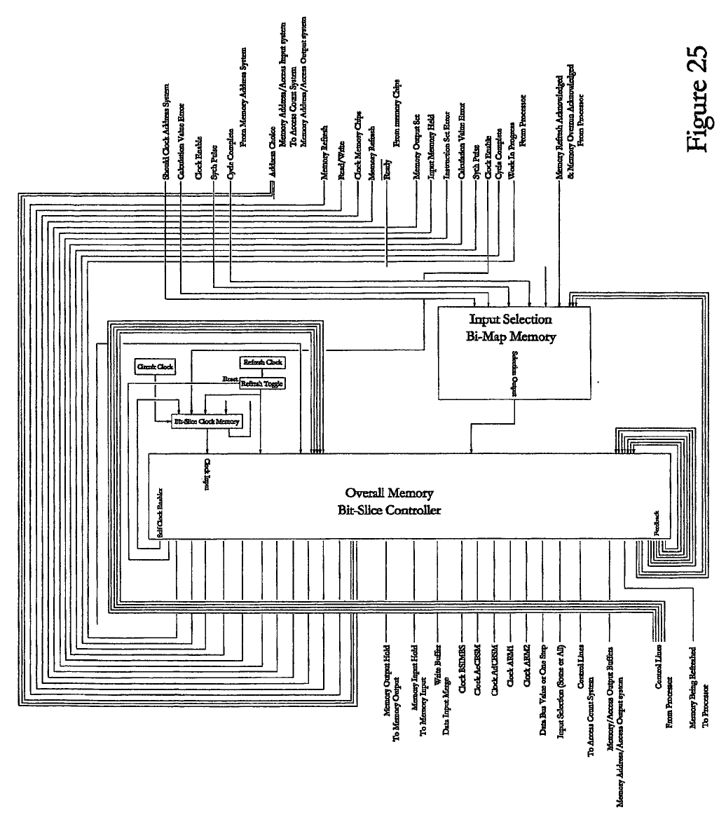

FIG. 26 is the layout for the Rest of General Purpose FIS Computer for this best mode Application;

FIG. 27 is the Primary Bit-Slice Feedback Programmed Memory System;

### INDUSTRIAL APPLICABILITY (DETAILED DESCRIPTION)

The Basic Design of a general purpose FIS Computer System as a Series of Black Boxes

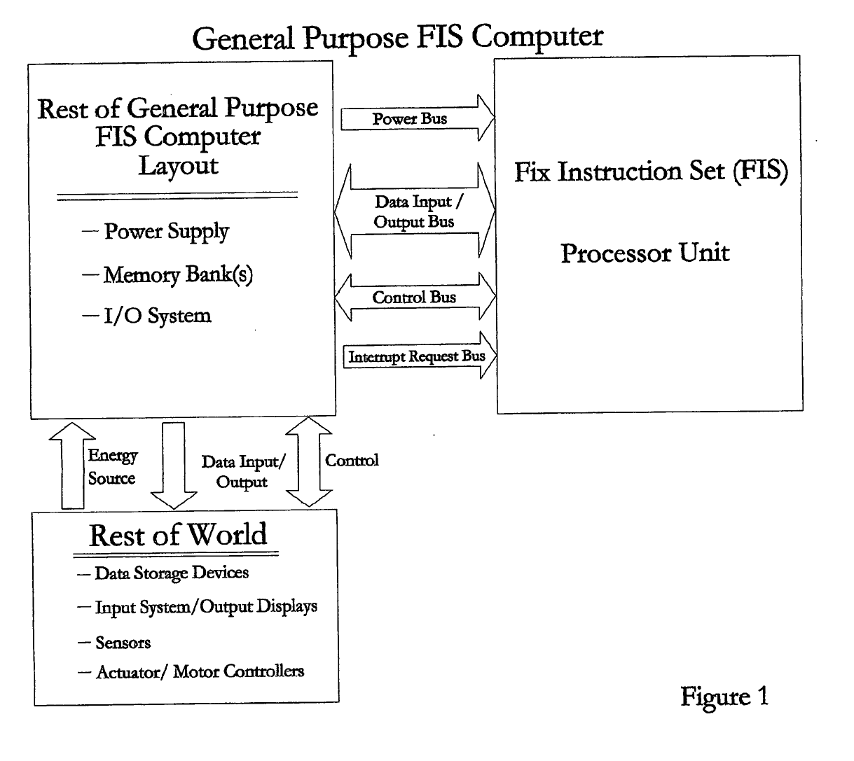

FIG. 1 is the most basic block diagram that can be made of a general purpose FIS computer system as viewed from the perspective of the general purpose FIS processor unit itself. This diagram holds true regardless of the type of general purpose FIS processor unit or microprocessor involved; be it one built from a multiplicity of logic circuits consisting of AND and/or OR gates, shift registers, flip-flops and the like as are the presently manufactured microprocessors, or a processor unit built from bit-slice feedback programs and bit-mapping processes placed into various specialized memory circuits.

On the right of FIG. 1 is the general purpose FIS processor unit itself. From the perspective of this diagram, this “general purpose FIS Processor Unit” can be viewed as a black box; that is, a box where power and signals go in in a predetermined way and then, once these energy flows have gone into this box, other signals, other energy flows, come back out of this box at a later time. These output signals, like the signals that went into this box, come out in a well defined, predetermined way.

Then in the upper left hand side of FIG. 1 is the box called “Rest of the general purpose FIS Computer.” From the perspective of this diagram, it too can also be thought of as a black box. For just like the black box of the “general purpose FIS Processor Unit”, things (i.e. energy sources and signals) go into this box in a determined fashion. Then, later, things (i.e. power and other signals) come back out of this box. They come out in a well ordered manner. But as viewed from the perspective of the other boxes on FIG. 1—the “Rest of World” and the “general purpose FIS Processor Unit” box—it does not matter how things actually work inside this box, just as long as the “Rest of FIS General Purpose Computer” does what it is called upon to do by the other black boxes.

Then the last of the these boxes, the box found on the left lower corner of FIG. 1, is the “Rest of World.” Like the other two boxes, it can also be viewed as a black box; the black box that provides the primary energy source and input signals from the rest of the world that enter into the computer system itself. It is also this system, this black box, that receives the output signals that come for the “Rest of FIS General Purpose Computer” and which are destined for the rest of the world.

Then in between these three black boxes are to be found eight arrows: arrows that represent the various types of energy flows that must take place between these various black boxes if this system is to perform as a general purpose FIS computer. For it is by means of these energy flows that these various boxes are able to communicate with one another in a orderly and timely fashion.

Now as for the first of these arrows on this diagram, the arrow found at the top middle of FIG. 1 between the “general purpose FIS Processor Unit” and the “Rest of FIS General Purpose Computer”, it is labeled the “Power Bus.” It represents the primary flow of energy into the “general purpose FIS Processor Unit” from the “Rest of FIS General Purpose Computer”; the energy that the “general purpose FIS Processor Unit” must receive if it is to carry out all of its many diverse functions.

The second arrow, the one found just below the “Power Bus”, is called the “Data Input/Output Bus” and it represents the multiple energy flows that travel from the “Rest of FIS General Purpose Computer” to the “general purpose FIS Processor Unit” as well as in the opposite direction. As an input bus, this multiple flow of energy, transfers information to the “general purpose FIS Processor Unit”; information that the latter system needs from the various subsystems found within the “Rest of the general purpose FIS Computer” so as to be able to work. Included in this stream of information is the instructions which tell the “general purpose FIS Processor Unit” exactly what steps it needs to follow in order to accomplish a given task; a task set down, ultimately, by the end user.

But in addition to instructions, this inflow of information over this bus also contains the data which the “general purpose FIS Processor Unit” will, in its turn, send back to other parts of the computer system found within the “Rest of FIS General Purpose Computer.” But very often before the “general purpose FIS Processor Unit” does send back this data, it will manipulate this information in one of many different ways (such as add the data together, shift the structure of the data to the right or to the left, change one or more of the data's bits and so on). The manipulation of this data, if it does occur, will be determined by the instruction the “general purpose FIS Processor Unit” has previously received from the “Rest of FIS General Purpose Computer.”

Then when this “Data Input/Output Bus” functions as an output bus, it transfers the aforementioned data, in many cases after it has been manipulated, back to one or more of the various subsystems found in the “Rest of the general purpose FIS Computer.” Included in this data sent back to the rest of the computer system will be the addressing values that the various subsystems of the “Rest of FIS General Purpose Computer” will, at different times, use to determine which memory locations or I/O systems are to be accessed at some future point.

Then there is the third arrow from the top, in the middle of this diagram. This arrow is identified as the “Control Bus”; that path upon which signals are sent from the “general purpose FIS Processor Unit” to the “Rest of FIS General Purpose Computer” and which are used by this latter system to configure the various subsystems found within this said “Rest of FIS General Purpose Computer.” The particular signals that are placed upon the “Control Bus” are determined by the particular instruction that the “general purpose FIS Processor Unit” had previously received from the “Rest of FIS General Purpose Computer” and which is being executed at that particular moment; an instruction that was sent to the “general purpose FIS Processor Unit” over the above mentioned “Data Input/Output Bus.”

This then leaves the last arrow in the middle of FIG. 1 to consider, which is called the Interrupt Request Bus” (IRQ bus). The lines that compose this arrow serve two functions. The first is to coordinate the transfer of data between the “Rest of General Purpose FIS Computer” and the “Rest of World.” This transfer can be done in one of two ways. The first is that when an IRQ is received over this IRQ bus, the “general purpose FIS Processor Unit” takes direct responsibility in transferring data into the “Rest of general purpose FIS Computer.” The second way that Input and Output from and to the “Rest of World” can be handled is to have a special transfer unit within the “Rest of general purpose FIS Computer” oversee and coordinate this movement of data. In this latter situation, the only role played by the “general purpose FIS Processor Unit” is to signal this said special transfer unit to begin the transfer, and to where to transfer the said data.

When I/O functionality is handled by a special transfer unit, this special transfer unit will use the IRQ bus to signal the general purpose FIS processor unit that it has completed its task. Or if it failed in its task, it will use the IRQ bus to inform the “general purpose FIS Processor Unit” of the problem that has developed.

The second major function that is provided by the “Interrupt Request Bus” is to tell the “general purpose FIS Processor Unit” when it is time to start the system up from scratch; to reboot the system. This signal is necessary whenever one of two things come to pass. The first is that this signal needs to be sent whenever the computer system begins to receive power after a period of time when the system was without power; which meant that all of the volatile memory systems have been wiped clean of their previous knowledge. The second situation in which the computer system needs rebooting is where the computer system enters into a “none performing state,” a conditions as old as computers themselves. That is, the computer “freezes” up. Or to put it another way, the computer enters into an infinite loop. When this happens the computer system stops responding to the user's instructions and input.

Then there are those arrows that are to be found between the “Rest of FIS General Purpose Computer” and the “Rest of World”. The first of these arrows—the “Data Input/Output” arrow—have the same basic purpose as that of the arrows called the “Data Input/Output Bus” and the “Data Output Bus,” respectively, and which were just discussed above. In their situation it provides the communication between the “Rest of general purpose FIS General Purpose Computer” and that of the “Rest of World.”

Then there is the next arrow on this diagram which is called the “Energy Source.” This arrow cannot, like the “Data Input/output” arrow, be compared to the “Power Bus” arrow in the middle of FIG. 1. The reason for this is because the “Energy Source” arrow can represent things that the “Power Bus” does not. For the energy that can be sent over conductors and connectors that make up the “Energy Source” arrow to the “Rest of general purpose FIS General Purpose Computer” can come in many more different forms than that represented by the “Power Bus.”

For in the case of the “Power Bus”, the energy sent to the “general purpose FIS Processor Unit” from the “Rest of FIS General Purpose Computer” is in what one would call an active form; an active form being such things as that of the coordinated drift of electrons and/or holes in a conductor, or that of the directed movement of electromagnetic fields, and the like. Now the arrow called “Energy Source” can, and in the present computer system do represent this type of energy flow. This energy arrows is in no way limited to this type of energy transport. Rather, the energy flow represented by the “Energy Source” arrow can also take on the form of the mass movement of stored energy, such as the mass movement of two or more reactive chemicals; reactive chemicals that move to a fuel cell that then takes the chemical potential energy stored in these reactive chemicals into a flow of electrical energy. Thus the arrow called “Energy Source” represents a much wider range of possible energy types than that of the “Power Bus.”

Now as for the last arrow between the “Rest of general purpose FIS Computer” and “Rest of World,” it is that of control. It is by way of this arrow the at the “Rest of general purpose FIS Computer” and “Rest of World” will coordinate their actions and movement of data very much like function served by the control bus between the “general purpose FIS Processor” and the “Rest of general purpose FIS Computer.”

As for why the term bus was used the defining terms “Data Input/Output” and “Control” between the “Rest of general purpose FIS Computer” and the “Rest of World” is that it may very well be the case that wires (be they electrical or photonic) will not be used to connect these two broad systems—which is what is normally view as the basic constituent of a bus. Rather, the “Rest of general purpose FIS Computer” may be connected wholly, or in part, by wireless technology to the “Rest of World.”

The Basic Analysis of a General Purpose FIS Computer System as a Series of Black Boxes

This then is the basic schematic for all general purpose FIS computer systems as viewed from the perspective of the general purpose FIS processor unit; wherein all of the components are treated, including the flows of energy and potential energy, as black boxes. As stated above, it does not matter how these various black boxes actually do what they do within themselves as long as they perform the tasks expected of them from the other systems. All that matters from the perspective of this diagram is that they fulfill the “obligations” that they have to the rest of the system. This concept will play a vital role in the conversion from the use of logic circuitry to that of the use of bit-slice feedback programmed and bit-mapped process devices within both the “general purpose FIS Processor Unit” and the “Rest of general purpose FIS Computer.”

The “General Purpose FIS Processor Unit” Black Box

Now in the case of the “general purpose FIS Processor Unit”, this obligation consists of properly using the power it receives over the “Power Bus” to accept the instructions over the “Data Input/Output Bus” and any signals that might also come to it over the “Interrupt Request Bus” and then carry out what they dictate. As to how the “general purpose FIS Processor Unit” black box actually works internally, it does not matter, as long as it does do what it is called upon to do by the “Rest of the general purpose FIS Computer.”

The “Rest of FIS General Purpose Computer” Black Box

Now as for its perspective on the rest of the computer system, this “general purpose FIS Processor Unit” black box does not “care” how the structure of the “Rest if the FIS General Purpose Computer System” is laid out or how it does its job internally. All that it is “concerned” with is that it receives its power in the proper form over the “Power Bus” from the “Rest of FIS General Purpose Computer” and that it also receives its instructions and other data over the “Data Input/Output Bus” from the “Rest of FIS General Purpose Computer” and that it also be given the necessary signals over the “Interrupt Request Bus” lines whenever they are called for. In addition to this, the “general purpose FIS Processor Unit” black box also expects from the “Rest of FIS General Purpose Computer” to properly accept and respond to the information that it, the “general purpose FIS Processor Unit”, places upon both the “Data Input/Output Bus” and the “Control Bus.” That is all that the “general purpose FIS Processor Unit” is “concerned” with regards to the “Rest of FIS General Purpose Computer.”

As for how the “Rest of World” box “views” the “Rest of FIS General Purpose Computer” box, it is the same as that of the “general purpose FIS Processor Unit” black box. The “Rest of World” sends signals and energy over the lines that make up two arrows that connect it with the “Rest of FIS General Purpose Computer.” Beyond what happens within these two arrows, the “Rest of World” “cares” not what happens inside the “Rest of FIS General Purpose Computer” black box. (i.e. both the “Rest of general purpose FIS Computer” and the “general purpose FIS Processor Unit.”)

The same story is repeated for how the overall computer system “views” the box labeled “Rest of World.” All that matters to the rest of the computer system is that they receive directly, or indirectly, what they expect over the corresponding arrows that link the “Rest of FIS General Purpose Computer” with the “Rest of World.” As for how or why or by what means these flows of energies are sent by the “Rest of World,” the rest of the computer system does is not “concerned”; just that “Rest of World” does get it done, and in a timely fashion.

Nature and History of the Communications of the Black Boxes of Computer Systems

Thus these three black boxes in FIG. 1 each, in their turn, “cares” about only one thing, what type of “data” and/or “energy” it receives from its companion black boxes and what type of “data” and/or “energy” it needs to send to its companion boxes and in what form that that “data” and/or “energy” must take. And that is all.

So the question becomes, “What has been the structure to this data?” This question naturally leads to an even more fundamental question. That is, “What determined the structure to this data in the first place?” Historically the answer to this latter question has been determined by one overriding consideration. That of producing a viable “general purpose FIS Processor Unit.” As it was explained in the “Prior Art” section, the first generations of the “general purpose FIS Processor Unit” black box devices were composed of discrete active and passive electronic components. The most important of these discrete components used was that of the vacuum tubes; which was a very unreliable component. To make the task of building these processor units as easy as possible, especially when the processor units were composed of thousands upon thousands of vacuum tubes that burned out on a regular predictable basis, a whole range of restrictions where placed upon the communication systems. One of the earliest restrictions placed on these arrows of FIG. 1 was that of simplifying the structure of the “data” that was being sent to the “general purpose FIS Processor Unit” by the “Rest of FIS General Purpose Computer.” That “data”, as a general class, included the instructions, addressing values and the “file” data. To simplify the transmission of all these different forms of data, what was done was to try and make all of it look as much alike as possible. That is, to have all of this data composed of the same number of bits, and so on.

What this did was to cause the computer engineers to move away from using multiple memory systems in the way Zusa had done in the very first computers to that of using one long memory bank containing all of the programs, addressing values, and file data. Based upon this first restriction, after restrictions where conceived and placed upon these communication systems, restrictions that made the difficult task of making a working general purpose FIS processor unit easier; restrictions such as using a binary numeration system, and having the size of each of these binary words start out as eight or sixteen bits long, and so on.

Then as time passed the mechanisms contained in the “general purpose FIS processor Unit's” black box were converted over from that of vacuum tubes to the far more reliable discrete solid state transistors, then to the even more reliable integrated circuit chips. This conversion did not, in any way, reduce the demands that the manufacturing of the “general purpose FIS Processor Unit” placed on the structure of the communication systems between the various black boxes of FIG. 1. Rather, the restrictions that the first generations of microprocessors placed on these communication systems were, in fact, even more severe and even more stringent than those required by the “general purpose FIS Processor Units” that were, at that time, built from more discrete solid state components.

So it was out of these very restrictive conditions placed on the communication systems that the first computer systems based on the first microprocessors were created. Then as the microprocessor industry grew, these restrictions placed upon the communication systems slowly eased. This meant that the performance and power of those components that made up the “Rest of FIS General Purpose Computer” black box (i.e. the memory banks and the I/O systems) also improved with time. In all of this process, in all of this growth and change, there was never a point reached wherein the black box called the “Rest of FIS General Purpose Computer” ever came to equal, much less be superior to that of the “general purpose FIS Processor Unit” black box in establishing what the specifications would be for these various said communication systems—that of the arrows on FIG. 1. Always, the design of each new generation of general purpose FIS microprocessors built upon a multiplicity of logic circuits consisting of AND and/or OR gates, shift registers, flip-flops and the like served as the final arbiter as to what the final structure to the flow of data would be within the communication systems. In their turn, these communication systems always dictated, in the end, what the overall structure of the “Rest of FIS General Purpose Computer” would have to look like: as, for example, in the design of the memory systems that were to be found in the “Rest of FIS General Purpose Computer.”

It must be stated that this relationship between the “general purpose FIS Processor Unit” and the rest of the computer system was one of absolute necessity. For without these restrictions made by the “general purpose FIS Processor Unit” on the communication systems there would have been no way for general purpose computers built around general purpose FIS microprocessors to have emerged in the first place. Yet in many ways these necessary restrictions placed on the general purpose FIS general purpose computer system by the “general purpose FIS Processor Units” have hampered the growth that could otherwise have taken place in that black box called the “Rest of FIS General Purpose Computer.” For if these restrictions had not existed, much advance could have been made in the overall performance of general purpose general purpose FIS computer system. One of the more crucial areas in which advance could have come is in the realm of memory systems. For it would have made a great deal of sense in the utilization of memory if the computer systems had remained upon the track first set down by Kanrad Zusa; that of using a range of independent memory banks, each with their own independent addressing systems. As it is identified in many of the claims below, these various “external” memory banks could have been optimized to handle various forms of data: such as instructions, addressing values (which, in some situations, might best be stored in two different “external” memory banks; one for relative addressing values and another for absolute addressing values), ASCI II data, 16-bit numerical data, 32-bit numerical data, 64-bit numerical data and so on. In this way, the overall performance of the general purpose FIS computer could have been greatly enhanced. Such specialization within the “Rest of FIS General Purpose Computer” black box has not been feasible as long as the “general purpose FIS Processor Units” have been composed of microprocessor units built out of a very large arrays of logic circuits of AND and/or OR gates and the like. For always there is the grave constraints placed on the system by the difficulty associated with manufacturing processor units such as these.

Note on the Use of Memory

It needs to be stated at this point in this discussion that memory circuits and memory systems will be used in two very distinct and different ways within this patent application in as far as it relates to the computer systems that will be built around the general purpose FIS processor unit of claims (2) and (6). One use for which memory will be employed within these types of general purpose FIS computer systems is outside the “general purpose FIS Processor Unit.” The second basic usage of memory in this type of general purpose computer built around the general purpose FIS processor unit of claims (2) and (6), is within the “general purpose FIS Processor Unit” itself, as identified in claim (2) below. These two different types of usage of memory need to be identified and clearly delineated from one another within this patent application. This must be done to avoid any confusion that might otherwise develop in the following discussions of this new type of general purpose FIS processor unit.

Now to provide this delineation in usage of memory, all memory usage that will occur in the “Rest of FIS General Purpose Computer”, such as RAM, and within the “general purpose FIS processor Unit” for non-calculating functions, such as caches, and ROM used for boot-up functions will be identified in this patent application by the word “external” appearing just before the word memory. What is more, this word external, in this particular usage, will also be enclosed with quotation marks. The latter usage of memory in this new type of computer system, that of memory employed within the “general purpose FIS Processor Unit” itself for the bit-mapping and bit-slice feedback functions, will be inferred whenever the word memory is used without this modifying term “external” appearing before it.

The Future of the Black Boxes of Computer Systems and their Communication Systems

This then brings us to the “general purpose FIS Processor Unit” built along the lines of claims (2) and (6). As viewed as a black box, this type of processor unit can, if desired, be made to behave in just the same way that the present general purpose FIS microprocessors built up from a multiplicity of logic circuits behave. That is a general purpose FIS processor unit of claims (2) and (6) can be made to appear, for all intents and purposes, to the “Rest of FIS General Purpose Computer” the same as that of present generation Intel or AMD microprocessor. Or a general purpose FIS processor unit of claims (2) and (6) can be so designed as to mimic precisely the behavior of the latest generation of Motorola microprocessor chips, those incorporated into such computer systems as manufactured by the Apple Corporation. If need be, one could design a general purpose FIS processor unit of claims (2) and (6) to behave as any of the older generations of processors manufactured in the past by any of these or any other manufacturers of microprocessors. The only difference between these two very differently constructed “general purpose FIS Processor Units”—those constructed from a multiplicity of logic circuits and those built from bit-slice feedback programs and bit-mapping processes—which in some situations would be a big difference, is the amount of power that would flow into the “general purpose FIS Processor Unit” black box from the “Rest of FIS General Purpose Computer”, power transported over the “Power Bus.” For the amount of energy needed to have the general purpose FIS processor unit of claims (2) and (6) carry out instructions would be, in general, far less than that of the present general purpose FIS microprocessors, as identified in claims (31) and (32) below; for memory circuits are, in general, very much less demanding in energy usage than that of a multiplicity of logic circuits placed on semiconductor chips.

The design of general purpose FIS processor units of claims (2) and (6) are not, in any way, restrained or constrained to that of solely mimicking the present generation, or past generations, of general purpose FIS microprocessors built around a multiplicity of logic circuits. For with the ease with which bit-slice feedback programs and bit-mapping processes can be designed and implemented, as compared to the design and construction of a multiplicity of logic circuits, a whole range of new types of “general purpose FIS Processor Units” based upon claims (2) and (6) can be built, general purpose processors that have never been seen before. The design specifications of these new types of general purpose processors, rather than being determined principally by the production processes that are used to make them, can now come from how one could design vastly superior systems within the “Rest of FIS General Purpose Computer” of the computer system; such as superior “external” memory systems that better fit with the data they contain.

To build these new types of general purpose FIS computers constructed around these new types of general purpose FIS processor units of claims (2) and (6), the process would begin by first determining one thing above all else: what will be the primary purpose a particular given general purpose FIS computer system need to serve? Will it serve, primarily, as as system to do numerical calculations? Or will it do data processing? Or routing of data across various networks? Or a basic desktop computer for light office work? Or serve as an all around general purpose computing device? Or some other function?

Then once this choice of functions has been made, once the basic purpose of the computer has been established, then an engineer would look to the “Rest of the general purpose FIS Computer” black box to see what would be the best way to design its internal structure to fit the particular task at hand: what type of memory systems and I/O systems would best serve the primary function for the particular type of general purpose FIS computer under construction. Then with this having been determined, the arrows that are shown on FIG. 1, would be designed.

Note on the Nature of Programs as Used in the General Purpose Computer that Build Around a General Purpose FIS Processor Unit of Claims (2) and (6)

At this point, before going on to how this new type of general purpose FIS processor unit of claims (2) and (6) can be built based on newly designed communication systems, what needs to be stated here, so that the following discussions will not become confusing, is that like the word “memory”, the word “program” will be used in two very distinct ways within this patent application. In one sense, this word will refer to any sequence of instructions and addressing values that are being sent to the “general purpose FIS Processor Unit” (regardless of its design) to direct this processor's operation. This type of “program” is the one that will be stored in one or more of the “external” memory systems. The second way the word “program” is being applied in this patent application is in terms of the bit-slice feedback programming and bit-mapping processes that are to be used within this new type of processor unit itself, as identified in claims (2) and (6).

In order to make a clear distinction between these two very different uses of this word, from this point forward these words will be delineated as follows. If this word is used alone, without hyphenation, it will refer to all of the various sequences of instructions and addressing values that go into making up the programs that are being sent by the various users to the “general purpose FIS Processor Unit”; programs that are being stored at the time of their use in the “external” memory of the “Rest of FIS General Purpose Computer” and which are directing the “general purpose FIS Processor Unit's” in what it is to do. If this word is hyphenated as “processor-program” it will refer to any of the bit-slice feedback programs and/or bit-mapping processes that are part of the internal structure of the processor unit as expressed in claims (2) and (6).

The Future of the Black Boxes of Computer Systems and their Communication Systems (continued)

Once the internal structure of both the “Rest of FIS General Purpose Computer” and the communication systems has been established, then the details that need to be determined for the internal structure for the “general purpose FIS Process Unit” black box can be set down. Generally the first step in this last procedure would start with identifying what will be included in the instruction set for the particular general purpose FIS processor unit of claims (2) and (6) under design. Then once this is done, processor-software would need to be designed and created for this system. First the processor-programs would need to be configured and written. Then these processor-programs need to be placed into the hardware systems that will contain them.

This leads to the second step in creating this new type of “general purpose FIS Processor Unit”, that of the design and construction of the hardware that would contain these various processor-programs. Then after this has been completed, the programs (such as the operating system and data processing systems) that would be run on this new type of general purpose FIS computer system would need to be created. This could be done in one of four ways: first, design this new computing system based on claims (2) and (6) so that it could run the preexisting software. Second, modify the pre-existing software so that it could run on this new type of computer. Third, new software could be written from scratch. Or finally, a combination of the first three choices could be done.

Then with the completion of this last task, which, in some cases, may prove the most difficult task to complete, the second type of general purpose FIS computer system built around a general purpose FIS processor unit of claims (2) and (6) would be finished: a viable and working computer system that would have been designed around the dictates of the “Rest of FIS General Purpose Computer” rather than that of the manufacturing processes that are associated with the creation of the “general purpose FIS Processor Unit.”

The Basic Design of the general purpose FIS Processor Unit of claims (2) and (6)

This then establishes the two diverse approaches by which a general purpose FIS processor unit of claims (2) and (6) can be designed and then built: the first type of system is one that is meant to mimic one or more of the present microprocessors constructed from a multiplicity of logic circuits; but which may, in many cases, also have built into it further enhancements and features that are not found in the microprocessor, or microprocessors, that it is mimicking. The second type of system is designed to create the best balanced computer system that can be made for a given task or set of tasks—i.e. computer systems that maximize the performance of all of the subsystems to a given task or set of tasks.

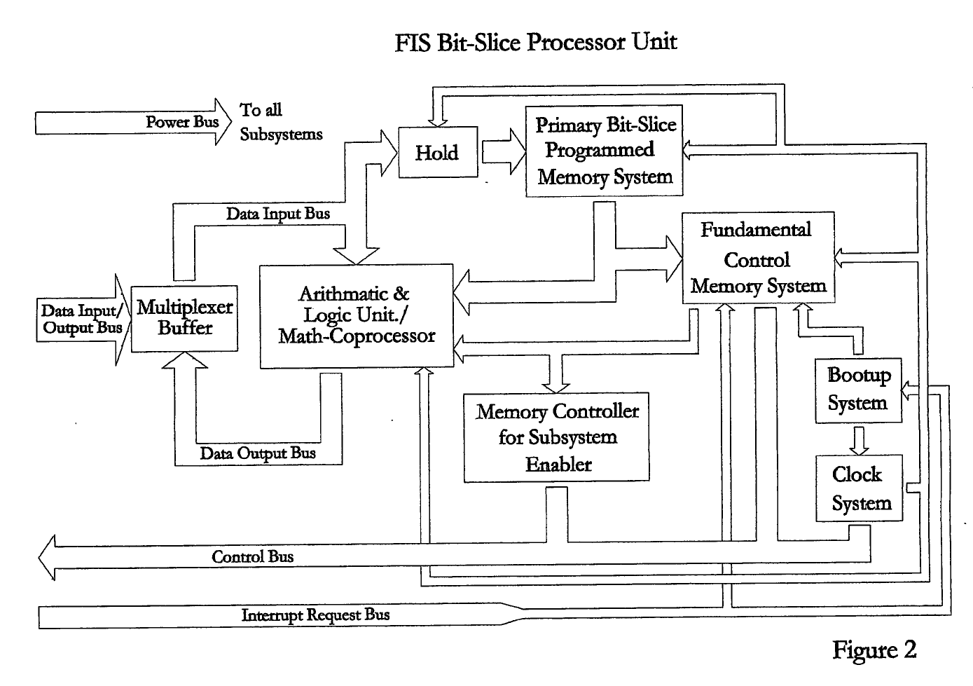

An interesting fact begins to emerge when one begins to consider how these two types of general purpose FIS processor units of claims (2) and (6) would be constructed. What one finds is that internally each of these two different approaches—that of mimicking present general purpose FIS processor units or that of maximizing overall performance of the computer system—have the same basic, fundamental architecture: an internal structure that is shown in FIG. 2. As for how it is possible to achieve such different results with the same basic architecture, it is because of the elegant power that is associated with bit-slice feedback programs and bit-mapping processes: that is, with different codes one has different performances.

Arguing from a different perspective, it can be said that the layout shown in FIG. 2 can, depending upon how one lays out the internal structure of these various subsystems, be made to perform in any number of different ways, giving rise to any number of different types of processor units built in accordance with claims (2) and (6).

Now as for these standard subsystems of a general purpose FIS processor unit of claims (2) and (6), the first two shown on FIG. 2 to be considered here in this patent application are those of the “Power Bus” and the “Data Input/Output Bus”—the “Power Bus” in this figure is simply a continuation of the “Power Bus” found in FIG. 1. The “Data Input Bus” links to the “Data Input/Output Bus” of FIG. 1 through a series of multiplexers and buffers. In other words, the input side of the “Data Input/Output Bus.”

The analysis of this new general purpose FIS processor begins with these two subsystems. For it is by way of them that the general purpose FIS processor unit of claims (2) and (6) will be able to first receive, in one form or another, the flow of energy that it needs to carry out all of its actions. In most general purpose FIS processor units of claims (2) and (6), especially in the first systems that will be designed and built in accordance with the claims of this patent, this energy flow will be provided by the flow of electricity coming over the connectors that will be linked to a power subsystem within the “Rest of FIS General Purpose Computer.”

The second of these two subsystem is that of the “Data Input/Output Bus”. It is upon this path that data will be received into the general purpose FIS processor unit of claims (2) and (6) from the “external” memory banks and/or I/O systems of the “Rest of FIS General Purpose Computer.” Upon entering into the general purpose FIS processor unit of claims (2) and (6) this data input/output bus splits in the more traditional FIS general purpose processors into three different pathways. The first of these three pathways goes to the master control unit that decodes the operational code which then directs the processor's activity. In this new generation of general purpose FIS processor unit of claims (2) and (6) this master control unit will be composed, in this patent application, of the “Primary bit-slice feedback Programmed Memory System” and the “Fundamental Control Memory System.” In some designs of the general purpose FIS processor unit of claims (2) and (6) this pathway may first pass through a “Hold” subsystem before terminating at the first component of the master controller, that of the “Primary bit-slice feedback Programmed Memory System.”

The second pathway that the “Data Input/Output Bus” splits into is one that goes to the Arithmetic and logic unit (ALU) as well as the math-coprocessor (generally used to carry out the higher forms of mathematics such as floating point arithmetic calculations and trigonometric functions), if the latter system is included in the general purpose FIS processor. In this new general purpose FIS processor unit of claims (2) and (6) the ALU and math-coprocessor will be treated as one and called the “ALU/Math-Coprocessor System.”

The third location to which the “Data Input/Output Bus”, in the present and past generations of general purpose FIS processors, is split off to and terminates at is that of the addressing system. However in this new type of general purpose FIS processor unit of claims (2) and (6), the addressing function can, if desired, become far more involved and intricate than that found in the logic based general purpose FIS processors. One of the consequences of this advancement, if applied in a given design, is that the addressing hardware will, in some or most cases, no longer be a integral part of the internal structure of the general purpose FIS processor unit of claims (2) and (6) itself. Rather the addressing functionality will, if this design change is used, be placed into a number of stand alone chips and placed throughout the computer system itself; in particular, throughout the “Rest of General Purpose FIS Computer.” As for the details of how this will be done, this will be explained in the “Best Mode” section given below.

The Hold Subsystem

Now as for the “Hold” subsystem mentioned above, it may be included into a given design of this general purpose FIS processor unit of claims (2) and (6) whenever the system needs to preserve previous instructions sent to it over the “Data Input Bus.” This can happen if, for example, the bit-slice feedback program contained within the “Primary bit-slice feedback Programmed Memory System” ever needs to carry out a subroutine within its operation; a subroutine that after being completed requires the master controller to return to the previous instruction that it was carrying out just prior to the execution of the subroutine. The purpose of this “Hold” subsystem is to allow this type of processor unit to do just that, to recall previous instructions without having to have the instruction sent back over the “Data Input/Output Bus” again. For by that time the data bus may have moved on to other things such as transferring other data into the “general purpose FIS Processor Unit”; in particular, to the “ALU/Math-Coprocessor System.” When this has happened the operational Code (Op. Code) will have been displaced off the “Data Input/Output Bus.”

The Bit-Slice Feedback Programmed Memory Subsystem

This now brings us to the heart and core of this “general purpose FIS Processor Unit” that is built in accordance with claims (2) and (6): that of the “Primary bit-slice feedback Programmed Memory System” and the “Fundamental Control Memory System”, as shown in FIG. 2. For it is by way of the actions of the “Primary bit-slice feedback Programmed Memory System” that the master controller controls all of the rest of the subsystems found in the general purpose FIS processor unit of claims (2) and (6) so that this “general purpose FIS Processor Unit” can properly respond to all the requests that the “Rest of the general purpose FIS Computer” places upon it. As for how the “Primary bit-slice feedback Programmed Memory System” accomplishes this task, it does so principally by sending its output to the “Fundamental Control Memory System;” a subsystem that is only second in importance to that of the “Primary bit-slice feedback Programmed Memory System” in the overall layout of the general purpose FIS processor unit of claims (2) and (6). The second subsystem that the “Primary Bit-Slice Feedback Programmed Memory System” can, in some designs of this new type of general purpose computer, send its output to is the “ALU/Math-Coprocessor System.”

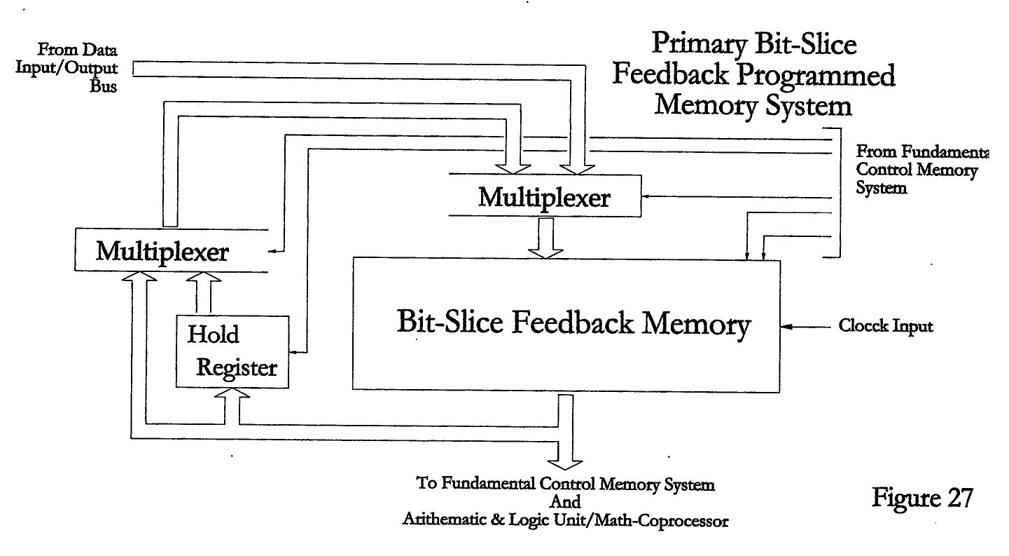

As for the basic construction of “Primary bit-slice feedback Programmed Memory System” it will be made up of hold registers (replaceable by a small bit-slice feedback memory systems if necessary), internal bus systems and memory circuits: all of which will be constructed and programmed so that all of these components will perform during most of its operation as a “normal” bit-slice feedback programmed system. Its basic layout is shown in FIG. 27.

The Fundamental Control Memory Subsystem

As for the “Fundamental Control Memory System” to which the “Primary bit-slice feedback Programmed Memory System” communicates directly with and which is the other component of the master controller, as identified above, this subsystem has two basic responsibilities. The first responsibility is that of configuring, by way of part of its output control lines, the precise state of all of the subsystems found within the general purpose FIS processor unit of claims (2) and (6) as shown in FIG. 2. It will be by means of these various states taken on by these various subsystems within the general purpose FIS processor unit of claims (2) and (6) that will allow this said “general purpose FIS Processor Unit” to do what it needs to do; that is, to carry out the instructions that it receives by way of the “Data Input/Output Bus” from the “Rest of general purpose FIS Computer.”

In addition to configuring the internal state of all the subsystems of the general purpose FIS processor unit of claims (2) and (6), including that of the “Primary bit-slice feedback Programmed Memory System”, the “Fundamental Control Memory System” will also be responsible, in conjunction with the output from both the “Clock System”—if the design of the new computing system based claims (2) and (6) makes use of a master clock rather than being build upon the concept of asynchronis—and the “Memory Controller for Subsystem Enablers”, also shown on FIG. 2, to provide the values that are sent over the “Control Bus” that configure all of the necessary subsystems of the “Rest of general purpose FIS Computer” so that these subsystems can then properly send and receive data to and from the “general purpose FIS Processor Unit.” In this way the various parts of this general purpose FIS computer as shown on FIG. 1 will be able to work together so as to perform all the tasks that this general purpose FIS computer system will be asked to perform by the user, or users.

As for the internal composition of this subsystem, the “Fundamental Control Memory System” will consist of one or more banks of memory circuits that will contain, principally, bit-mapping processes (but some of its functionality would be more appropriately defined as bit-slice feedback programming—this distinction, however, will be explained in more detail below), several hold register (again replaceable, if necessary, by small memory circuits containing bit-slice feedback programs), a number of counting registers (also replaceable, if necessary, by small memory circuits containing simple bit-slice feedback programs) and a couple of multiplexers and/or enablers.

The ALU/Math-Coprocessor System

This then is the “Fundamental Control Memory System.” But the “Primary bit-slice feedback Programmed Memory System” also communicates, as mentioned above, in some designs of this new type of computer directly with the “ALU/Math-Coprocessor System” as shown on FIG. 2. As for this latter subsystem, it is this subsystem that is responsible for carrying out, under the direct control of both the “bit-slice feedback Programmed Memory System” and the “Fundamental Control Memory System”, all of the various data manipulations and data flows that the general purpose FIS bit-slice feedback microprocessor unit must accomplish; such as additions, subtractions, multiplications, and many other possible mathematical functions as well as the shifting of bytes to the left or right, of bit manipulations and of many other algorithmic functions. To put it another way, all of this functionality that the “general purpose FIS Processor Unit” will possess, and in many cases must possess if it is to be a fully functional general purpose FIS processor unit, is provided by this one subsystem, which in turn will be composed of multiple sub-subsystems; that of the “ALU/Math-Coprocessor System.”

As for how this subsystem of the general purpose FIS processor unit of claims (2) and (6) will accomplish all of this work, it will do it by first receiving input over the “Data Input/Output Bus” as mentioned above. Then the “ALU/Math-Coprocessor System” will, if necessary, manipulate this data (such as the additions, subtractions and the like). Finally, it will send this data, in some cases after it has been manipulated, back to some subsystem within the “Rest of general purpose FIS Computer” by way of the “Data Input/Output Bus.”

As for carrying out the various manipulations that the “ALU/Math-Coprocessor System” can do, it will use bit-mapping processes controlled by local bit-slice feedback computing devices (also called local bit-slice feedback controllers) to provide all of this various functionality. This functionality of the “ALU/Math-Coprocessor System” may, if need be, and in most case shall be spread over a number of differing memory banks containing both bit-mapping processes and bit-slice feedback programming. The degree to which this spreading of functionality over varying memory banks will be done will depend upon the degree of speed and functionality that the general purpose FIS processor unit will require when it comes to data manipulation and mathematical functionality. For each of these different memory banks within the the “ALU/Math-Coprocessor System” to accomplish these various algorithmic functions (mathematical, logical and manipulative), it will require them to be programmed with different bit-mapping processes and bit-slice feedback programs. In order for all of these various memory banks of the “ALU/Math-Coprocessor System” with their corresponding bit-mapping process programs, to function properly, they will need to receive the appropriate data; data that will be provided, as mentioned above, over the “Data Input Bus.”

That is what the second major subsystem that will be incorporated into the “ALU/Math-Coprocessor System” will do. Through the use of an array of demultiplexers, multiplexers and/or enablers, the “ALU/Math-Coprocessor System” will direct the inflow of information from the “Data Input/Output Bus” to the appropriate memory bank that contains the correct bit-mapping process that will carry out the given function that is needed to be done: such as addition, bit manipulation, multiplication, etc.

Then as for the third subsystem included in the “ALU/Math-Coprocessor System,” it, like the second subsystem, will direct the flow of information within the “ALU/Math-Coprocessor System.” But this time this subsystem directs data out of this subsystem and onto the “Data Output Bus.” It, too, will be constructed from a series of multiplexers, demultiplexers, and/or enablers.

Address Buses

It should be mentioned that the two general diagrams, FIG. 1 and FIG. 2, being presented in this patent application, lack “address buses.” The reason for this is simple. Address buses can, for all intents and purposes, be looked upon as another means by which a given stream of data, in this case addressing values, travels from the “general purpose FIS Processor Unit” to the “Rest of general purpose FIS Computer.” When one examines closely this particular data stream, what one finds is that this flow of information is not different from all of the other flows of data that take place between these two black boxes; the “general purpose FIS Processor Unit” and the “Rest of general purpose FIS Computer.” Because of this, it is possible, on a theoretical basis, to amalgamate the flow of addressing values with all of the rest of the other flows of information (such as instructions and file data) onto one set of master bus systems. This is what has been done in this patent application: addressing values, as a whole, are treated no differently from that of the other data streams that need to find their way into and out of the “general purpose FIS Processor Unit.” As for the master bus systems that will handle all of this information traffic, it is the one discussed above, the one called the “Data Input/Output Bus.”

The Bootup Subsystem

The next subsystem found in the “general purpose FIS Processor Unit”, as represented in FIG. 2, is that of the “Bootup System.” This subsystem directs the actions of the “general purpose FIS Processor Unit” whenever this latter system has been directed to “bring up” the entire computer system to an operational level. How this subsystem will operate is explained in some greater detail below. As for its construction, it will consist of a series of bit-slice feedback programmed memory circuits, linked together by shift registers (replaceable, if necessary, by small memory circuits) and enablers and multiplexers.

The Clock Subsystem

This subsystem, the master clock subsystem, because of the incredible power associated with bit-slice feedback computing systems, is something that is optional within the FIS bit-slice feedback general purpose computer. In fact, as will be explained in the “Best Mode” section found below, the best approach will be to provide separate clocks for each of the subsystems within the overall system. Then with each subsystem having its own separate clock, signals will be sent to and from the master controller (i.e. the “Primary Bit-Slice Feedback Control System” and the “Fundamental Control Memory System”) and all of rest of these variously independently clocked subsystem found throughout both the general purpose FIS processor and the “Rest of General Purpose FIS Computer.” It will be by way of these various signals that this new type of general purpose FIS computer system will be able to coordinate its efforts and operation when carrying out the various instructions within its instruction set while still operating asynchronously.

But if this general purpose FIS bit-slice computer system does possess a “Master Clock System” as shown below the “Bootup System” on FIG. 2, this subsystem will have, except for the “Fundamental Control Memory System”, the greatest number of connections to the greatest number of subsystem both within the general purpose FIS bit-slice feedback processor unit itself and the “Rest of Computer.” This subsystem, if it is incorporated into this new type of computer system, will consist of several bit-slice feedback programmed memory systems that are inner-linked in a master-slave relationship. That these interlocking bit-slice feedback programmed memory systems are, in their turn, controlled by several lines coming from the “Fundamental Control Memory System”, as shown in FIG. 2. As for the operation of this “Clock System,” it is explained in greater detail later in this patent application. As for its construction, it will consist of an oscillator circuit and several memory circuits, and if necessary some hold register circuitry.

The Memory Controller for Subsystem Enablers

The final subsystem shown on FIG. 2 is the “Memory Controller for Subsystem Enablers.” As for its internal function, this subsystem will use a bit-mapping process to control all the various enablers and/or multiplexers that are found throughout the computer system and that are responsible for the orderly placement and removal of information onto and off of the various lines that compose the “Data Input/Output Bus.” As mentioned above, this subsystem's output is placed onto the “Control Bus.” As for how this subsystem is, in its turn, controlled; it can be seen from FIG. 2 that it receives its direction directly from the “Fundamental Control Memory System.”

The primary constituent of this particular subsystem of the general purpose FIS processor unit of claims (2) and (6) is a series of memory circuits that contain bit-mapping processes.

Initial Summation of the general purpose FIS Processor Unit of claim is (2) and (6)

This then gives an initial introduction to the various subsystems that make up the general purpose FIS processor unit of claims (2) and (6) and that, in their cooperation with one another, accomplish all that the present general purpose FIS microprocessor units built upon logic gates can accomplish, and much more. Yet as explained above, all of these various subsystems of the general purpose FIS processor unit of claims (2) and (6), as well as the subsystems that make up these various subsystems, require for their construction only those components that were listed in claim 2: That is, these systems only require various memory circuits (either of dynamic or static nature and of either volatile or nonvolatile type), multiplexers, enablers, shift registers, hold registers, and/or counting registers. None of these basic subsystems of the general purpose FIS processor unit of claims (2) and (6) require for their functioning vast arrays of logic circuits as do the presently manufactured general purpose FIS microprocessors. The only exception to this being any logic circuitry, if necessary, within the addressing system of the memory circuits.

Boot Process

Now that the basic structure of the general purpose FIS processor unit of claims (2) and (6) has been introduced, the boot-up process for this microprocessor system will be discussed in some length.

The first major point that needs to be understood about how the boot-up process applies to this particular type of general purpose FIS computer is that the sequence of events that will take place will be dependent upon the type of memory into which the various processor-programs for these various subsystem of the general purpose FIS processor unit of claims (2) and (6) are to be loaded; whether or not some or all of these various memory circuits in these various memory banks are going to be volatile (i.e. where the information contained within the said memory circuits is lost whenever the power is lost for any length of time) or whether all of these memory circuits of these said memory banks are, without exception, nonvolatile. That is the memory circuits retain their information even during periods of time when power is not provided to the system. The most nonvolatile memory circuits, and the most stable memory circuits, are those wherein the programs contained within them have been written “directly” into the masks from out of which the memory circuits are constructed.

Volatile Memory Boot-Up Sequence

In the case of the use of volatile memory in part, or all, of the general purpose FIS processor unit of claims (2) and (6), as expressed in claim (10), then some or all of the processor-programs that make this system work must be entered into these said volatile memory chip sets each and every time power begins to flow to the system after a period of time without power. The loading of these processor-programs into these various volatile memories will be the very first step that will be carried out by the “Bootup System” in this type of computer system.

Nonvolatile Memory Boot-Up Sequence

The second approach to designing a general purpose FIS processor unit of claims (2) and (6), as mentioned above and also as expressed in claim (11) below, is that all of the various memory chip sets used within this said bit-slice feedback general purpose FIS processor unit of claims (2) and (6) are of the nonvolatile type—that being that when power is discontinued, for whatever reason, these memory circuits continue to hold within their memory cells the knowledge of the various processor-programs.

As for the loading of these processor-programs into the various said nonvolatile memory circuits, this will be done for most systems prior to these memory circuits being placed within the computer system itself. That is, the programming of these nonvolatile circuits (or chips) is considered part of the manufacturing process of this particular type of the general purpose FIS processor unit of claims (2) and (6).

Once these preprogrammed nonvolatile memory circuit (chip) sets have been brought together with all the other components that make up this particular type of “general purpose FIS Processor Unit”, one based on claims (2) and (6), and the remainder of this said computer system has also been completed; upon powering up of this said computer system, all of the necessary processor-programs (both bit-slice feedback programs and bit-mapping processes) will be in place and ready for use. This will be true without any involvement of the “Bootup System”, as shown in FIG. 2, whatsoever; as compared to that of computer systems that use volatile memory within the general purpose FIS processor unit.

In this situation, wherein all of the memory circuits of the general purpose FIS processor unit of claims (2) and (6) are of a nonvolatile type, all that the “Bootup System” needs to do to properly start (or re-start) this said computer system is to send an active signal to the “Fundamental Control Memory System” by way of the “Interrupt Request Bus.” When this happens it will have the effect of driving this said “Fundamental Control Memory System” into a predetermined state. With this change of state, the “Fundamental Control Memory System” will then redirect all the rest of the subsystems of the general purpose FIS processor unit of claims (2) and (6), except that of the “Clock System”, assuming there is a master clock built into the system, which will be under control of the “Bootup System” during this time, into the boot-up sequence.

As for establishing this precedence within the “Fundamental Control Memory System” for the “Bootup System” over all other subsystems that send signals to the “Fundamental Control Memory System”, including that of the “Primary bit-slice feedback Programmed Memory System”, it will be achieved by the proper programming of the bit-slice feedback program/bit-mapping process that will be placed into the memory circuits of this said “Fundamental Control Memory System”; programs that, when this special line from the “Bootup System” to the “Fundamental Control Memory System” goes active, will treat everything else that the “Fundamental Control Memory System” has been doing and receiving from all the other subsystems within the general purpose FIS processor unit of claims (2) and (6), including that of the “Primary bit-slice feedback Programmed Memory System,” as insignificant—that is, all of these other signals are treated as invariant.

A Further Note on the Fundamental Control Memory Subsystem

It should be noted at this point that this “Fundamental Control Memory System” of the general purpose FIS processor unit of claims (2) and (6)—which, in conjunction with the “Primary bit-slice feedback Memory System”, serves as the core of this said bit-slice feedback general purpose FIS processor unit of claims (2) and (6)—does not necessarily function purely as a bit-slice feedback programmed system. Nor does it necessarily act purely as a bit-mapping process system. Rather, it, for many different types of “general purpose FIS Processor Units” that can be designed in accordance with claims (2) and (6), will operate as a composite of both types of systems.

Modes

To understand how this can be, how the “Fundamental Control Memory System” can act at times as purely a bit-mapping process device and then at other times as a bit-slice feedback programmed system, it must be understood how some of the very many different types of general purpose FIS processor units of claims (2) and (6) are going to be constructed. Some of these designs will possess the ability to run in different modes, as identified in claims (49) through (55). The two most common mode pairs that will be built into these new types of computer systems are those of Kernel Mode and the Application Mode and that of the Real Mode and the Protected Mode (both of these pairs of modes will be explained in more detail below).

In addition, there may be other types of modes that can be included in the general purpose FIS processor unit of claims (2) and (6), depending upon what function, or functions, the general purpose FIS processor unit of claims (2) and (6) will be designed to carry out. Regardless of which modes are incorporated into a given design of a general purpose FIS processor unit of claims (2) and (6), they all will, in general, be implemented in the same basic manner.

To begin with, the hardware that will be used generally to implement these various modes is that of a hold register (or, if necessary, a small bit-slice feedback programmed memory system). This said hold register, or small memory system, will be added to the “Fundamental Control Memory System”, as identified in claim (57). Also, this hold register, or memory system, will allow the general purpose FIS processor unit of claims (2) and (6) to keep track of which mode it is in.

Then to make use of these different modes built into a general purpose FIS processor unit of claims (2) and (6), the processor unit must have its bit-slice feedback programs and bit-mapping processes, especially those processor-programs placed in the “Primary bit-slice feedback Programmed Memory System” and the “Fundamental Control Memory System”, constructed in such a way as to include into its instruction set the necessary instructions to change the computer system from one mode to another; a process presently used by the current generation of general purpose FIS processors constructed from logic circuitry.

A Further Note on the Fundamental Control Memory Subsystem, continued

Thus in general purpose FIS processor units of claims (2) and (6) that make use of different types of modes to operate under, as identified in claims (49) through (56), when none of these modes are active—that is, the computer is running in its most basic state—the “Fundamental Control Memory System” operates not so much as a bit-slice feedback programmed device but as a bit-mapping processor, that is, there is no real feedback taking place within this subsystem.

But then when any or all of the various modes that might be built into a given general purpose FIS processor unit of claims (2) and (6) are made active, such as when a given general purpose FIS processor unit of claims (2) and (6) is running the under Application Mode of the Kernel Mode and Application Mode pair or under Protected Mode of the Real Mode and Protected Mode pair, then when this is the case, the processor-program of the “Fundamental Control Memory System” will behave more as a bit-slice feedback program rather than a bit mapping process. That is, this subsystem will be receiving feedback of a limited type.

Nonvolatile Memory Boot-Up Sequence (Continued)

Now whenever the “Fundamental Control Memory System” is driven by the “Bootup System” into the boot-up mode, this system, when it enters into this state of operation, will perform as a bit-mapping processing device. That is, all of its output lines from the main memory of the “Fundamental Control Memory System” are given predetermined values; and that the determination of these values will not, in any way, be effected by any feedback that might be active within the “Fundamental Control Memory System (i.e. the status of the hold registers for the various mode pairs) at the time the “Bootup System” sends its signal to the “Fundamental Control Memory System.”

Then once the “Bootup System” has set the “Fundamental Control Memory System” into the boot-up mode, the “Fundamental Control Memory System” drives the master controller to access the BIOS-which, like the present various types of computers which are built around the various FIS general purpose processors made from logic circuitry, will be a part of the “external” memory found in the “Rest of general purpose FIS Computer”—so as to send the first instruction to the “Primary bit-slice feedback Programmed Memory System.”

Handling of BIOS

Note: that because of the unique nature of this type of computer system, one built around the general purpose FIS processor unit of claims (2) and (6), the BIOS can be handled in one of two ways. It, like the present computer system built around a “general purpose FIS Processor Unit” that is constructed from a multiplicity of logic circuits, can have the BIOS embedded into EPROMS. Or this new type of computer system can have the “Bootup System” shown in FIG. 2 load the BIOS up into the a small part of the “external” volatile memory found in the “Rest of general purpose FIS Computer”, from where it will be run. Then once the BIOS has completed its task, it can then be removed from local memory, opening up that addressing area in that “external” memory system.

Now the advantage to using this latter approach to handling the BIOS is two fold. First, it, as just stated above, opens up addressing areas within one or more of the “external” memory systems that would otherwise have been permanently taken up by the BIOS. Second, the upgrading of the BIOS would be far easier to do than in those computer systems that have the BIOS stored in EPROMS.

Nonvolatile Memory Boot-Up Sequence (Continued)

Regardless of how the BIOS is handled, once it starts to run, the system based upon the general purpose FIS processor unit of claims (2) and (6) executes its first sequence of instructions, a set of commands which, like nearly all other general purpose FIS computers in existence at the time of filing of this patent application, has a two fold goal. First, this program checks to see which hardware is attached to the computer system by way of the I/O subsystem(s). Then after determining this, the BIOS sees to the loading of the operating system into “external” program/addressing memory(ies) of this computer; the program that, once it is loaded into “external” memory, will take over control from the BIOS and then see to the overall operation of the computer including overseeing the operation of all the various application programs that can be run either sequentially or concurrently on this said general purpose FIS computer system.

Introduction—Multitasking/Multiuser

As identified in claims (22) and (56), a general purpose FIS processor unit of claims (2) and (6) can be designed to accomplish both the multitasking and multiuser functionality. To do this, a computer system built around a general purpose FIS processor unit of claims (2) and (6) will, in general, make use of four separate, but closely related functions—functions that will be built into the hardware and/or the software of one or more of the subsystems of this computer; including that of the general purpose FIS processor unit of claims (2) and (6) itself.

Before explaining these four interlocking functions, it needs to be stated at this point that in most general purpose FIS computer systems—which will, in time, also include those general purpose FIS computers that will be built around general purpose FIS processor units of claims (2) and (6)—have looked upon the multiuser functionality of a computer, for the most part, as a part of the much greater function called multitasking. For when an existing operating system that is capable of running more than one application at a time, such as a Unix type operating system, receives a request to run an application, the first thing that this type of computer system does is to assign to that application the necessary computer resources so that that program will be able to run. Once an application has been assigned these necessary resources, the operating system will then treat that application as just one more task in the list of tasks that requires a certain amount of time upon the CPU unit.

The time that each particular task will receive on the CPU is determined by a part of the operating system called the scheduler. This process, this scheduler, does not, in any way, care from where the request to run that program comes. All that it cares about is what priority level the task has and how much time it has already had on the CPU. Then based upon these two bits of information, on priority level and previous CPU usage, the scheduler determines how quickly and for how long that task will again run on the CPU, as compared to all of the other tasks that also need to be run on the same CPU.

On examination of this multitasking process one discovers that none of the steps in this process changes significantly if there is more than one user on the system. Only two things really change from user to user. First the range of computer resources that are made available will, in general, be different from one user to the next. Second, the operating system will need to keep track of where the input comes from and where the output goes when a given program is being run by a given user. But as for the running of the programs, that does not change with the user.

So because of this continuity of running processes, most operating systems that have multiuser capacity operate, for the most part, as if this multiuser functionality is little more than an add-on feature to that of the operating system's multitasking functionality. What is more, if one examines the situation from the perspective of the multiuser functionality, what one discovers is that there cannot be a multiuser computer system that is not, first and foremost, a multitasking computer system.

As for future computer systems that will be built around the general purpose FIS processor unit of claims (2) and (6) and that will offer multitasking and multiuser functionality, the operating systems for these systems will handle, for the most part, the multiuser functionality in the same way as that of past and present operating systems have handled these services. Multiuser functionality will be treated for the most part as just an add-on feature to the multitasking functionality; that is, multiuser functionality will simply be a part of the multitasking functionality, with certain constraints and limitations.

Function One

Now as to the first function that makes multitasking, and thus multiuser functionality, possible in a computer system built around a general purpose FIS processor unit of claims (2) and (6)—at least in its simplest form—it will consist of having built into the various “external” memory systems and I/O systems of this computer system dual addressing systems. And that these dual addressing systems will allow this computer system to access each of the “external” memory banks or I/O systems by way of one of two different, distinct means.

The first of these addressing systems will be called, in this patent application the Kernel Addressing System. The second will be referred to as the Application Addressing System. And as these names imply, one will be used by the kernel of the operating system and the other by the applications that will carry out specific task for the operating system.

Now each of these two distinct addressing systems within each of the “external” memory systems as well for the various I/O system(s) that provide data to the general purpose FIS processor unit of claims (2) and (6) will be independent of each other; the values that can be sent from one addressing system will be completely separate from the values the other can send.

It should also be noted that these two addressing control systems—Kernel Addressing System and Application Addressing System—can, in their turn, be broken up, if need be, into two or more subaddressing systems. And what this means is that each “external” memory system that feeds data and/or programming information to and receives data from the general purpose FIS type processor unit of claims (2) and (6) can be addressed by this general purpose FIS processor unit in one of four or more different, distinct ways—which, by way of note, creates an enormous degree of flexibility in how these various “external” memory systems can be handled. And it will, in the end, be this greater degree of flexibility in handling “external” memory and I/O systems that will be a major contributing factor to this new type of computer system's greater potential ability to manipulate data and transfer data throughout the system than is presently found within the present computers built around the “general purpose FIS Processor Units” based on a multiplicity of logic circuits consisting of AND and/or OR gates, shift registers, flip-flops and the like.

Function Two

The second and third functions for carrying out multitasking within the computer built around a general purpose FIS processor unit of claims (2) and (6) are to be directly incorporated directly into the “general purpose FIS Processor Unit” itself.

As for the first of these two functions, it is the ability of the “Primary bit-slice feedback Programmed Memory System” to respond to three specific instructions within its instruction set. The first of these instructions, when called, has the effect of toggling the general purpose FIS processor unit of claims (2) and (6) from the Kernel Mode to the Application Mode, as in accordance with claim (58). And this change of mode is registered and recorded within the “Fundamental Control Memory System” of this general purpose FIS processor unit by way of changing the state of a mode register (or a small bit-slice feedback programmed memory) that is there for that purpose, as explained above.

Function Three

The third function to make multitasking a part of the computer system built around the general purpose FIS processor unit of claims (2) and (6) involves the “Fundamental Control Memory System” carrying out two events which, in all likelihood, will occur simultaneously. First, this subsystem of the general purpose FIS processor unit of claims (2) and (6) directs the addressing systems for the various “external” memory banks to switch from one addressing system to another. If, for example, the computer has been using the Kernel Addressing Systems to access the various “external” memory banks (thus the system has been in the Kernel Mode), then the “Fundamental Control Memory System” directs all these memory banks to start using the Application Addressing Systems (the system switches to Application Mode).

If, on the other hand, it has been using the Application Addressing System, then the memory banks are directed to once again to return to the use of the Kernel Addressing System—returning the general purpose FIS processor unit of claims (2) and (6) to the Kernel Mode.

The second event that the “Fundamental Control Memory System” carries out is one that occurs whenever the system is going from the Kernel Addressing System to the Application Addressing System. And this event is that another subsystem within the “Fundamental Control Memory System,” hereafter to be called the Application Counter Register (which can, if need be, be a small bit-slice feedback programmed memory system), receives a numerical value from the scheduler—that part of the operating system that coordinates the flow of tasks to the “general purpose FIS Processor Unit.” And the Application Counter Register serves the same role in this new general purpose FIS processor as the IRQ timer does in the general purpose FIS processors built from logic circuitry. However, this new approach to allowing the processor to switch between processes will be far more flexible than the use of a timer.

Once the “Fundamental Control Memory System” has set the Application Counter Register with a number provided by the schedular, the general purpose FIS processor unit of claims (2) and (6) then begins to carry out, one at a time, the instructions contained within the application program that is being run as a process under the operating system. And after each instruction has been carried out, the “Fundamental Control Memory System” will clock down the value found in the Application Counter Register by one. Or in some cases, the Application Counter Register may be counted up depending upon the design of the Application Counter Register and how it is integrated into the overall system.

And after this last action, of counting up or down, one of two things will then happen. If the Application Counter Register has not yet reached a set point—which, in general, is zero—then the “general purpose FIS Processor Unit” goes on and runs another instruction for the present application. If, on the other hand, the Application Counter Register has reached the designated set point, then the general purpose FIS processor unit of claims (2) and (6), by way of its “Fundamental Control Memory System”, converts the system back into the Kernel Mode, and in doing so resets the computer system to once again use the Kernel Addressing System for the various “external” memory systems.

The effect of all of this latter interaction between the rest of the “Primary bit-slice feedback Programmed Memory System” and that of the Application Counter Register is that the operating system can, after a certain number of instructions have been carried out for a given process, take back control of the “general purpose FIS Processor Unit.” And once the operating system has control of the “general purpose FIS Processor Unit”, it then can make a determination. It can either allow the process that was just stopped to run again for a given number of instructions. Or it can then allow another application, another process, to have its turn at directing this said “general purpose FIS Processor Unit.” That is, the operating system allows the next application on the list held by the scheduler the opportunity to run a given number of instructions.

And that of the four basic functions built into this type of computer system that allow such a computer system to accomplish multitasking, this one, the counter register that toggles the system back into the Kernel Mode after completing a certain number of instructions, is the most crucial of them.

Function Four

In the present processors built upon logic circuits, there are a large number of registers in the said processor; registers that when the general purpose FIS processor changes from one process to another under the direction of the operating system must be stored in RAM. And in this new type of computer, the same type of action can be taken if this new computer system is set up to mimic the present and past generations of general purpose FIS processors that make use of internal registers. All of the values for addressing and the ALU/math-coprocessor can be stored and then later retrieved for RAM when switching between processes. And this is the fourth function that his new processor will, if necessary, use to carry out multitasking.

However in may ways this last functionality, this storing and retrieving addressing and register values, will not be necessary in a well designed general purpose FIS general purpose bit-slice feedback computer. The reason for this is two fold. First, those registers (which are, in actual fact, nothing more than singleton memory locations) made use of in the ALU and math-coprocessor of the present and past generations of general purpose FIS processors will not be needed in the properly designed new computer system built around general purpose FIS processor unit of claims (2) and (6).

And the biggest design improvement is to have the “Data Input/Output Bus” consist of three independent data transfer subsystems. And in this configuration, two of these said data transfer subsystems could be used to bring in data to the various subsystems within the ALU/math-coprocessor. And the third of these data transfer subsystems would be used to transfer, immediately on completion of the given subsystem within the ALU/math-coprocessor, the result of this said subsystem to one of the “external” memory system.

In this arrangement, there would be no need to have any “long-term” storage, i.e. internal registers, within the said general purpose FIS processor to serves the ALU/math-coprocessor. That is, the resultant products of the said manipulations of the input data will be immediately transferred to the RAM within the system. As for how this will work, that shall be explained in the latter section, the “Best Mode.”

As for the registers used in handling addressing functions and other internal functions within the processor in this new system, they will no longer be singleton memory locations. Rather, in the properly designed new computing system built around general purpose FIS processor unit of claims (2) and (6), each of these singleton memories (i.e. registers) will be expanded out into “large” memories of at least sixty-five thousand storage spaces. Then the addressing systems for these “large” memory systems that will be used to provide the addressing values to the RAM and the various I/O systems for the system will then be further abstracted within this new computer system. That is, all of these said addressing systems with their “large” addressing memory systems will, in their turn, be linked to a singleton memory register.

In this type of configuration, changing the value in this singleton memory will allow this new computer system to switch between processes without the need to download and then upload all of the addressing information for a given process. Also, as mentioned earlier, each of the Ram systems and I/O systems—which this new system may have more than one of each—will have more than one addressing system. There will be at least one addressing system for the kernel and at least one addressing system for the applications. All of these addressing systems for all of the RAM systems and I/O systems will be tied together into two grand abstracts, one for the kernel addressing system and one for the application addressing system. In this way, this new computer system built around this new general purpose FIS processor unit of claims (2) and (6) can change from one kernel process, or a given application process, to another by simply changing the value in the kernel addressing register or the application addressing register.

And so as mentioned above, the internal registers used in the present processors constructed from logic circuitry for internal control and functionality will, for the most part, not exist in the internal structure of the general purpose FIS processor unit of claims (2) and (6)—the only major exception to this being the singleton memory location found in the “Hold” subsystem mentioned above. However in this new computer system built around the general purpose FIS processor unit of claims (2) and (6) there will be set up a specialized fast external RAM system, at least in the first several generations of this new system built around this new general purpose FIS processor unit of claims (2) and (6), that will serve as a means for this new type computer system to mimic the functionality of the registers in the present and past generations of general purpose FIS processors built from logic circuitry, such as the x86 type microprocessors. This, in its turn, will allow this new computing system, at least with regards to the first generation of this new type of general purpose computing system, to run nearly all of the software that has been written for the x86 type computer systems and which makes use of these internal registers.

Advantage of the Toggling System

Now the great advantage of incorporating two separate addressing systems, one system used for the kernel processes and one used for the application processes, for the various “external” memory systems and I/O systems of this computer system—and thus handling the multitasking and multiuser functionality in this particular way—is that all of the fundamental instructions that make up the instruction set that are not directly related to multitasking (i.e. adding bytes together, multiplying bytes one with another, moving bytes and words from one place to another and the like) to remain the same regardless of whether or not a program is being run under the Kernel Mode or under the Application Mode.

In other words, all the higher level programs such as that of the operating system, word processors, data base systems, electronic spreadsheets, and the like, can be written using the same basic methodology and can be compiled with the same basic compilers and/or interpreters. All of this can be done without concern as to whether or not the particular program will, in general, operate in a multitasking environment or in a single application environment.

Multitasking and Mimicry

And as stated in claim (27), this instruction set that will be applicable in both of these modes, the Kernel Mode and the Application Mode, can also be designed to serve another purpose; that of fitting as closely as possible with the instruction set, or instruction sets, that go along with the more popular, presently manufactured general purpose FIS microprocessors. In doing this latter task, that of mimicking a present general purpose FIS microprocessor, there can be a more fluid and rapid conversion of many of the present higher level programs, programs that are now run on either the Intel/AMD processors or Motorola processor units, to run on this newly designed hardware. In some cases, the mimicking of the instruction sets can be made to be so exact that it will allow for a quick substitution of hardware with little, if any, interference with the operation of these higher level programs, as identified in claims (27) and (28), including that of multitasking and multiuser functionality.

Introduction to Real/Protected Modes

This then explains, in outline form, how this new processor unit based on claims (2) and (6) will be able to carry out the multitasking and multiuser functionality, and also allow the system to fit into the role of a mimicking processor unit. Yet this is not all that this new type of “general purpose FIS Processor Unit” must be able to accomplish if it is going to match, if not exceed, the performance of the present general purpose FIS microprocessors based on a multiplicity of logic circuits consisting of AND and/or OR gates, shift registers, flip-flops and the like. What it must also do in addition to carry out multitasking is to have the capacity to carry out what the more powerful Unix like operating systems (systems such as BSD and Linux) require. That is, to allow this computer system to operate in two other modes in addition to the Kernel Mode and the Application Mode: these other modes being the Real Mode and the Protected Mode.

Real Mode

In the first of these additional modes, that of the Real Mode, the program that is running under this mode—regardless of whether it is running under the Kernel Mode or the Application Mode—will have complete and unfettered access to all of the computer system's resources, including, but not limited to, all of the I/O system functionality.

Protected Mode

In the second mode, that of the Protected Mode, the freedom of access to all the various resources within this new general purpose FIS computer, especially that of the access to the various aspects of the I/O system, is greatly curtailed for those programs that are also running under the Application Mode. That is, if the instructions of a program happen to be carried out while the general purpose FIS processor unit of claims (2) and (6) is in both the Application mode and the Protected mode simultaneously, the only way that this program can receive or send information to or from the I/O system is by way of calls to the kernel of the operating system which, by way of note, is always run in the Kernel Mode. But any program that happens to be running under the Kernel mode—especially that of the kernel of the operating system—will continue, regardless of whether the system is in Real Mode or Protected Mode, to have complete and unfettered access to all the various resources of the computer, including the I/O system, at all times; which, of course, is necessary if the kernel is to process the various calls that it receives from the various application programs that are being run under it as tasks and which are also run when both the Application Mode and the Protected Mode are active.

Implementation of the Real/Protected Modes

The means by which the Real/Protected Modes will be carried out in a general purpose FIS processor unit of claims (2) and (6) is very similar to that of how the multitasking functionality is accomplished within this same “general purpose FIS Processor Unit.”

First, there will be built into the “Fundamental Control Memory System” a subsystem called the Protected Mode Register (which, if necessary, can be a small bit-slice feedback programmed memory system). Like the Application Mode Register, the Protected Mode Register will be used to create a feedback loop within the “Fundamental Control Memory System” which will keep the system in either the Real Mode or the Protected Mode until one of two instructions is sent from the kernel to “general purpose FIS Processor Unit”; an instruction which will have the effect of causing the “Fundamental Control Memory System” to change the state of this register.

The second mechanism to implement the “Real/Protected” mode pair are the two instructions that can be sent to the general purpose FIS processor unit of claims (2) and (6) to cause this toggling from either Real Mode to Protected Mode or from Protected Mode to Real Mode.

The one difference in the implementation of the Real/Protected Mode pair to that of the KerneVApplication Mode pair is that in the operation of the former mode pair there will not be a counter register associated with its application; a counter register that is used in the “Fundamental Control Memory System” to toggle the system from one mode to another when a given set point, such as zero, is reached.

Note on Bit-Slice Feedback General Purpose FIS Programming

Now in order to have a bit-slice feedback programmed memory system, displayed in FIG. 2 as the “Primary bit-slice feedback Programmed Memory System”, function as the core of a “general purpose FIS Processor Unit”, it must be able to do one thing above all else: that of receiving instructions from the “Rest of general purpose FIS Computer.” Once the “Primary bit-slice feedback Programmed Memory System” has done this critical step, to have received an instruction from the “Rest of general purpose FIS Computer”, it must then be able to promptly act upon that instruction.

Now in order to understand how the first of these two tasks can be done, it must be remembered that the output and addressing system for memory circuits within the “Primary bit-slice feedback Programmed Memory System” are “normally” linked in a tight feedback loop; that is what it means to be a bit-slice programmed memory device. But in order for an instruction to be accepted by the “Primary bit-slice feedback Programmed Memory System”, this immediate feedback loop for this said “Primary bit-slice feedback Programmed Memory System” must be temporarily interrupted and redirected. It is during these periods of interruption and redirection of the input to the addressing system for the bit-slice feedback programmed memory circuits within the “Primary bit-slice feedback Programmed Memory System” that the general purpose FIS processor unit of claims (2) and (6) is able to receive its instruction from the “Rest of general purpose FIS Computer”, instruction that the said “general purpose FIS Processor Unit” then uses to direct its own operation.

But during this first task, that of taking in an instruction, something quite out of the ordinary occurs, at least from the perspective of a “normal” bit-slice feedback programmed system. And that is that during the severing of the immediate feedback mechanism within the “Primary bit-slice feedback Programmed Memory System” a much larger and more encompassing feedback loop develops, as is explained in claim (39) below; a feedback loop that is just as strong and just as influential as that of the “normal” immediate feedback loop. However this larger feedback loop takes in its overall sweep of operation not only the memory circuits of the “Primary bit-slice feedback Programmed Memory System” but also the “Fundamental Control Memory System” as well as the “external” RAM that contains the program that is being run.

It is this very much larger feedback loop that makes it possible to convert what is an otherwise very much limited mechanism—that of the standard bit-slice feedback programmed device—into a much more powerful mechanism: that of the core element of a fully functional general purpose general purpose FIS processor unit. Or to state it another way, most bit-slice feedback programmed systems, those bit-slice feedback programmed systems that have, in the past, been designed and built for narrow specific tasks, did not, in general, have a smaller feedback loop built within a larger feedback loop. But it is this feature, and this feature alone, that makes it possible for a series of bit-slice feedback programmed systems to do what it otherwise is not able to do; to serve as a “general purpose FIS Processor Unit” system as it is being described in this patent application.

Nature of the Clock System

As explained in the previous section, the “Clock Subsystem”, this new type of computer built around this new type of general purpose FIS processor unit need not be built around one particular “master clock.” Rather, with nearly all, if not all, of the subsystems found throughout this new computer system, such as all of the functions in the “ALU/Math-coprocessor” and all of the addressing/accessing subsystems for RAM and I/O, being constructed about their own local bit-slice feedback programmed devices, this system naturally lends itself to being designed as an asynchronous device. That is, each of these individual bit-slice feedback programmed devices can be run on their own clocks. In that way each of these subsystems can be driven to their maximum speed.

But then to be able to link all of these systems together so that they can be made into an integrated whole, each of the individual bit-slice feedback programmed devices running these various subsystems will have input and output lines that will link to the “Fundamental Control Memory System” to all other subsystems so that they can communicate with one another. Through these communications, the overall general purpose FIS processor unit of claims (2) and (6) will be able to carry out the instructions it receives from the programs being run from RAM, EPROMS or flash memory.

But if this new type of computer system is built using a master clock system its structure will be as follows. The “Clock System”, as shown on FIG. 2, like other clock systems found in other general purpose FIS computers, if it is placed in the system, will be there to stabilize and synchronize the flow of information throughout the system. But in this particular computer, there will not be, in general, one timing line coming from the “Clock System”; a line that terminates at a whole host of various points throughout the rest of the computer system. Rather, there will be, in most designs of the general purpose FIS processor unit of claims (2) and (6) that use a master clock, a multitude of timing lines sent from the “Clock System” to a multiple of points throughout this computer system. In fact, there will be timing lines sent to every point within this computer system built around a general purpose FIS processor unit of claims (2) and (6) wherein feedback is in operation.

The principle source of this feedback in this type of computer is, of course, the many bit-slice feedback programmed memory systems that will be scattered throughout it. The number of these timing lines will vary from system to system depending upon both the design of the general purpose FIS processor unit of claims (2) and (6) and the design of the “Rest of general purpose FIS Computer.” For different designs of this new type of computer system will use differing numbers of feedback loops and feedback systems; that is, they will use differing numbers of bit-slice feedback programmed devices and bit-mapping devices.

As for these various timing lines, the “Clock System” will send out the signals over these lines in a very precise and accurately choreographed order; an order which will change depending upon the code it receives from the “Fundamental Control Memory System”; a code that will be different, depending upon which subsystems will be triggered to carry out a given instruction.

As for the master “Clock System”, if it is used within the system, it can, without difficulty, be constructed for several bit-slice feedback memory circuits linked together. In general there will be two such feedback memory circuits. One will be set up to determine the rate at which signals are sent out. The second would be used to determine the order in which the various signals are to be sent; changing it based upon the instruction being executed by the master controller.

Size of the Instruction Set

Another aspect of the general purpose FIS computers built around general purpose FIS processor units of claims (2) and (6) that will, in general, be very different from the present computer systems constructed around general purpose FIS microprocessors that use a multiplicity of logic circuits is in regards to the size of the instruction set as in accordance with claim. As this claim identifies, the instruction set for a general purpose FIS processor unit of claims (2) and (6) can be made, if desired, to be very much larger than that of the present general purpose FIS microprocessors based on a multiplicity of logic circuits; especially if the computer system built around a general purpose FIS processor unit of claims (2) and (6) is designed in accordance with the claim 91.

Two Reason for Potentially Larger Size to the Instruction Set

There are two reasons why this can be so, this new type of general purpose FIS computer system can have a much larger instruction set than that of the presently manufactured general purpose FIS computer systems. First, if the word that encodes the instructions of the instruction set is 16 bits long, then this word size—small in comparison to, say, a 32-bit or 64-bit word—will still allow for as many as 65,536 internal states to exist for the bit-slice feedback program that is to be contained within the “Primary bit-slice feedback Programmed Memory System.” And if one assumes that, on average, the number of internal states that the “Primary bit-slice feedback Programmed Memory System” will need to carry out any given instruction is, in general, five steps long, then the number of possible instructions in the instruction set of a given general purpose FIS processor unit of claims (2) and (6), if it uses all its internal states, is 13,107.

It should be noted that the number given here for the average number of steps for the bit-slice feedback programs for the various instructions is purely a hypothetical one. For this number cannot be known with precision until after a given designed general purpose FIS processor unit of claims (2) and (6) has been fully laid out and engineered. That is, the complete structure of the black boxes and the arrows shown in FIG. 1 have been completely worked out.

After these systems have been fully designed, especially in the way that the “Primary bit-slice feedback Programmed Memory System” will work with that of the “Fundamental Control Memory System” which will, in it's turn, work with the “Clock System.” If any, it may turn out that the average number of steps for the various bit-slice feedback programs that carry out the various instructions will be some other number: say 2.5, or 3.3, or 4.1, or some other small number. What is more, the number for the average length of each of these bit-slice feedback programs for the various instructions will, in all likelihood, vary from one type of general purpose FIS processor unit of claims (2) and (6) to the next. So, for these two reasons this number for the average length of the bit-slice feedback programs will remain indeterminate until the precise design of a given general purpose FIS processor unit of claims (2) and (6) is complete.

But regardless of what the average length for the various bit-slice feedback programs turns out to be—2.5, 3.3, 4.1 or some other small number—what will still be true is that when this number is divided into 65,536 it will give a count to the number of possible instructions for this system that will far exceed that of the number of instructions presently found in the present instruction sets for the presently manufactured general purpose FIS microprocessors. Such as those built around a multiplicity of logic circuit—this latter type of system has, in general, several thousand instructions.

Note on Size of Present “general purpose FIS Processor Units” Based on Logic Circuits

As for the number of instructions in the present generation of general purpose FIS processors built from logic circuitry, that of several thousand, a quick note needs to be made. For it may appear that this number is too large by roughly an order of magnitude; large because most reference sources state that there are between two and six hundred instructions for the modern microprocessor built from logic circuits.

But what is missing from this more common figure of two to six hundred is the fact that these various quoted “instructions” possess a whole range of nuances and subtleties. For example, the addition instruction can take on as much as a dozen different forms. There are two fundamental factors that differentiate one form of addition from the next. First, there is the question of where the “general purpose FIS Processor Unit” will be getting the data that it will then use to carry out the addition—be it from the various internal registers, or from any number of different locations found in the “external” memory systems, or some combination thereof. Then there is, of course, the issue of where the processor will place the result of the addition that it carries out. Again, does it place this new number in one of its internal registers, a register contained within the “general purpose FIS Processor Unit” itself? Or does it place the results of its addition into “external” memory?

And for a “general purpose FIS Processor Unit” to be able to make this type of distinction between different types of additions, and thus be able to carry them out, each and every one of these many forms of additions require a different binary code to be assigned to them. So, if one counts the entire operational code set, or instruction set, the true number of instructions for the present general purpose FIS processors is much greater than the oft quoted figures of between two to six hundred.

Two Reasons for Potentially Larger Size of Instruction Set (Continued)

So the number for the potential size of the instruction set for this new type of “general purpose FIS Processor Unit” of 13,107 is based, as just explained, upon an instruction set that is encoded with 16-bit words and where the average length of the processor-programs within the “Primary bit-slice feedback Programmed Memory System” is five steps long. But if the instruction set were to use a word size different from 16, such as one with 24-bits, then the number of possible instructions, assuming again that on average each processor-program for each instruction within the “Primary bit-slice feedback Programmed Memory System” is just five steps long, climbs to 3,355,443.

But in most cases, at least for the near future, a system that uses a 16-bit word to encode its instruction set would be more than adequate to allow for all the instructions the “general purpose FIS Processor Unit” would need. For even if you build a general purpose FIS computer around a general purpose FIS processor unit of claims (2) and (6) that took advantage of multiple RAM systems and data transfer subsystems within the “Data Input/Output Bus,” such a system could have in the neighborhood of two to three thousand basic instructions (such as moves, compound moves, additions, compound additions, subtractions, compound subtractions and the like). But even at three thousand such basic instructions, this would still leave roughly ten thousand possibilities open for other types of instructions; instructions that could be of a much more advanced character. Included in this list of more advanced instructions could be a whole host of instructions that could, for example, give answers to a variety of mathematical functions such as trigonometric functions, logarithmic functions, etc. In addition to this class of instructions, another set of powerful instructions could be created that could perform data correction. Then another set of instructions could be created to do all sorts of data encryption and decryption. The possibilities with this type of general purpose FIS processor unit, one built in accordance with claims (2) and (6), are enormous.

This then is the first reason why such a general purpose FIS processor unit of claims (2) and (6) can have such a large number of instructions. But as mentioned above, this is not the only reason why this type of processor unit, one built in accordance with claims (2) and (6), can have an enormous instruction set. For the truth is is that the presently manufactured FIS general purpose processors based upon logic circuits such as AND or OR gates also make use of 16 bit words to encode their instructions. But obviously they do not make full use of the potential associated this size of word. For if they did, their instruction sets could, since they have no need to use more than one internal state to carry out a given “explicit” instruction, contain 65,536 instructions.

So the real difference between these two types of “general purpose FIS Processor Units” with regards to the size of their instruction set arises from another factor. That other factor is in how easy, or how difficult, it is to produce the said “general purpose FIS Processor Unit” with all of its functionality. In the case of the general purpose FIS processor unit of claims (2) and (6), the creation of this system rests principally upon producing a form of “software”, i.e. bit-slice feedback programs and bit-mapping processes. This product, or special form of “software”, proves far easier to design, manipulate, mold and create than that of a product produced from a vast and intricate network of logic circuits consisting of AND gates, OR gates, shift registers, flip-flops, etc,.

What is more, once the bit-slice feedback programs and bit-mapping processes have been created for a given general purpose FIS processor unit of claims (2) and (6), they are far easier to put into memory circuits and then transfer these memory circuits to silicone than it is to inscribe a whole new intricate logic circuit into silicon wafers. It is for this reason that the general purpose FIS processor unit of claims (2) and (6) can come to have far more extensive instruction sets than that of the presently manufactured general purpose FIS microprocessors. Or to put it another way, memory circuits have become, in the last ten years, far easier to make and far more capable of doing things than that of a multiplicity of logic circuits.

Programming Sequence of Bit-Slice Feedback Programs

So all of the superior power of the general purpose FIS processor unit of claims (2) and (6) comes from the inherent superiority of bit-slice feedback programming and bit-mapping process over that of trying to provide functionality through the use of a multiplicity of logic circuits consisting of AND and/or OR gates, shift registers, flip-flops, etc,.

Thus to properly understand the potential of this general purpose FIS processor unit of claims (2) and (6), one must understand the nature of bit-slice feedback programming. As for an initial introduction to these processor-program technologies, it was provided in the “Background Art” section given above. But, there remains to be explained one further important point about bit-slice feedback programs that was not given in that earlier discussion and which will be especially true for many of the bit-slice feedback programs that will be placed into “Primary bit-slice feedback Programmed Memory Systems” of many of the different types of general purpose FIS processor units of claims (2) and (6). That point is is that the code sequence for a bit-slice feedback program need not be in a linear numerical order.

As to what this means, the “Background Art” section of this patent application explained that bit-slice feedback programs are, at their very essence, nothing more than a sequence of numbers—generally binary numbers—that serve three basic purposes. First, these numbers are used to uniquely encode each of the nodes that make up the flow chart that allows a given bit-slice feedback programmed system to accomplish a given task. Second, part of each of these numbers that make up this processor-program serve as the output signal that will be sent to the “outside” world. Third, these numbers that make up each of the steps in the bit-slice feedback program also act as part of the addressing value for the memory location to which the next number in the program sequence is to be found; that is, part or all of each of these numbers that make up the bit-slice feedback program act as addressing values.

But these numbers that make up the bit-slice feedback program are not all there is to the addressing values for accessing the various memory locations that contain the bit-slice feedback program. Rather, part of the addressing values for the memory locations for the bit-slice feedback program are provided by signals from the “outside” world, signals that have been properly digitized if they were originally analog. And as for this latter component—this digitized input from the “outside” world—it is this input that allows a bit-slice feedback program to have what is called branch points: that is, to have points within the processor-program wherein the “decision making” process can play an important role.

And as this explanation shows, the implementation of this type of program is done by having the next number in the program sequence stored at a memory location that is being addressed by the combination of the present number in the program sequence (which is the immediate feedback that is built into all bit-slice feedback programs) and that of the “correct” digitized input from the “outside” world.

With this simple explanation of a bit-slice feedback program, the point that is being made here about the nature of bit-slice feedback programs can be restated as follows: that the sequence of addressing values that make up bit-slice feedback programs need not be, in any way, a linear numerical sequence—that is, this sequence of addressing values will not, in general, be of the form 1, 2, 3, 4, . . . .

And to better understand what this means, consider the following example. Suppose that in a particular designed general purpose FIS processor unit of claims (2) and (6), the “Primary bit-slice feedback Programmed Memory System” uses 16-bit words to encode its instruction set. As explained above, this size of word will allow the general purpose FIS processor unit of claims (2) and (6) to have up to 65,536 internal memory locations for its “Primary bit-slice feedback Programmed Memory System.” It is within this memory space that all of the code that will be used to execute all of the various instructions of the instruction set are to be found.

But these various sequences of code for the various instructions are not necessarily going to correspond to a linear numerical sequence. That is, the sequence of code for a given instruction—let us say a particular type of move function that requires five internal states to complete—will not, in all likelihood, be found sequentially within the memory circuits of the “Primary bit-slice feedback Programmed Memory System”; say between memory locations 00,234 and 00,239, for example. Rather, the first of the internal states might start, say, at 00,234. But from there, the next two internal states for this instruction may jump, for example, to the memory locations 36,345 and 36,346. Then from 36,346, the bit-slice feedback program sequence for this particular move instruction might then go to the memory location 54,978. Then finally, the code sequence for this move might come to an end at memory location 29,001.

Then, of course, the last step in the sequence of all the instructions in an instruction set of a general purpose FIS processor unit of claims (2) and (6), with the possible exceptions of the halt command and the reboot command, is to have the “Fundamental Control Memory System” direct the “Primary bit-slice feedback Programmed Memory System” to wait for the next instruction that will be sent to the “general purpose FIS Processor Unit” from the “Rest of general purpose FIS Computer”, as in accordance with claim (39). Then, once the “Primary bit-slice feedback Programmed Memory System” receives the next instruction, it will then run through the particular bit-slice feedback code for that particular instruction; and in this way this computer system will steadily work its way through a given set of instructions that make up a program.

But as for the hypothetical code for this particular hypothetical move instruction, it can be written down in a very concise form. In doing so it can be more clearly seen how the code for a particular bit-slice feedback program need not be in a linear numerical sequence. And the concise form of this particular hypothetical code sequence is as follows:

| Number of Steps | |
|---|---|
| for Code Sequence | Internal States (Absolute |
| (Relative Address Values) | Address Values) |
| 1 | 00,234 |
| 2 | 36,345 |
| 3 | 36,346 |
| 4 | 54,978 |
| 5 | 29,001 |
| | wait for next instruction |

With, of course, the understanding that what is written into the computer is not, in general, a series of numbers written in a decimal form. Rather, the numbers would, in general, be in a binary format least for those computers that have been built in accordance with a binary numeration system.

Why Jumps

Now as for why there will be these jumps in the bit-slice feedback code loaded into the “Primary bit-slice feedback Programmed Memory System”, there are two basic reasons for it. The first is one that is common to many bit-slice feedback programs. To make most bit-slice feedback programs nontrivial, one must include in their programming the ability for decisions to be made based upon input from the “outside” world. To be able to do this, a program must have one or more branch points. That is, the program must be able to go in one of two or more different directions at certain junctures in its programmed routine. And to achieve this process of redirection in a bit-slice feedback program, the processor-program will need to direct the computer to go to one of two or more possible locations within the memory system that contains the bit-slice feedback program. But different memory locations means different addressing values. And thus this means that the numerical sequence for the bit-slice feedback program will not be nice and neat and linear.

So this is the first reason that the code for a bit-slice feedback program—or in the case of the processor-program placed within the “Primary bit-slice feedback Programmed Memory System”, a series of bit-slice feedback programs brought together into one memory system—will not be in a linear numerical sequence: because of the “decision making” process.

The second reason why there can be divergence from a linear addressing sequence in the bit-slice feedback code is one that will be special to a certain type “Primary bit-slice feedback Programmed Memory Systems”. In particular, that group of “Primary bit-slice feedback Programmed Memory Systems” will be set up so as to mimic as closely as possible—and in some cases exactly—the various instruction sets of the various types of presently manufactured general purpose FIS microprocessors, as stated in claim (39).

And to do this mimicry, it will be necessary that some of the memory locations within the “Primary bit-slice feedback Programmed Memory System” of these various general purpose FIS processor units of claims (2) and (6) be claimed as starting points for various instructions; instructions such as moves, bit swaps, shift right of words, shift left of words, etc,.

Or to put it another way, when one goes about creating all of the various bit-slice feedback programs that will be written to carry out all of the various instructions that will make up the instruction set for his new type of “general purpose FIS Processor Unit”, a general purpose FIS process that will be designed to mimic another “general purpose FIS Processor Unit”, you must create this code in such a way as to avoid all of the internal states that correspond to the starting points for all the instructions that are contained within the instruction set of the “general purpose FIS Processor Unit” that is being mimicked. In this avoidance of starting points for mimicked instructions, the code for the various bit-slice feedback programs in the “Primary bit-slice feedback Programmed Memory System” will, as a result, jump about

So these are the two basic reasons why it will not, in general, be possible to write a nice neat bit-slice feedback code for the bit-slice feedback programs for the various instructions of an instruction set for the general purpose FIS processor unit of claims (2) and (6); that is, code that fits nicely into a linear numerical sequence.

### BEST MODE FOR CARRYING OUT THE INVENTION

Now returning to FIG. 1, this discussion of best mode application of these basic ideas will begin by first considering the arrows between the “Rest of general purpose FIS Purpose Computer” and “general purpose FIS Processor Unit.” Of these, this discussion will start with the “Power Bus.” In the first generation of general purpose FIS bit-slice feedback processors/computers, these first computing systems will make use of the present generation of transistor technology. This means that the power bus will provide electrical power at the various typical voltage levels, ranging 3 volts to as much as 15 volts.

Now as for the “Data Input/Output Bus,” in the computers constructed around processors built up with logic circuitry, the structure of this bus system was originally designed to best conform with the desire to minimize the cost of hardware. To do this it was determined early on that this bus should be broken down into two subsystems: One to bring into and transfer out of the general purpose FIS processor data and instructions and also to bring into the general purpose FIS processor the addressing values needed to access both the RAM and I/O systems. The second subsystem, called the address bus, was used to transfer addressing values from the general purpose FIS processor to either the RAM system or the I/O system; and in general, there was only one of each.

And as the general purpose FIS processors built from logic circuitry advanced and improved, this system continued, for the most part, to hold to this basic structure for the “Data Input/Output Bus”; growing from 4 bits wide in the first microprocessor from Intel, to data and addressing busses that are composed of 64 lines each.

But in order to have this type of “Data Input/Output Bus” work, especially with regards to arithmetic calculations, it was required that with general purpose FIS processors built from logic circuitry there be at least two internal registers (identified in this patent application as a singleton memory) be built within the processor itself. The first of these internal registers was used to hold the addressing values sent over the address bus to either the RAM system or the I/O system. The second internal register was used for carrying out arithmetic calculations, logic processes and bit manipulations. This second type of internal register was in some computer systems called the accumulator.

And with regards to these arithmetic calculations, logic processes and bit manipulations, the accumulator often served two functions: first to receive and hold one of the two numbers that is to be sent the ALU. Secondly, the accumulator was used to hold the results generated by the ALU.

Then to get the answer back out to the RAM or I/O system so that it can be stored and other arithmetic calculations can be done, the FIIS processor built from logic circuitry would then need to execute another instruction that would transfer the value in the internal register over the data bus to the said RAM or I/O system.

Now turning to the question of how to best design a new type of computer built around a general purpose FIS processor unit conforming to claims (2) and (6), the first point that needs to be recognized is how very easy it is to design and build a general purpose FIS processor unit conforming to claims (2) and (6). The second point that needs to be considered is how inexpensive hardware has become. Finally, it must be recognized that if it were possible to bring in two numbers into the ALU/math-coprocessor from RAM at a time and to have RAM accept the results from the ALU/math-coprocessor immediately would be the best theoretical approach to handling the functionality of the ALU/math-coprocessor.

And by considering these three insights, it can be realized that using only one data bus is not the optimum approach to the design of the “Data Input/Output Bus.” In fact, the optimum condition is where there are three data transfer subsystems built into the “Data Input/Output Bus.” And with such an arrangement, two of these said data transfer subsystems of the “Data Input/Output Bus” can be used to feed data directly to the ALU/math-coprocessor built into the general purpose FIS processor unit conforming to claims (2) and (6). This alleviates the old requirement of bringing data in one at a time, with the first number being stored in an internal register. Then with the third data transfer subsystem, this new computer system can, upon the ALU/math-coprocessor finishing either its arithmetic calculation, logical process or bit-manipulation, transfer the ALU/math-coprocessor output to either an RAM or I/O subsystems in the “Rest of general purpose FIS Computer” without the need to be stored in an internal register.

As for the structure of these three data transfer bus subsystems in this first generation product, they will be identical in size and functionality. Now as for there size, to at least match the largest floating-point arithmetic functionality found in the present generation of general purpose FIS processors built from logic circuitry—such as the calculation ability of the Motorola Risk general purpose FIS processors and that of the crusoe chips from Transmeta—they will need to be at least 128 bits wide. And at 128 bits wide, it allow these transfer subsystems, especially with regards to integer arithmetic calculations, to carry out 16 8-bit calculations, 8 16-bit calculations, 4 32-bit calculations, 2 64-bit calculations or 1 128-bit calculations. So this shall be the size of these data transfer subsystems.

As explained in the section “Nature and History of the Communications of the Black Boxes of Computer Systems”, the internal structure of the “Rest of general purpose FIS Computer” has been, up to this point, dictated by the restrictions created by the construction of the general purpose FIS processor units built from logic circuitry; its cost and its difficulty of design. As just explained, this in turn, limited the structure and size of the “Data Input/Output Bus” system to one data transfer subsystem and one output addressing subsystem.

However, as was also just explained, it would, on a theoretical bases, be better if this “Data Input/Output Bus” system were constructed in this first generation general purpose FIS processor unit of claims (2) and (6) with three large data transfer subsystems (128 lines each), where two could be used to simultaneously to bring in the numbers for an arithmetical function and one to send the result out. Now to be able to make full use of this arrangement for the “Data Input/Output Bus” system, the structure of the RAM and I/O in the “Rest of general purpose FIS Computer” must be changed and improved. At the time of the writing of this patent application, the vast majority of the computers constructed about a general purpose FIS processors constructed from logic circuitry use but one massive bank of RAM; a bank of RAM which has but one control system; a control system that can place but one number at a time upon the one data transfer subsystem of the present “Data Input/Output Bus” system.

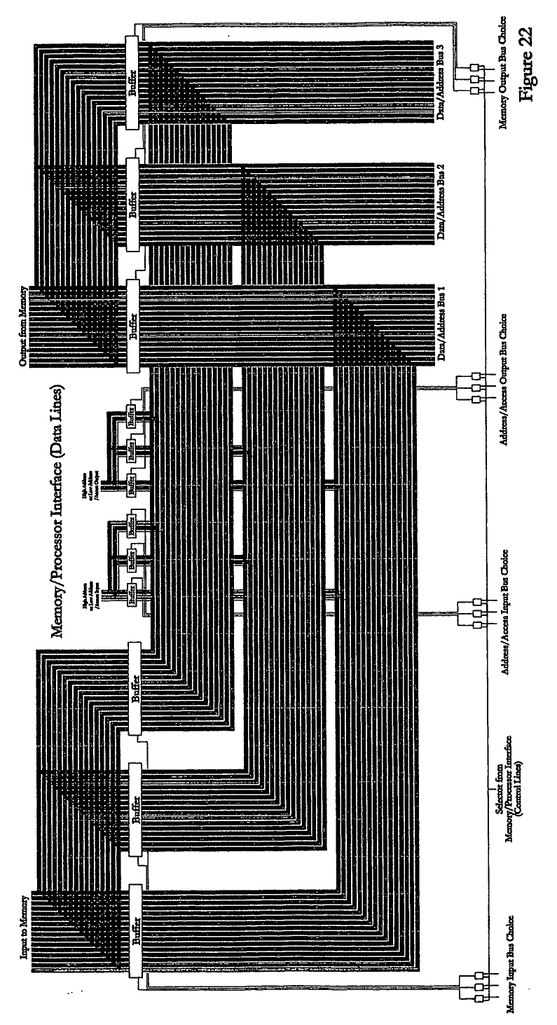

But in this first generation of this new type of computer built around the general purpose FIS processor unit of claims (2) and (6), to make full use of the three data transfer subsystem of the “Data Input/Output Bus”, there needs to be at least three such RAM subsystems within the “Rest of general purpose FIS Computer.” Each of these RAM subsystems will need to have the ability to link to any of the three data transfer subsystems of this new type of “Data Input/Output Bus.” The way this will be done is through the buffer bridge shown in FIG. 22. As seen in this figure, it will be through the direction of the master controller that will determine which of the data transfer subsystems a given RAM links at an given moment.

Now to make this major change in the “Rest of general purpose FIS Computer” possible, that of having three or more RAM systems within this new type of computer system, the subsystem that handles the addressing of RAM will, in this first generation of this new type of computer system based on the general purpose FIS processor unit of claims (2) and (6), be made into a number of stand-alone units. And these stand-alone units will be controlled from “afar” by the general purpose FIS processor unit of claims (2) and (6); and where one such stand-alone addressing/accessing unit will be assigned to each of the RAM subsystems as well as that of each of the I/O subsystems found in the “Rest of general purpose FIS Computer.”

Now as for the design of these stand alone addressing subsystems, it will have some points in common with the present addressing systems built into the latest versions of the x86 general purpose FIS processors. To begin with, these new stand alone addressing subsystems for RAM and I/O will make use of the “paging” technology—a technology that is intimately linked to the multi-tasking technology of the present generation of operating systems. What is more, included in the use of this “paging technology” will be the “locks” which will prevent a process running in application mode (explained earlier in this patent application) to change the “page” it is working within. This lock out mechanism will make sure that when an “application process” wishes to address a new page, it will do so through the operating system. And in doing, this “application process's” efforts to address a “new page” will always pass through all of the checks and balances built within the operating system.

Also, these stand alone addressing units for the various RAM and I/O systems residing in the “Rest of general purpose FIS Computer” will in fact, as explained earlier, be broken down into two broad sub-addressing subsystems—one to be used, for the most part, for the operating system processes. The second will provide addressing of the RAM and I/O system for the application processes. Then in the first generation of this new type of general purpose FIS computer built around the general purpose FIS processor unit of claims (2) and (6), these two broad classes of addressing subsystems will each, in their turn, as mentioned above, be broken down into two further subsystems so that in this way, there will be four separate independent addressing subsystems for each of the RAM and I/O subsystems within the “Rest of general purpose FIS Computer” in this best mode application.

But in addition to having multiple addressing subsystems for each of the RAM and I/O subsystems, a second set of subsystems, which will be called the access subsystems in this patent application, will need to be put into place. To understand why a second type of control subsystem will need to be added to the RAM and I/O subsystem to work in conjunction with the addressing subsystems, one must remember that the data transfer subsystems of the “Data Input/Output Bus” are to be 128 bits wide in this best mode application. When this is the case, the RAM and I/O will initially be feeding data out at 128 bit “chunks.” However, there will be certain situations wherein the data to be fed to either the general purpose FIS processor unit of claims (2) and (6) will need to be sent in smaller increments than 128 bits (i.e. 8 bits, 16 bits, 32 bits or 64 bits).

For example, if the output from a given RAM subsystem were to be broken into 8 bit word—as for example when one happens to be dealing with and modifying a text file composed of ASCII characters—then there would be 16 such words in the 128-bit wide output from the said RAM. There will be times in the operation of the first generation of this new type of computer built around the general purpose FIS processor unit of claims (2) and (6) when each of these 16 8-bit words will need to be fed to, as well as be received from, the data transfer subsystem not in a parallel fashion, but sequentially.

So to be able to handle this situation of being able to send and receive data to and from RAM either as one large sequence of 128 bit at one time (i.e. parallel mode) or, as a series of smaller word, such as 8-bit words (i.e. serial mode), this new type of computer will need to introduce into the overall control subsystems for each of the RAM and I/O subsystems of the “Rest of general purpose FIS Computer” a number of these access subsystems. And these access subsystems will act as control systems which will be responsible for parsing data in and out of RAM and the I/O subsystems in the needed format; that is, to be able to send out and receive data as a sequential stream of 128-bits, 64-bits, 32-bits, 16-bits or 8-bits.

And as with the addressing subsystems, these accessing subsystems for the various RAM and I/O subsystems in the first generation of this new computer system will be broken down into four separate, independent sub-subsystems—two that will allow the operating system to have multiple access to the 128-bits of data coming out of and into the various RAM or I/O subsystems, and another two to allow a given application to have two independent means of parsing data to and from the various RAM or I/O subsystems.

Now as for the precise structure of these four separate, independent addressing/accessing subsystems for the various RAM or I/O systems contained in the “Rest of general purpose FIS Computer”, they will be identical to one another. Their structure will consist of a number of bit-mapping memory circuits controlled by the same bit-slice feedback system that will control the addressing function for each of these RAM and I/O systems.

And with this change in how RAM is addressed, going from a system built into the general purpose FIS processor to a various separate, independent addressing/accessing subsystems within the various RAM or I/O systems, there is no need to have a separate addressing bus system, as found in the present and past generations of general purpose computers built around FIS processors constructed from logic circuitry. Rather, this first generation of general purpose FIS processor unit of claims (2) and (6) will make use any one of the three data transfer subsystems for the “Data Input/Output Bus” to transmit the addressing values to the various addressing/accessing subsystems built into the various RAM and I/O systems within the “Rest of general purpose FIS Computer.”

More than Three RAM Subsystems

So far in this discussion of the best mode for this new computer system, at least in its first generation, it has been recognized that this first generation system should contain at least three RAM subsystems; two to feed data to the ALU/math-coprocessor and one to retrieve the results from the same said ALU/math-coprocessor.

However, on examining the overall functionality and purpose of this new type of computer based on this new general purpose FIS processor unit of claims (2) and (6) that will need to be built into the first generation of this new computing system, it can be seen that two further RAM systems need to be included into the “Rest of general purpose FIS Computer.” The first of these will be used to store all of the programs (i.e. instructions and addressing values) that are being run on the system.

A second RAM system within the “Rest of General Purpose FIS Computer” will be needed within this new general purpose FIS processor unit of claims (2) and (6) if the internal registers which play such a fundamental role in the present general purpose FIS processors built from logic circuitry are to be emulated from this new type of computer system. And as for this RAM, it must be of a kind that will be as fast as this new general purpose FIS processor unit of claims (2) and (6) so that it will not hamper the overall performance of this new computer system.

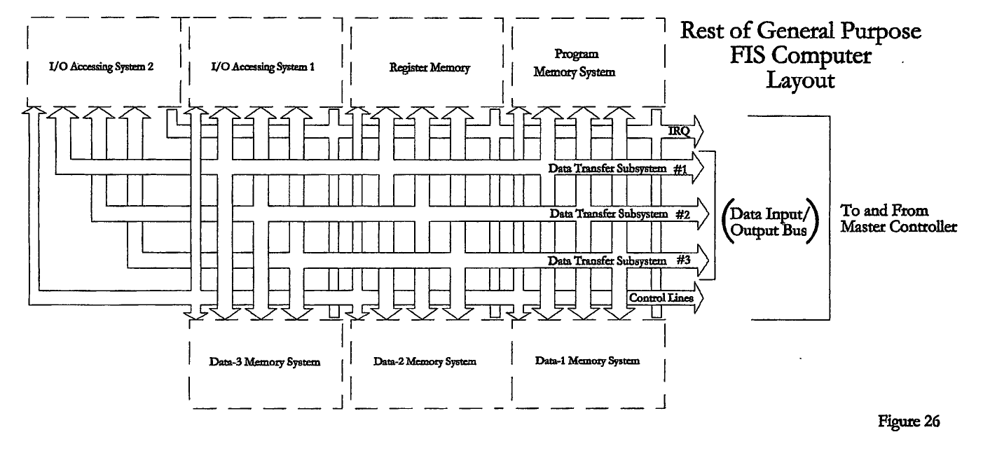

As for the I/O subsystems, the first generation of this new computer will have two. This will allow for rapid transfer of data from one I/O system to another—assuming that the various I/O devices placed in the system are properly balanced between the two I/O subsystems. The overall structure for the “Rest of general purpose FIS Computer” for the first generation of this new computing system is shown in FIG. 26.

Control Bus

As for the structure of the control bus shown in FIG. 1, in computer systems built around general purpose FIS processors constructed from logic circuitry, it has always been the processors that has been the final arbiter when it came to the final structure of this communication system. But as explained above, with the simplicity by which a general purpose FIS processor built up from bit-slice feedback memory circuitry and bit-mapping circuitry, this is no longer the case. Rather, based upon initial theoretical considerations, the prime mover in the design of this new type of computer is actually no longer that of the processor. Rather, the prime mover in the design of the control bus is that of the “Rest of general purpose FIS Computer.” In particular, it has come down to the independent addressing/accessing subsystems within the RAM and I/O systems in the “Rest of general purpose FIS Computer.”

Interrupt Request Bus

Finally, the last of the arrows between the “general purpose FIS Processor Unit” and the “Rest of general purpose FIS Computer”, that of the IRQ bus, will, in this new type of general purpose computer system, be increased in size over that found in many of the present computer systems, especially those constructed around X86 type microprocessors. And by increasing the number of lines within the IRQ arrow, this new type of general purpose computer will not, in general, face the occasional problem that can develop with having to few IRQ, that of conflicts.

The General Purpose FIS Bit-Slice Feedback Programmed Processor Unit

So in this first generation of the best mode design for this new type of computer system, the first of the three major components that have evolved into what is now called the general purpose FIS processor (addressing system, ALU/math-coprocessor and master controller) will no longer be an internal component. As mentioned above, the addressing system—which, in this first generation of new computer system constructed around this new general purpose FIS processor unit of claims (2) and (6) is now composed of two systems: that of the addressing subsystem and the accessing subsystem—will be converted into multiple stand-alone chips which will control the acquisition and dissemination of data within the RAM and I/O subsystems within the “Rest of general purpose FIS Computer.”

But even though the circuitry for doing these addressing/accessing functions will no longer be a direct part of the general purpose FIS processor itself, these stand-alone addressing/accessing circuits will still receive all of their direction and data (addressing values), and thus their control, from the “general purpose FIS Processor Unit” by way of the “Data Input/Output Bus” and the “Control Bus.” As for that part of the “general purpose FIS Processor Unit” that will be providing this control and direction, it will be the master control unit of this new general purpose FIS processor unit of claims (2) and (6); which, as mentioned above, will consist of both the “Primary Bit-Slice Feedback Programmed Memory System” and the “Fundamental Control Memory System.”

ALU

The discussion of the various components of the ALU (integer adder, twos complement, left and right word shifters, left and right word rotators, Increment, decrement, logic functions (AND, OR and XOR), byte and bit manipulation, and byte and bit comparators) will begin with one of the more oft used of these subsystems, that of the Integer Adder.

Integer Adder

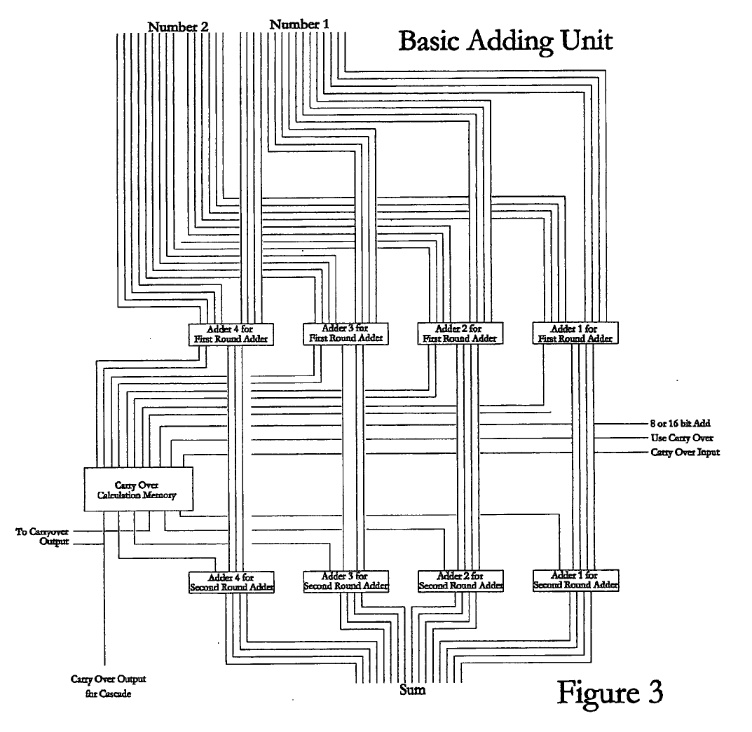

The best mode design for this sub-subsystem for this new type of computer based on a general purpose FIS processor unit of claims (2) and (6) is provided in FIGS. 3 to 6. As for the code that is to be written into the various memory circuits found within this component of the ALU, it is of a nature that once an individual conversant with the knowledge of basic processor structure as well as the methods of constructing bit-mapping processes and bit-slice feedback programming—as articulated above—and has also come to understand the layout of these various said memory circuits and the various functions that each of them is to serve as well as the actions that are to happen between the various components of this Integer Adder (which is what the master controller is to provide), the code should, to such an individual, be straight forward and easy to produce. And based on this assumption that this code is straight forward to produce for such an individual conversant in this said knowledge, it will be assumed that the code for the Integer Adder need not be included within the submission of this patent application in order to establish proof that the below given claims can, at the time of submission of this patent and hereafter, be used to create a said new, viable and fully functional type of general purpose FIS computer based on the FIS processor built in accordance with claims (1) and (6).

And this assumption as to the ease with which the code can be created for the Integer Adder will also be made concerning the code for all of the other components built into this best mode application of this new type of computer based on the FIS processor built in accordance with claims (1) and (6) and this is the reason why this code shall not be provided in this initial patent application.

But it must be stated that much of this said code has already been produced. And the remainder of the code yet to be produced shall, in short order, be so produced. If necessary to establish the proof of utility of the below given claims for the purposes of patent approval, all of the code so far completed can, upon request, be provided, and thereby be included into this said patent application. Of the remaining code yet to be produced, but soon to be produced, it can be so forwarded upon its completion; if so requested.

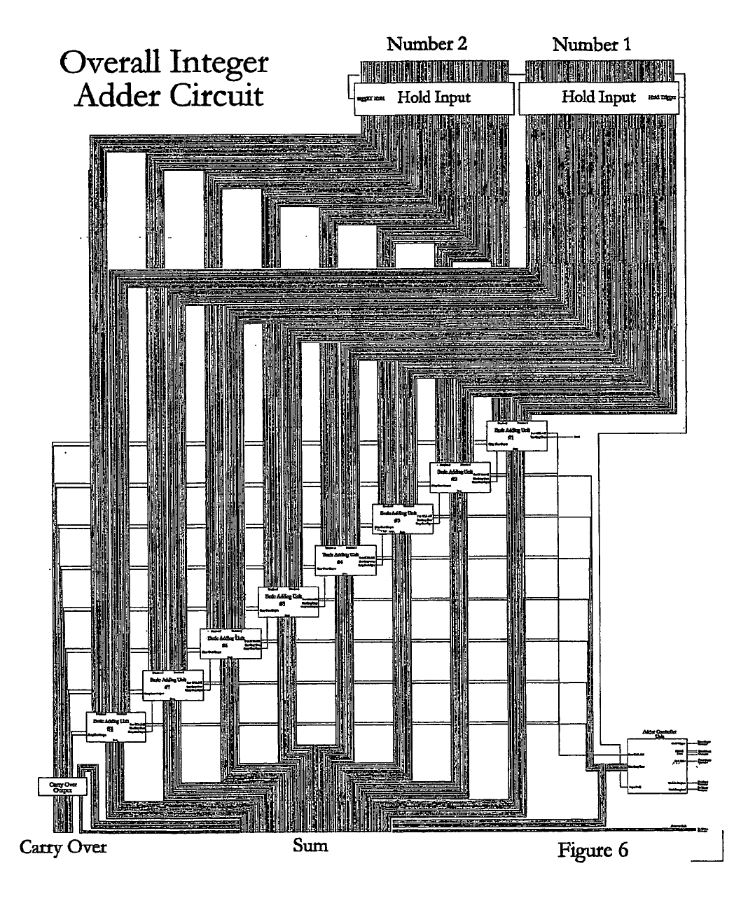

Now as for the Integer Adder, this component of the ALU, like all of the others of the ALU, must internally be broken down into a series of sub-memory circuits. This must be done so that the amount of memory used in the overall system can be kept within reasonable bounds, yet be able to achieve substantial functionality; such as having an integer adder system that can add up to two 128-bit numbers (as measured in a binary numeration system). But to break the overall Integer Adder system up into a large number of subsystems, as shown in FIGS. 3 and 6, the process of rolling over and adding the carryover bit from one sub-addition circuit to another must be carried out. But in carrying out these various rollover additions of the carryover bits, the computing speed of the overall integer adder will be reduced.

There are, however, several specific things in the design of the Integer Adder that can greatly reduce the adverse effects that setting up a number of sub-addition circuits to do the overall integer addition have on speed, while substantially improving the functionality of the Integer Adder. The first of these specific designs is to divide up the 128-bit Integer Adder into a number of Basic Adding Units; where the layout of this Basic Adding Unit is shown in FIG. 3. The second step that will allow for reducing the adverse time effects caused by rollover additions of the carryover bits is by introducing what is called in this patent application, the Carry Over Calculation Memory, shown in FIG. 3.

The reason that the number of rollovers in the addition process can be reduced through the use of the Carry Over Calculation Memory is because of an elegant feature that is inherent in not only binary addition of two numbers greater than two digits, but in all additions of “reasonable” size regardless of its base. To explain this elegant feature of addition, as it applies to a binary system, consider the Basic Adding Unit in FIG. 3.

In this circuit layout the the addition is carried out in three stages. The first stage of this Basic Adding Unit is composed of two parts: First, the numbers to be added are divided into four sets of four bits each which are then passed to the second part of this said first stage, which is composed of four bit-mapping memory circuits. Then the product generated by these four bit-mapping memory circuits are, in their turn, divided into two sets of binary numbers each. The first of these sets of bits from each bit-mapping memory circuit (i.e. four bits in each set) are passed directly to the third stage of the Basic Adding Unit. The second set of bits from each bit-mapping memory circuit of the first stage (two bits each: one carryover bit and one “warning bit”) are passed to the second stage of this Basic Adding Unit.

Now the second stage in this Basic Adding Unit, as seen in FIG. 3, is the Carry Over Calculation Memory, which is simply another bit-mapping memory circuit. The purpose of this Carry Over Calculation Memory is to take both the carryover bit and warning bit from all four memory circuits from the first stage of this Basic Adding Unit, as well as a carryover bit that will be used to chain a number of these Basic Adding Units together, as shown in FIG. 6, and uses all of these input bits to determine in the equivalent of one clock cycle what the carryover bits are to be used by the four bit-mapping memory circuits that make up the third stage of this Basic Adding Unit. At the same time, this second stage will also generate either one or two carry over bits to serve as the overall carryover bits for this Basic Adding Unit. As for why there can be two carryover bits, that is because this Basic Adding Unit can perform either as an adding unit that carries out one sixteen-bit addition or two eight-bit additions. And in the latter case, two overall carryover bits will be generated for each Basic Adding Unit.

Now what makes possible this reduction in the number of rollovers in the calculation of the carryover bits for each of the third stage adders as shown in FIG. 3 is that only sixteen of the 256 combinations of output numbers in each of the four memory circuits that make up the first stage will, in any way, be effected by having a carryover bit value of one added to them. So, if one introduces a second bit to the carryover bit, called the warning bit, it becomes possible to calculate all of the carry bits for the four memory circuits for the third stage of this Basic Adding Unit at once. It also becomes possible to calculate the overall carryover bits for this said Basic Adding Unit at the same time. Then, with all of these five, or six, carryover bits calculated at one time by the “Carryover Calculation Memory” and sent the appropriate carryover bits the various memory circuits of the third stage of the Basic Adding Unit, as shown in FIG. 3, the third stage of this said adding unit will then be able to calculate the final product for the sixteen-bit (or 2 8-bit) addition; and to do so in the equivalent of one clock cycle. So in this way, this design of this sixteen-bit Basic Adding Unit is able to carry out this integer addition in the equivalent of three clock cycles rather than the four that it would have taken if each of the carryovers was delivered directly up to its neighbor, the bit-mapping memory circuit so as to complete its calculation.

Then with this Basic Adding Unit as a basic building block one can chain them together, as mentioned above, by way of their overall carryover bits, as shown in FIG. 6. When you chain eight of these Basic Adding Units together, as shown in FIG. 6, the system is then capable of taking in two sets of 128 bits and carry out a number of different types of integer additions: 16 8-bit additions, 8 16-bit additions, 4 32-bit additions, 2 64-bit additions or 1 128-bit addition.

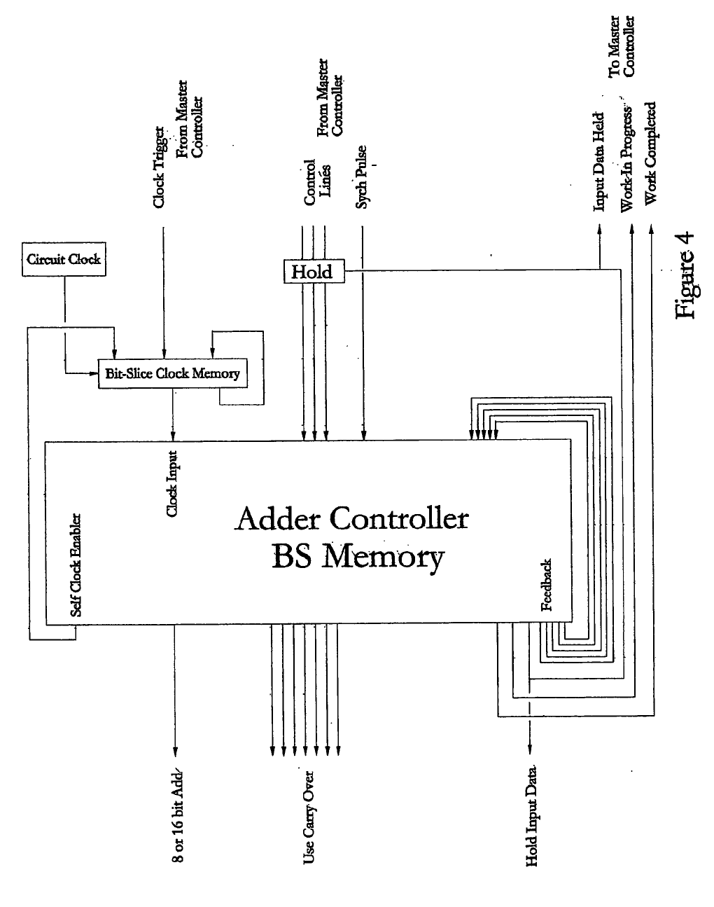

As for which of these additions that will be done at any given moment, that will be controlled by the Adder Controller bit-Slice memory system, as shown in FIG. 4. This latter system, in its turn, will receive its instruction by the number brought to it by the control lines shown in FIG. 4; lines that originate within the master control system, which, in its turn, receives its direction from the program that is running at any given moment.

Now, in this above given discussion, the concept of the “equivalent” clock cycle was used. The reason why this concept of “equivalent clock cycles” is used is because the flow of information through the bit-mapping circuitry shown in FIGS. 3, 5 and 6 will, in actual fact, not be controlled by any clock signals. That is, all of the memory circuits in these bit-mapping circuits will be clockless. However, the Adder Controller Bit-Slice memory system which will be controlling this bit-mapping circuitry will be clocked. So, from the perspective of the Adder Controller Bit-Slice memory system, the actions of bit-mapping portion of this Integer Adder must be thought of in terms of how many clock cycles of the Adder Controller Bit-Slice memory system must pass through so as to allow enough time for the bit-mapping portion of this Integer Adder to complete its work. So this is what is meant by the concept of equivalent clock cycles.

Also, since there is no clocking mechanism applied to the bit-mapping memory circuitry for the Integer Adder, this said circuitry is what is called “always active.” That is, once the input to this bit-mapping integer addition circuitry changes, this said circuitry begins to immediately calculate the new result for the new numbers that this bit-mapping memory circuitry is receiving. Now to make sure that this bit-mapping circuitry is only active when an integer addition needs to be carried out, and not each time the data on the various data transfer subsystems of the “Data Input/Output Bus” changes so as to deliver data to other functions within the general purpose FIS processor unit of claims (2) and (6), there will be a hold circuit placed between the “Data Input/Output Bust” and that of the Integer Adder, a hold system that will grab new input data for the Integer Adder off the “Data Input/Output Bus” whenever it is needed, as shown in FIG. 6. This hold circuitry will only be triggered by the Adder Controller Bit-Slice Memory system when this latter circuitry has been triggered by the master controller, so as to carry out another integer addition.

And once the input hold circuitry had been triggered and a new set of numbers have been introduced to the rest of the Integer Adder, there will be a rippling effect through the various stages of the Integer Adder's bit-mapping circuitry; starting with the first stage and working its way to the second stage. But even when the first stage does settles out, the second stage may not have reached its final output immediately following. For in some cases, this second stage of the bit-mapping integer adder circuit may be directed by the Adder Controller Bit-Slice Memory system to accept and act upon the carryover bit received from an adjacent Basic Adding Unit; as shown in FIG. 6. If this is the case, then this given second stage will not settle out until the second stage of the adjacent Basic Adding Unit; which, in some case may, itself, not settle out until its neighboring Basic Adding Unit has also been sent out into a stable state. And if, for example, two 128-bit numbers are being added together rather than a set of 64 bit additions, 32-bit additions, 16-bit additions or 8-bit additions, this rippling effect will have to travel through all eight Basic Adding Units shown in FIG. 6.

And then after the second stage of each of the eight Basic Adding Units have, in fact, completely settled out, stable values for the carryover bits will develop on the various Carry Over Calculation Memory which will then allow the various third stages to these various said eight Basic Adding Units to then seek a stable state. And then upon having the third stage of all eight Basic Adding Units settle out, the output from these said third stages will be giving the final, stable answer for the given set of integer additions being carried out; be it 1×128 bits, 2×64 bit, 4×32 bits, 8×16 bits or 16×8 bits.

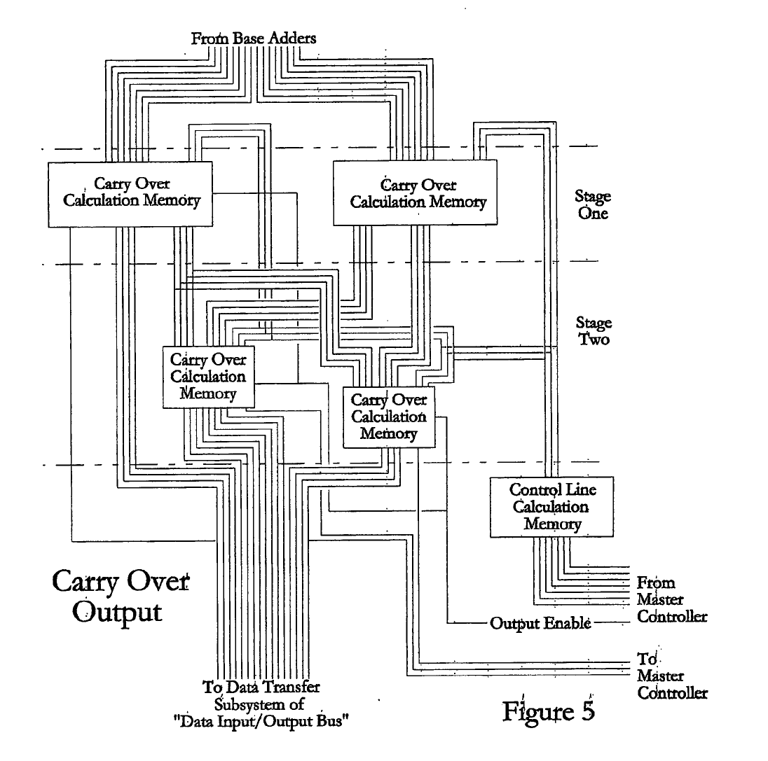

The last component of this Integer Adder is that of the Carry Over Output circuit, shown in FIG. 5. This circuit will serve two purposes. First, this circuit will send to the master controller a set of signals that will allow the master controller to determine if any of the additions carried out in the Integer Adder created an oversized number; that is, a number that is too large to be stored in the given size word then in use. In some cases, an overrun of the value can be of importance to the calculations being carried out; thus requiring an increase in the size of the word. The second function that this circuit will do is to allow this new computer system to store the values for the carryover in any of the RAM systems. Again, some programs run on this system may have use for these carryover values.

Increment/Decrement

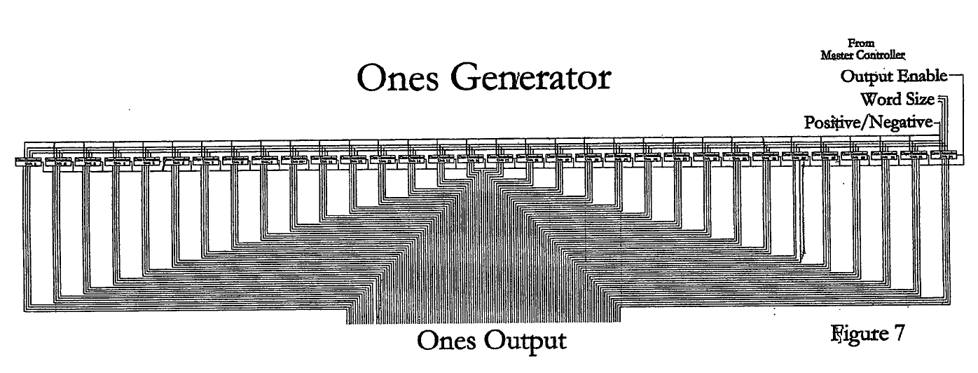

The increment/decrement process will be treated like any other integer addition, but with one difference. There will be set up within the ALU a simple memory circuit shown in FIG. 7 that will be able to place onto one of the two 128-bit data transfer subsystems that feed data to the Integer Adder either a set of positive or negative ones. These positive or negative ones can be structured in one of the following patterns: 1 a 128-bit +/−one, 2 64-bit +/−ones, 4 32-bit +/−ones, 8 16-bit +/−ones or 16 8-bit +/−ones. The choice of which of these combinations of ones will be sent out over the 128-bit transfer subsystem will be determined by the code that master controller sends over its control lines to this said positive/negative ones memory generator system.

But this ones generator will also be used for another purpose; that of a zeros generator. And the zeros that this circuit generates will be used by various programs running on this new type of general purpose FIS computer, principally the operating system. And the principal use of these zeros so generated is to clear sections of RAM so that it can be used by a new program or process; a process that is of great importance to the successful and smooth operation of many kernel and application programs, functions and subroutines.

Twos Complement

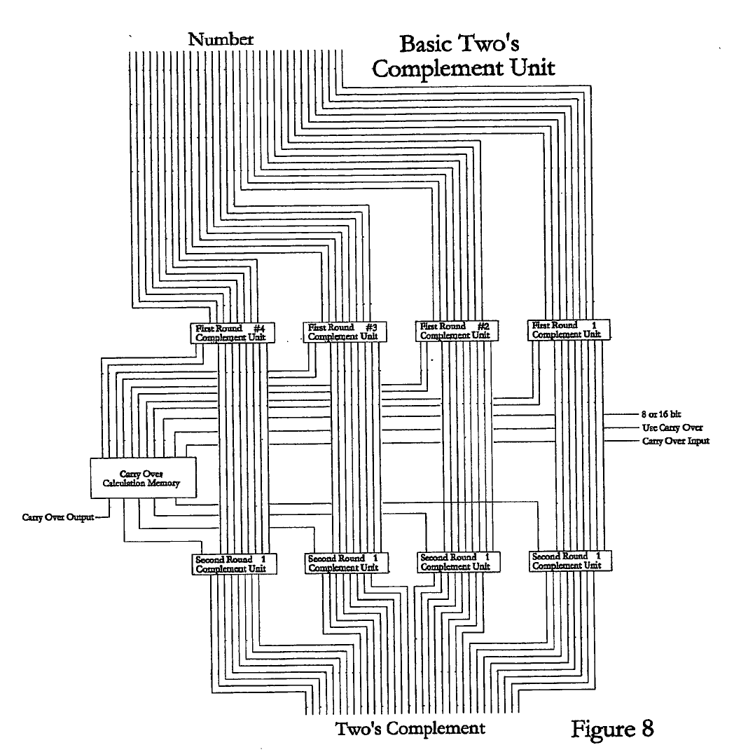

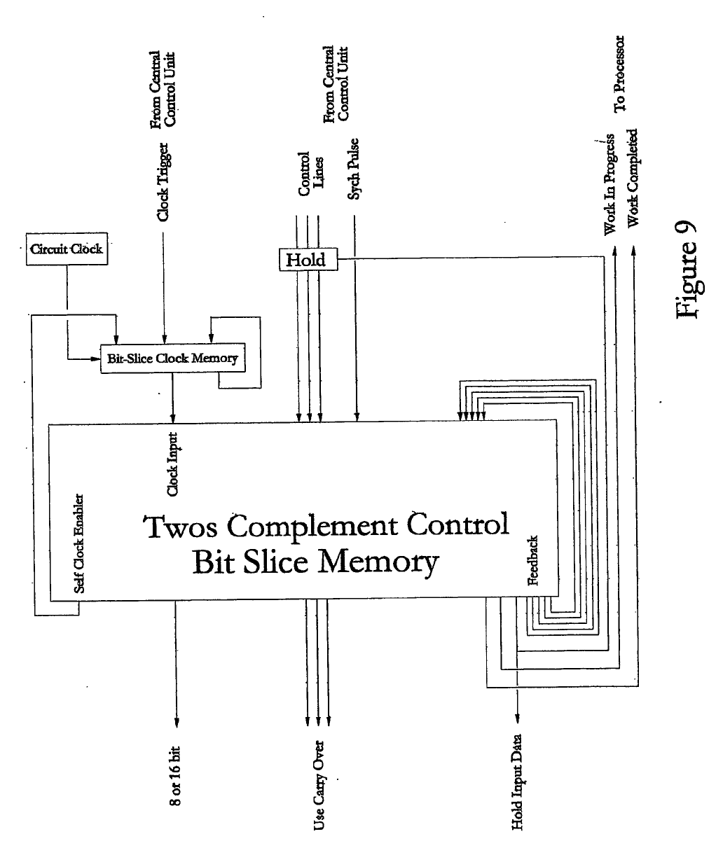

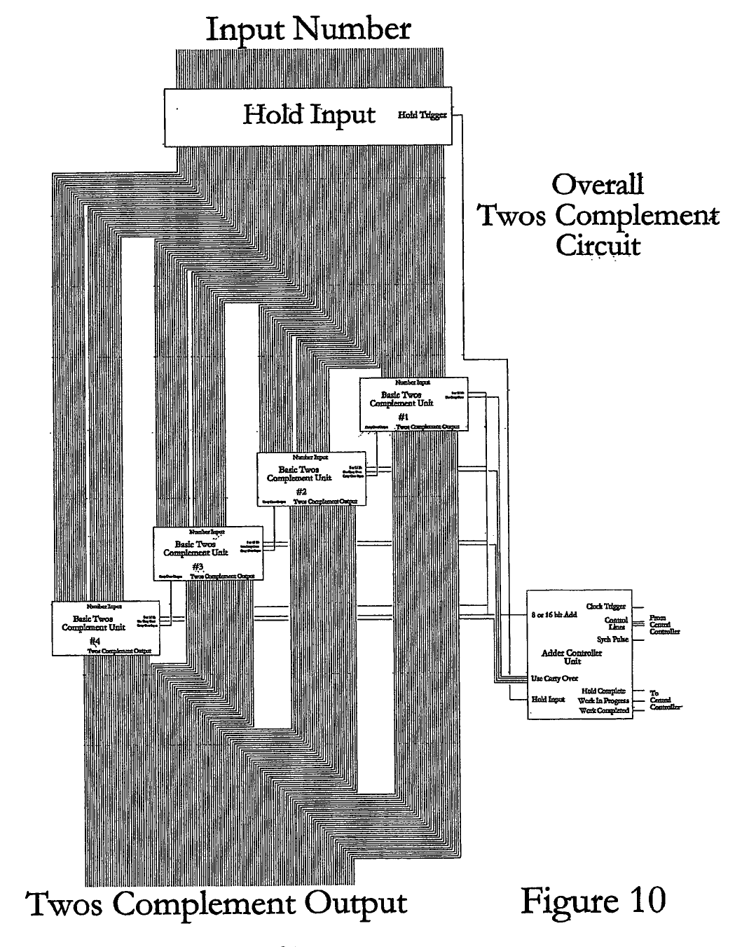

As for converting between positive and negative binary numbers within this new type of computer based on the general purpose FIS processor unit of claims (2) and (6), this said computer system will make use of the concept of twos complement. This will be done by building a dedicated circuit to carry out this functionality, circuitry that is shown in FIGS. 8 through 10. The bit-mapping and bit-slice feedback memory system that will convert a given integer to its two complement—and thus either into a negative number or back into a positive number—has the same basic structure as that of the integer-adder for the first generation of this new computer system based on the general purpose FIS processor unit of claims (2) and (6). That is, there will be a bit-mapping circuit that will carry out the conversion of 16 8-bit conversions, 8 16-bit conversions, 4 32-bit conversions, 2 64-bit conversions or 1128-bit conversion. Then there will be a “integer twos complement bit-slice feedback memory system” that will control which type of conversion is to take place; a bit-slice feedback memory system that will, like the bit-slice feedback memory system directly controlling the integer adder circuit, be receiving its instruction by way of the master controller which, in its turn, will be receiving instruction from the program being run.

The two main differences between that of the integer adder and the twos complement circuitry is, first, in the code placed in the memory circuits that make up both that of the bit-mapping process and the bit-slice feedback system of each of the two ALU subsystems. The second difference is that the two complement bit-mapping circuitry will only require one set of 128-bits as input rather than two, as in the Integer Adder. That is, it will only need to take data off one of the three main 128-bit transfer subsystem of the “Data Input/Output Bus.”

Integer Subtraction

As for carrying out integer subtraction, there will be no need to set up a separate set of circuits to carry out this functionality. Rather, what the master controller shall do when carrying out a subtraction is to first direct the subtractor to the twos complement circuit. Once this number, or set of numbers (i.e. 2 64-bit numbers, 4 32-bit numbers, 8 16-bit numbers or 16 32-bit numbers), has been converted to its twos complement, the result, along with the subtrahend, will be passed to the integer adder to generate the final difference, or set of differences. And again, the master controller will oversee this latter transfer and addition process.

Comparator

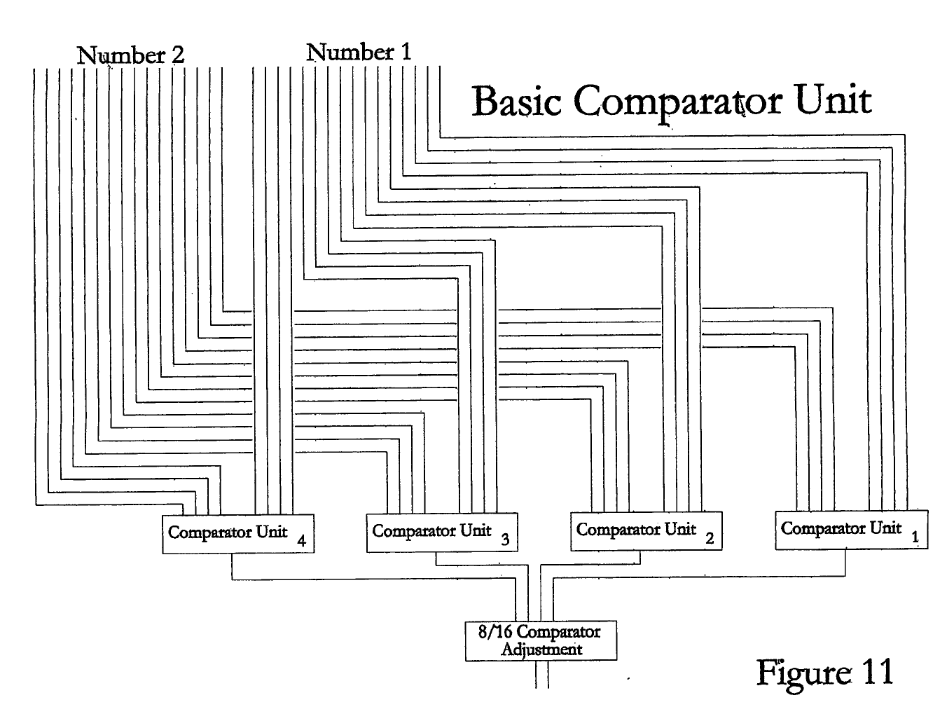

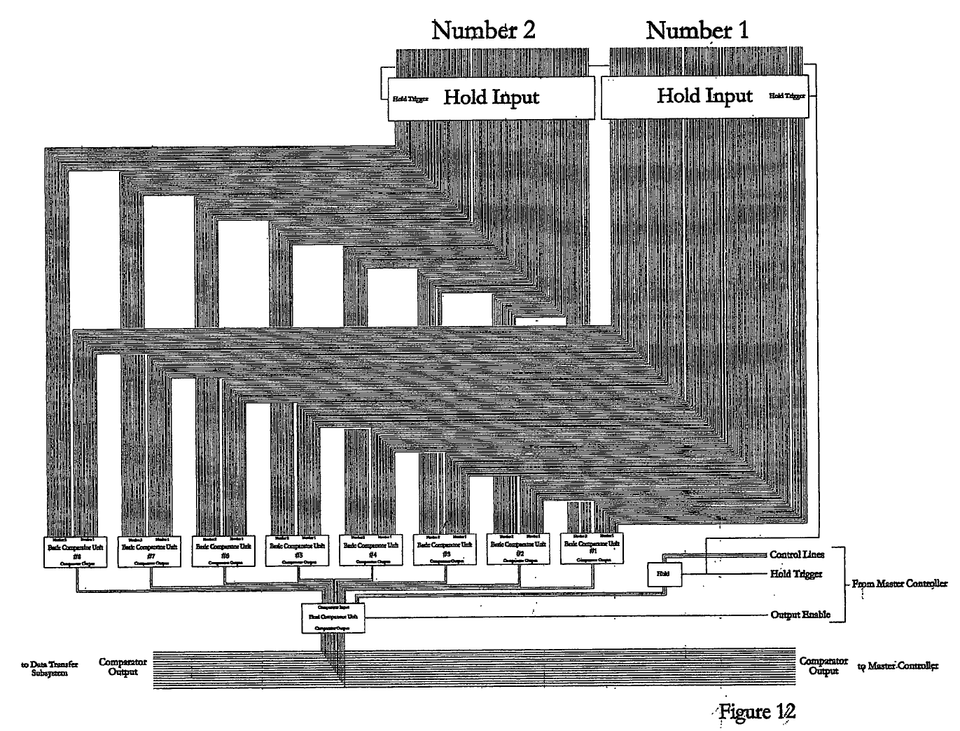

The basic structure of this component of the ALU, shown in FIGS. 11 and 12, will be slightly different from that of the integer adder in that there will be no product to return to external RAM. Rather, the bit-mapping system will have three filtering stages to determine which, if any, of the two sets of 16 8-bit numbers, 8 16-bit numbers, 4 32-bit numbers, 2 64-bit numbers or 1 128-bit numbers are equal to one another; and if not equal, which is the greater and which is the lesser.

And like the bit-mapping integer adder circuitry, this bit-mapping comparator circuitry can be asynchronous.

Right and Left Shifter-Right and Left Rotator

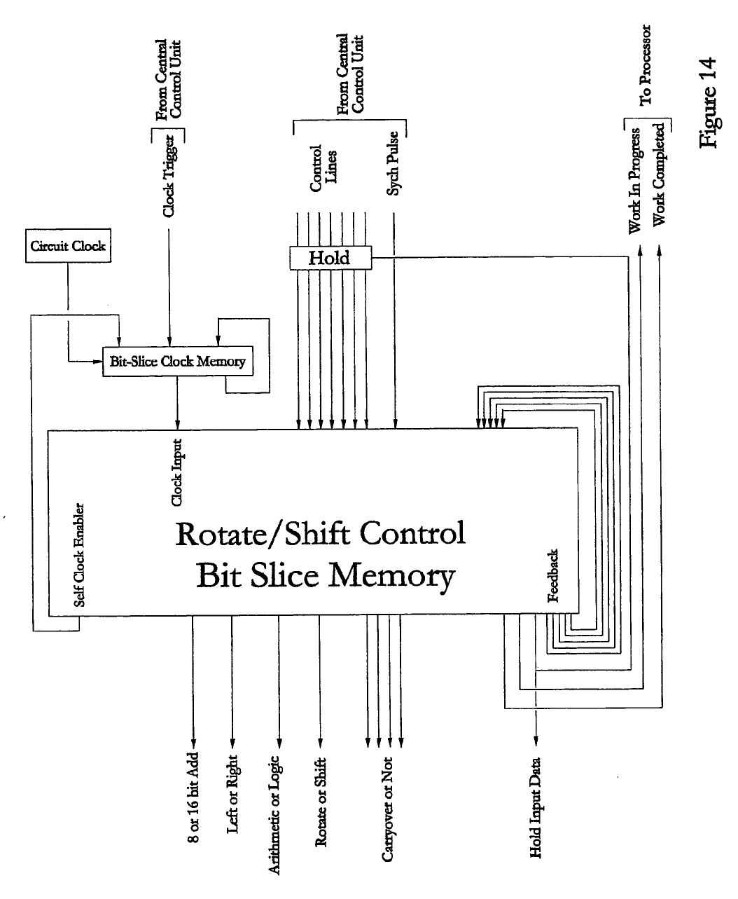

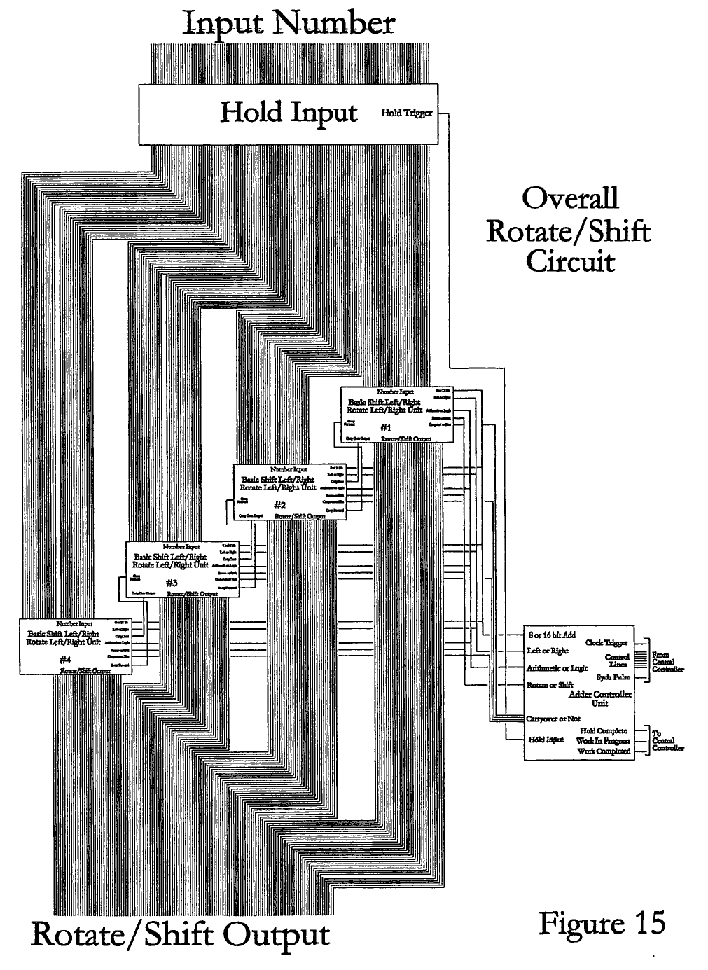

There will only be one set of circuits constructed as shown in FIGS. 14 to 16 that will be needed to carry out both right and left shifting of the various sets of bits in the various word sizes and that of right and left rotating of the same various bit in the same various word sizes.

Now to begin with, it must be recognized that the Right and Left Shifter function will need to be broken down into three basic sub-functions: shift left arithmetic, shift right arithmetic and shift right logical. Then as for the Right and Left Rotator functions, it will be broken down into the following four sub-functions: the rotate left through carry, the rotate left with branch carry, the rotate right through carry sub-functionality and finally the rotate left with branch carry.

As for the basic bit-mapping circuit to do this, it is shown in FIG. 14. And in this circuit each of the memory circuits contained in the first stage will send a rollover bit to the Shift/Rotate Carryover Calculation Memory; and depending if the rotate/shift is to either the left or to the right, this bit will be adjusted to pass the correct bit (the left most bit or the right most bit) to this second stage.

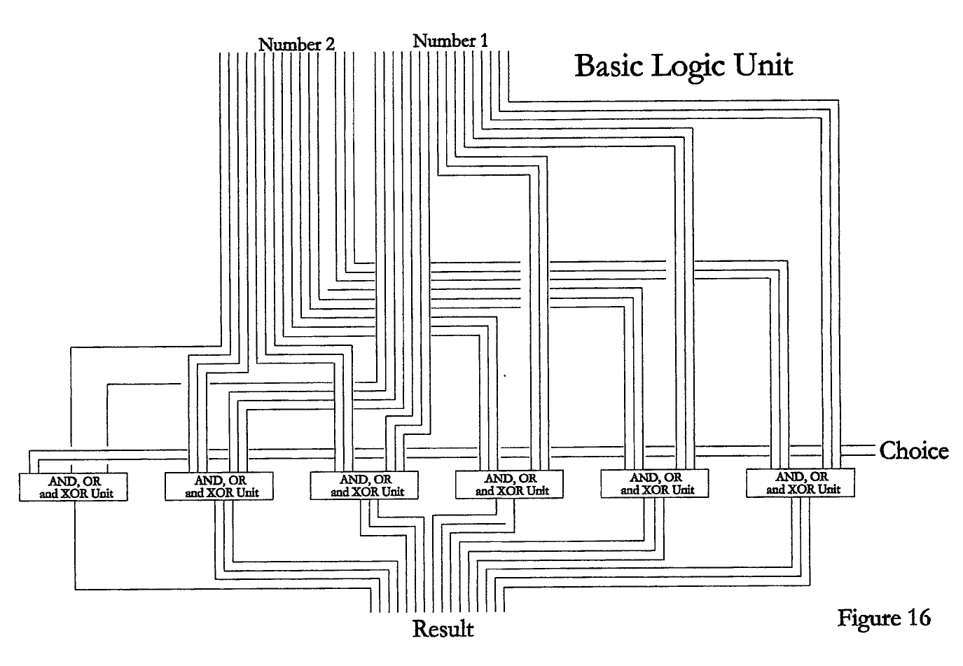

When a Rotate/Shift is to take place, the bit-slice feedback memory system shown in FIG. 16 will send the appropriate signal to each of of the memory circuits in the first, second and third stages of the bit-mapping circuit, as shown in FIG. 14, to direct it to carry out either a left or a right shift/rotate. And this said bit slice feedback memory system shown will also direct each of the second stages of each of the basic Shift Left/Right Rotate Left/Right Units whither the calculation is a shift or a rotate, as well as to use the carryover/carry forward bit from its neighbor, Basic Shift Left/Right Rotate Left/Right Units. And like the Comparator circuit and the Integer Adder, the bit-mapping circuitry for this function can be made to run asynchronously.

AND, OR and XOR

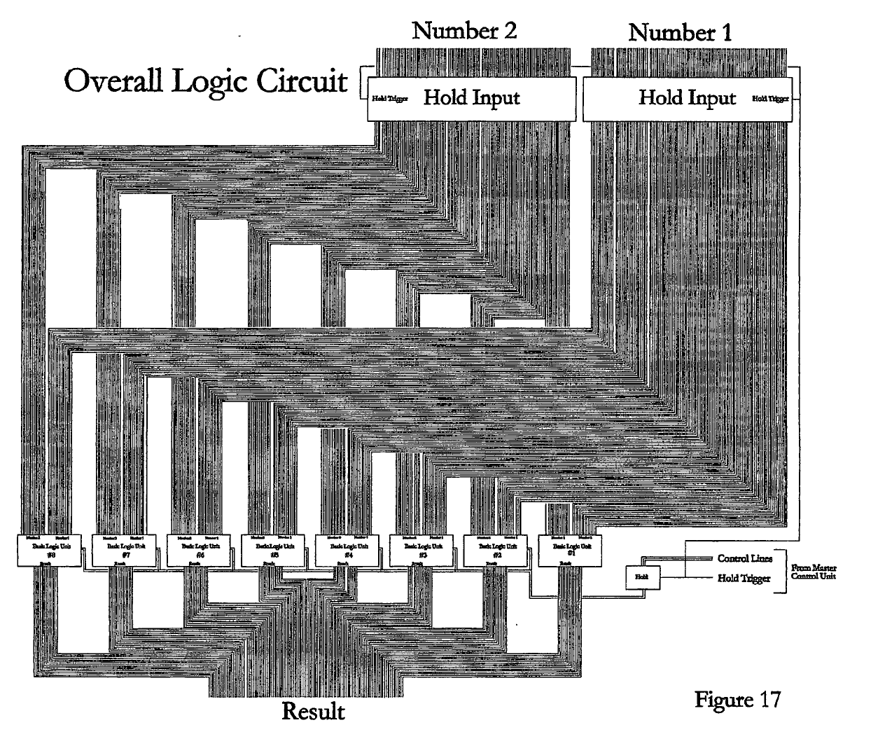

The AND, OR and XOR circuit, like the ones generator, will require no bit-slice feedback memory control system. And the reason why this circuit will not require its own control system is because all of these processes—16 8-bit AND operations, 8 16-bit AND operations, 4 32-bit AND operations or 2 64-bit AND operations—turn out to require the exact same code as that of AND, OR or XOR for 2 128-bit numbers. So all that needs to happen to carry out any of these 15 different functions, these five ANDs, five ORs and five XORs is to have the hold circuit belonging to one stage of this bit-mapping circuit to be clocked by the master controller and the result of all five ANDs or five ORs or five XORs will be obtained. As for the simple structure of this circuit, it is shown in FIGS. 16 and 17.

But as for determining which of the three basic functions this circuit will do, that will be done by having the master controller send over its output control lines seen in FIG. 17, a code that tells the various basic Logic Units, shown in FIG. 16, which of these three said basic logic functions to do.

Bit-Manipulation

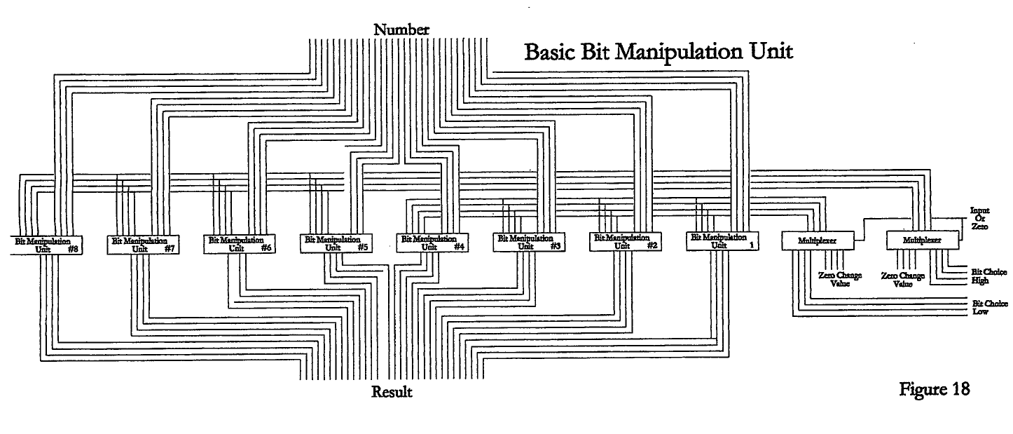

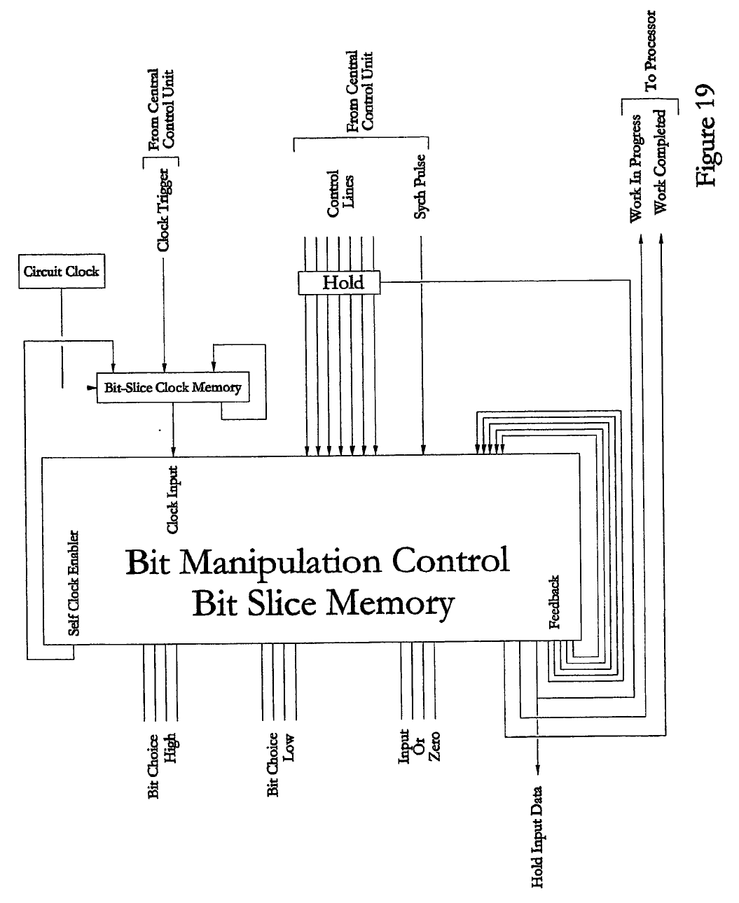

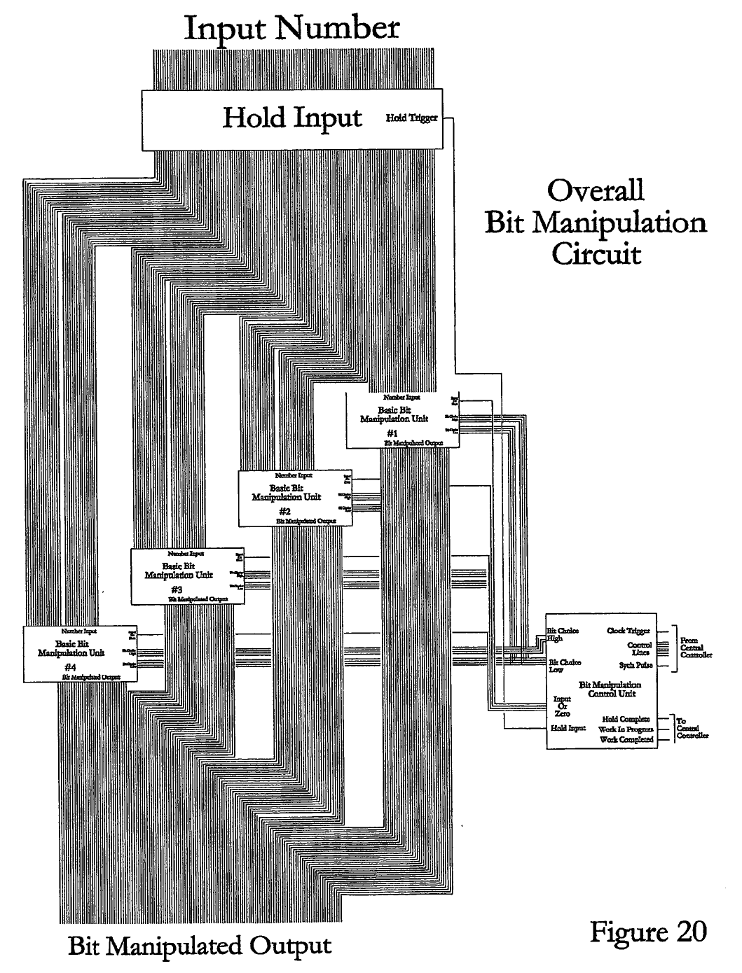

The Bit-Manipulation circuit, like Integer Adder circuit, will require a specialized bit-slice feedback system to control its operation, shown in FIG. 19. But unlike the Integer Adder, its bit-mapping circuitry, shown in FIGS. 18 and 20, will consist of just one stage. Within this stage, just those bits that need to be changed, either to zero, one or its opposite, will be changed; and it will happen in the equivalent of one clock cycle.

Data Move (also called Load)

In the vast majority of the general purpose FIS processors constructed from logic circuitry, the process of moving (loading) data throughout the computer system built around these said general purpose FIS processors is by way of a two stage process. The first of these stages has consisted of bringing a given byte or word into one of the internal registers within the general purpose FIS processor from the location where the data was located prior to the move (load). Then the second step in this process is to then transfer this data from the said internal register to the word's final location, be it either in some location within RAM or to be passed to a given port for the I/O system. If this move (load) is a block move (load), then this two stage process is repeated for each byte or word that is to be moved (loaded).

And the reason why most of the past general purpose FIS processors constructed from logic circuitry had to operate in this fashion when moving (loading) data is because in the early development of the general purpose computer every effort was made to keep the use of hardware to a minimum, as explained above. One of the major steps in keeping hardware to a minimum was, as discussed above, accomplished by doing two things. First, the computer was limited to just one data transfer bus. The second was that only one RAM system with only one addressing system was used within the overall computing system; an addressing system that was, from the very first, incorporated into the microprocessor. It was this using of one data transfer system, one addressing system and one RAM system that forced the use of internal registers and multiple steps in the transfer of data from one location to another.

But in the best mode of this new type of general purpose FIS processor unit of claims (2) and (6), and the computer built around it, the system has none of these restrictions found in those computers built around general purpose FIS processors made from logic circuitry. To begin with, there are multiple data transfer subsystems in the “Data Input/Output Bus.” Secondly, there are multiple RAM and I/O systems. Finally, each of the multiple RAM and I/O systems have multiple addressing/accessing subsystems built within them.

And when one examines the layout of these RAM and I/O systems as shown in FIG. 26, it is seen that these various RAM and I/O systems can be easily linked with one another without the need of ever passing data to and from the general purpose FIS processor unit of claims (2) and (6) itself; that is, data will not need to be brought into an internal register and then sent back out again.

Rather, what can happen is that the master controller of this said new type of general purpose FIS processor unit will direct each of the bit-slice feedback memory controllers built into two of the RAM or I/O systems to carry out a move (load) of data between themselves; and to do it over one of the three given data transfer subsystems of the “Data Input/Output Bus”; and to do so without every having the data come into the processor in the process.

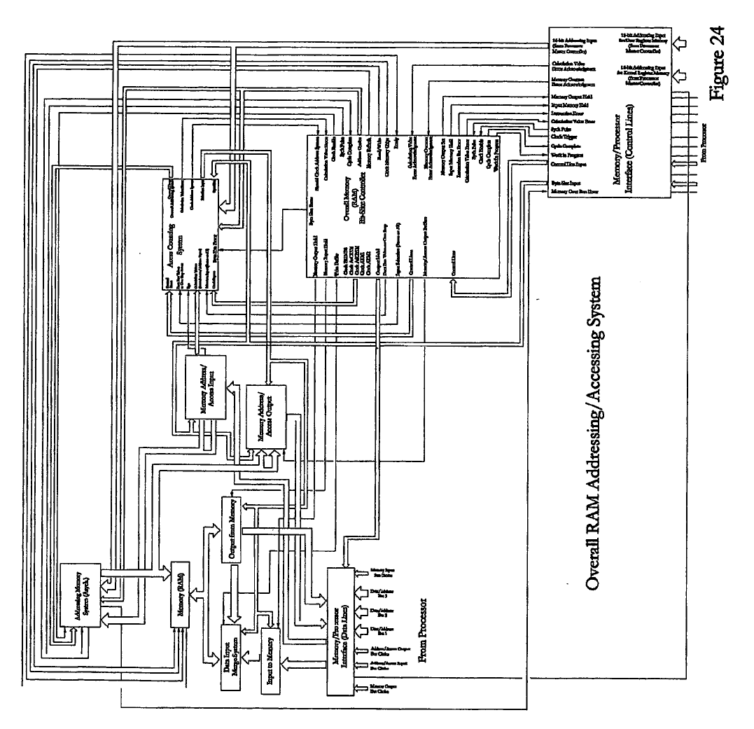

Now the second reason why in this best mode application of this new type of computer built around a general purpose FIS processor unit of claims (2) and (6) will not need to depend upon bringing in and sending out data through an internal register in order to move (load) data is because of the multiple addressing/accessing subsystems built into each of the RAM and I/O systems. Through the direction of the master controller, any one of multiple addressing/accessing subsystems within a given RAM or I/O systems will be able to send data by way of a hold circuit, as shown in FIG. 24, to any of the other three addressing/accessing subsystems within the same RAM or I/O system. So the data can be moved within a given RAM system without ever having to be passed to the general purpose FIS processor.

So in this way data can be moved (loaded) throughout the system with a minimum of effort, and with as little involvement of the general purpose FIS processor unit of claims (2) and (6) itself, thus shortening the time required to move data.

Master Controller

The master controller is at the core of the general purpose FIS processor. Its fundamental purpose is to coordinate the actions of all the other various components of this said best mode application of this general purpose FIS processor/computer; which include the Integer Adder, Increment/Decrement circuit, Twos Complement circuit, Comparator, Right and Left Rotator, AND, OR and XOR circuit, Bit-Manipulation and RAM addressing/accessing circuitry so as to complete all of the different functions associated with all of the different instructions found within the instruction set of the general purpose FIS processor.

And as indicated above, the master controller for this new type of general purpose FIS processor unit of claims (2) and (6) will consist of the “Primary Bit-Slice Feedback Programmed Memory System” and the “Fundamental Control Memory System” working as a coordinated unit. What is more, and also explained above, the “Primary Bit-Slice Feedback Programmed Memory System” will be unlike most other bit-slice feedback memory systems in that there will be two feedback systems at work within the said “Primary Bit-Slice Feedback Programmed Memory System”; one feedback system embedded within a second feedback system. It will be by way of the larger feedback loop that the “Primary Bit-Slice Feedback Programmed Memory System”, and thus the master controller, will take in an instruction.

Now to understand how this new general purpose FIS processor/computer system will take in an instruction and thereby prepare to carry out the next instruction, one must first appreciate the fact that this most basic function of this general purpose FIS processor, this taking in and executing of an instruction, is a “looping” process. That is, there are a series of steps that happen over and over again each time this said general purpose FIS processor carries out a given instruction. To start the process, the proper addressing value must be set up in the active component of the addressing/accessing subsystem for the RAM that contains the program. Then once this has been done, the instruction needs to be sent to the master controller.

This proper addressing of the programming RAM system is accomplished in one of two ways. First, if the said computer system is beginning the boot-up process, the master controller, the Bootup System of FIG. 2 sets the system to access the first location in BIOS. Historically, the first location in the BIOS has been set to the zero addressing value.

The second way that the addressing/accessing subsystem for the RAM system containing the program being executed has the right addressing value is through the actions taken by the instruction that had just been completed. So what this means is, when each and every instruction within the instruction set for this general purpose FIS processor is executed by the master controller, the last thing the master controller needs to do before taking in the next instruction is to make sure that the addressing value within the active addressing/accessing subsystem of RAM system containing the program points to that next instruction. Thus this advancing of the addressing/accessing subsystem will need to be incorporated in every processor-program for every instruction that is placed into the “Primary Bit-Slice Feedback Programmed Memory System.”

Now with the next instruction to be carried out having, in one way or another, been placed on the first of the three data transfer subsystems of the “Data Input/Output Bus”, two actions take place. The first is that the the “Hold” subsystem shown in FIG. 2 stores the instruction value. The second action is that the same instruction, now held by the “Hold” subsystem, is passed through the multiplexer within the “Primary Bit-Slice Feedback Programmed Memory System”, as shown in FIG. 27, and becomes the input for this “Primary Bit-Slice Feedback Programmed Memory System.” That is, the much larger feedback loop for this “Primary Bit-Slice Feedback Programmed Memory System” is the one that controls and inputs data over the feedback lines for bit-slice feedback programmed memory found within “Primary Bit-Slice Feedback Programmed Memory System.” Through this action the master controller composed of the “Primary Bit-Slice Feedback Programmed Memory System” and the “Fundamental Control Memory System” is able to receive the next instruction that it is to carry out.

Now having explained how the master controller for this new type of FIS processor built in accordance with claims (2) and (6) and shown in FIG. 2 can receive an instruction from RAM, it is time to explain how this best mode application of this FIS processor built in accordance with claims (2) and (6) can carry out each of the following functions: integer addition, increment and decrement various sets of words, calculate the twos complement for a given word, compare two sets of words, shift or rotate either to the right or the left a given set of words, perform a set of ANDs, ORs or XORs on a set of words, to manipulate any given bit in a given set of words and finally move data (also called Load).

Execution of Integer Addition

As for integer additions, there are two basic classes of instructions that make use of the component within the ALU that carries out this function. The first class of instructions that direct the master controller to use the Integer Adder is that of where only one addition between two sets of numbers occurs-be it 16 8-bit additions, 8 16-bit additions, 4 32-bit additions, 2 64-bit additions or 1 128-bit addition. Each of these different sets of additions will have its own particular instruction within the instruction set. When carrying out any one of these individual addition sets, the master controller will handle them the same except for the code it sends to the Bit-Slice Feedback Integer Adder Controller, shown in FIG. 4, for the Integer Adder over its output control lines, as explained above.

Now to explain how exactly the master controller will carry out one of these additions, the first action, as explained above, is to have the master controller take in the instruction that directs it to do this addition. Then after the instruction is in, the next thing that happens within the master controller is to have the master controller's clock-and as explained above, this best mode application of this new general purpose FIS processor system/computer will be asynchronous; thus this master controller's clock will, unlike the clocks found in most logic based general purpose FIS processors, be a local clock. Then the next feedback number for “Primary Bit-Slice Feedback Programmed Memory System” will be output. This number is sent to two subsystems, the first of these is that of the “Fundamental Control Memory System.”

And upon receiving this output from the “Primary Bit-Slice Feedback Programmed Memory System”, the “Fundamental Control Memory System”, which is, principally, a bit-mapping memory system, then sends out a whole range of control signals to all of the various systems and subsystems throughout the entire computer system constructed around this new general purpose FIS processor unit of claims (2) and (6). Now in the case of carrying out the first step in this integer addition, all of these signals that are sent out, except for those sent to the program RAM system, to two of the data RAM systems and the multiplexer subsystem for the “Primary Bit-Slice Feedback Programmed Memory System”, will be set to “No Action”; which is generally a zero value placed on the output line. For most of the output lines for the “Fundamental Control Memory System”, such as those going to all of the other components of the ALU such as the Twos Complement unit and the Bit-Manipulation Circuit, they will remain throughout the entire execution of the integer addition in a “No Action” status.

Now as for the first of the positive signals that are initially sent out by the “Fundamental Control Memory System”, it is the one that is sent to the multiplexer subsystem for the “Primary Bit-Slice Feedback Programmed Memory System.” The purpose of this signal is to convert the input feedback lines from receiving input from RAM to that of the direct feedback loop for the “Primary Bit-Slice Feedback Programmed Memory System” itself. This change in what is fed into the “Primary Bit-Slice Feedback Programmed Memory System” has the effect of directing this “Primary Bit-Slice Feedback Programmed Memory System” to begin working on its own internal sequence of actions.

As for the second positive set of signals that the “Fundamental Control Memory System” sends out on the first clock cycle in the execution of this new instruction, it is the values that are sent to the Integer Adder over the “Fundamental Control Memory System's” own output control lines; output control lines that not only terminate at the Integer Adder but at all of the subsystems within the ALU as well as the various RAM addressing/accessing subsystems. It is through this value placed on these said output control lines that allow the “Fundamental Control Memory System” to tell the Integer Adder which of the different types of additions it is to do: be it 16 8-bit additions, 8 16-bit additions, 4 32-bit additions, 2 64-bit additions or 1 128-bit addition.

Now it should be noted at this time, that all of the integer addition instructions assume that the appropriate data, and thus the proper addressing values to the RAM systems that are to provide the data input for the Integer Adder, has already been prepared to be placed onto the appropriate data transfer subsystems for the “Data Input/Output Bus.” The setting up of this data was accomplished by a previous instruction or set of instructions.

But even though the data is ready to transfer, it is the third set of positive signals that the “Fundamental Control Memory System” sends out on the first clock cycle of the master controller's clock that directs the various Memory/Processor Interface Data Lines system, as shown in FIG. 22, to actually place this data onto the appropriate data transfer subsystems for the “Data Input/Output Bus.”

Then once these first output signals for the “Fundamental Control Memory System” have been set up as mentioned above, then on the next clock cycle of the master controller's clock the “Primary Bit-Slice Feedback Programmed Memory System” outputs a second feedback number that, in its turn, is fed to the “Fundamental Control Memory System.” Upon receiving this second number, the “Fundamental Control Memory System” then does four things. First, it continues to keep the correct control values for the Integer Adder on its output control lines. Second, it sends the clock trigger signal, as shown in FIGS. 4 and 6, to the said Integer Adder. This sets this unit into operation. Then at the same time that it is sending this clock trigger signal, the “Fundamental Control Memory System” also sends a signal to the “Primary Bit-Slice Feedback Programmed Memory System” to go into a tight, non-action loop. Then finally, it directs itself to listen for the signal from the Integer adder that will indicate that the Integer Adder has grabbed the input data off the two input data transfer subsystems for the “Data Input/Output Bus.” Once all of this has been done, the master controller goes into a ‘wait’ state.

But while the master controller is in a wait state the Integer Adder goes about the simple process of grabbing its input data from the various subsystem of the “Data Input/Output Bus”, then sending a signal to the “Fundamental Control Memory System” that indicates it has its data and is now working on the rest of the task of adding the two sets of numbers together. Then upon receiving this signal, the “Fundamental Control Memory System” releases the “Primary Bit-Slice Feedback Programmed Memory System” from its tight non-action loop, allowing the latter to move on to the next step in the integer addition's sequence.

Then the clock for the master controller sends another clock pulse to the “Primary Bit-Slice Feedback Programmed Memory System” which in turn causes this system to send a new feedback number to the “Fundamental Control Memory System.” And upon receiving this new number the “Fundamental Control Memory System” turns off the clock trigger to the Integer Adder while at the same time setting up its output control lines so that it can tell the program RAM system to step its active addressing subsystem forward by one-in this best mode application, as explained above, each of the RAM systems will have four addressing subsystems, but only one of them will be active at any given moment.

Then another clock pulse is sent to the “Primary Bit-Slice Feedback Programmed Memory System” from the master controller's clock which brings a new feedback number to the “Fundamental Control Memory System.” This in turn causes the “Fundamental Control Memory System”, while still holding its output control lines to the value just set in the previous clock cycle, to send a clock trigger to the program RAM system. This triggering of the clock in the program RAM causes this system to become active.

And once this has happened, one of two things can occur depending upon the nature of the addition instruction received by the master controller. The first possibility is that the instruction received is of the kind that will step forward the active addressing/accessing systems for the RAM systems that provided the data input to the Integer Adder. And if it is this kind of instruction, when the next feedback number for the next step in the flow of control for this instruction is received by the “Fundamental Control Memory System”, this system then sets its control lines to the values necessary to direct the data RAM systems to clock their addressing values by one. Then once the master control clock sends another clock signal to the “Primary Bit-Slice Feedback Programmed Memory System” and thus a new feedback number to the “Fundamental Control Memory System”, the “Fundamental Control Memory System” then triggers the clock circuit for the two RAM systems that provided input data to the Integer Adder; while still holding the control line values to the values set in the previous clock cycle.

Then once this has been completed and on the next clock cycle for the “Primary Bit-Slice Feedback Programmed Memory System”, the “Fundamental Control Memory System” does five things. It again sets the “Primary Bit-Slice Feedback Programmed Memory System” into a tight non-action loop. The second thing the “Fundamental Control Memory System” will be doing at this time is to set itself up to wait for the Integer Adder to indicate that it has completed its overall addition task. The third thing that the “Fundamental Control Memory System” does is to set on its output control lines the code that will tell the RAM system that will be storing the output from the Integer Adder to take up the value off the third of the three data transfer subsystems for the “Data Input/Output Bus.” Fourth, the “Fundamental Control Memory System” will also enable the Integer Adder so that it can output its result onto the third of the three data transfer subsystems for the “Data Input/Output Bus.” Finally, the “Fundamental Control Memory System” sets itself up to wait for the completion signal from the Integer Adder; and then the master controller waits for the Integer Adder.

Then upon the Integer Adder completing its task and sending its completion signal to the “Fundamental Control Memory System”, the “Fundamental Control Memory System” then carries out another whole series of functions simultaneously, starting with sending a sych pulse to the Integer Adder while at the same time making sure that the clock trigger for the Integer Adder has been set to a “No Action” value. Then finally, it removes the “Primary Bit-Slice Feedback Programmed Memory System” from the tight non-action loop it's in.

Then when the master controller's clock sends out its next pulse to the “Primary Bit-Slice Feedback Programmed Memory System, the “Fundamental Control Memory System” sends a clock trigger pulse to the RAM system that will be taking up the output data from the Integer Adder. At the same time, the “Fundamental Control Memory System” will also place the “Primary Bit-Slice Feedback Programmed Memory System” into yet another tight non-action loop and sets itself up so as to wait for the signal from the first of the data RAM systems that had output data to the Integer Adder. And the signal that the master controller is waiting for is the one indicating that the RAM system has completed its stepping forward by one.

Then upon receiving this signal from the first data output RAM system, the “Fundamental Control Memory System” then sends a sych pulse to this said data RAM system and releases the “Primary Bit-Slice Feedback Programmed Memory System” from its tight non-action loop.

Then with a clock pulse sent by the next master controller clock to the “Primary Bit-Slice Feedback Programmed Memory System”, the “Fundamental Control Memory System”, on receiving the next feedback number from the “Primary Bit-Slice Feedback Programmed Memory System”, sets the said “Primary Bit-Slice Feedback Programmed Memory System” into still another tight non-action loop and configures itself to receive the completion signal from the second data RAM system that sent data to the Integer Adder, a signal that indicates that it too has completed its stepping forward by one of its active addressing system.

And when this second data RAM system has adjusted its active addressing system and then sent the said signal to the “Fundamental Control Memory System”, the “Fundamental Control Memory System” responds to the signal from this said second data RAM system by sending this latter system a sych pulse, directing the master controller to look to the third RAM system, the one that had been directed to take in the output value from the Integer Adder, to see if it had completed its storage of the data. The master controller does this by once again releasing the “Primary Bit-Slice Feedback Programmed Memory System” from one tight non-action loop and placing this said “Primary Bit-Slice Feedback Programmed Memory System” into another after, of course, one clock cycle of the master controller's clock. Then the master controller repeats the above checking process for this last RAM system, the one storing the result from the Integer Adder. Upon the receiving of the completion signal from this third RAM system, it then releases the “Primary Bit-Slice Feedback Programmed Memory System” from the tight loop one last time, at least during the execution of this instruction.

Then on the next clock pulse sent to the “Primary Bit-Slice Feedback Programmed Memory System”, the “Fundamental Control Memory System” enables the data output system for the program RAM system. This allows the program RAM system to place the next instruction on the appropriate data transfer subsystem of the “Data Input/Output Bus.” But when the “Fundamental Control Memory System” enables the output for this program RAM system it must, at the same time, disable the output of the data RAM system that was using the same said data transfer subsystem to feed data to the Integer Adder. Then the “Fundamental Control Memory System” sends, in this same clock cycle, a signal to the multiplexer of the “Primary Bit-Slice Feedback Programmed Memory System” to switch from the direct feedback loop to the large scale feedback loop; It thereby prepares the overall master controller to accept the next instruction, which will happen when the master controller's clock sends its next clock pulse to the “Primary Bit-Slice Feedback Programmed Memory System.”

Now the other set of single integer addition instructions to be found in this best mode application of this new type of general purpose FIS processor unit of claims (2) and (6) is where the RAM systems that are providing the input data to the Integer Adder are not stepped forward by one. The execution of this set of instructions is simpler than that of the above. For rather than going off and sending signals to these said data RAM systems after the Integer Adder has grabbed its data, all that the “Fundamental Control Memory System” needs to do is to place the “Primary Bit-Slice Feedback Programmed Memory System” into a tight non-action loop and have the overall master controller wait for the Integer Adder to complete its task. Then when the Integer Adder completes its task, the “Fundamental Control Memory System” releases the “Primary Bit-Slice Feedback Programmed Memory System” from the tight loop that it is in. Then on the next clock cycle, the master controller triggers the data RAM system that is to take up the result of the Integer Adder and then waits for its completion. But at no point does the master controller need to wait for the data RAM systems that output data to the Integer Adder to complete any task. Then on receiving the signal indicating that the data RAM system has taken up the data from the Integer Adder, the master controller sets itself up so as to receive the next instruction.

Now as for the second class of integer adder instructions, those instructions that direct this general purpose FIS processor unit of claims (2) and (6) to carry out one of the five different types of block additions-that of a given number of 16 8-bit additions, a given number of 8 16-bit additions, a given number of 4 32-bit additions, sets of 2 64-bit additions or a given number of 1 128-bit addition-the master controller will, to carry out this function, use as its core set of actions those actions that were just described in the above given process; that of the first of the two types of single integer additions; that of where the data RAM systems that feed data to the Integer Adder is stepped forward by one after the Integer Adder has grabbed the said data. But in these block integer addition processes, there will be several additional steps added to this core process.

And the first of these new steps will come immediately after the “Primary Bit-Slice Feedback Programmed Memory System” takes in the operational code (Op. Code) for the instruction. What happens in this next new step is that the “Fundamental Control Memory System”, once it receives the next feedback number from the “Primary Bit-Slice Feedback Programmed Memory System”, sets up its output control lines to the value that will, upon being received by the program RAM system, direct this latter system to step its active addressing system forward by one, then output the information at that memory location onto the appropriate data transfer subsystem of the “Data Input/Output Bus.”

Then on the next clock pulse from the master controller's clock to the “Primary Bit-Slice Feedback Programmed Memory System”, the “Fundamental Control Memory System” sends a trigger signal to the local clock system for the program RAM system while holding its output control line values steady. Once the local clock system for the program RAM system is set into action, which sets the overall program RAM system into action, the “Fundamental Control Memory System” enables the program RAM output system to output its data onto the appropriate data transfer subsystem of the “Data Input/Output Bus.” This number that the program RAM will put out is the number of integer additions the master controller is to carry out.

And this value that has now been placed on the the appropriate data transfer subsystem of the “Data Input/Output Bus” will be transferred to the appropriate hold register, or small memory system within the master controller (the operation of which was explain earlier in this patent application) when the master controller's clock sends its next pulse to the “Primary Bit-Slice Feedback Programmed Memory System” and the next feedback number is sent to the “Fundamental Control Memory System.” And this taking up of this number by the hold register/small memory circuit is achieved by the “Fundamental Control Memory System” sending a clock pulse to this said hold register/small memory circuit.

The next set of actions that will need to be added to the single integer addition process is at the end of the sequence of actions; once one set of integer numbers have been added together and the results of that addition have been stored in a Data RAM system and the addressing value for that said Data RAM system has stepped forward by one. And what now happens in a block integer adder instruction is that the value stored in the above mentioned hold register/small memory circuit is reduced by one.

Then if the value in the hold register/small memory circuit has reached the set point value, which in this best mode application of this new type of computer will be zero, this said hold register/small memory circuit sends a positive signal to the “Fundamental Control Memory System” which then directs this latter system to configure the master controller so that the next instruction from the program RAM system can be brought in and carried out. But if the value in the hold register/small memory circuit has not yet reached the value of zero, the set point, this said hold register/small memory circuit sends a negative signal to the “Fundamental Control Memory System.” Then upon receiving this negative signal, the “Fundamental Control Memory System” directs the “Primary Bit-Slice Feedback Programmed Memory System” to return to the beginning of the sequence of this block integer addition, to the point where the said master controller triggers the Integer adder to grab data off the appropriate data transfer subsystems of the “Data Input/Output Bus” so that the next integer addition can take place.

And thus in this way the master controller carries out as many additions as the value first received by the hold register/small memory circuit when this block integer addition instruction was first begun.

Change Addressing for RAM

The next function that the master controller must be able to accomplish is that of setting up addressing values for the various addressing systems within the various RAM systems as shown in FIG. 26. The first thing to understand about this best mode for this new computer system built around this new general purpose FIS processor unit of claims (2) and (6) is that this system will make full use of the concept of paging of RAM; which is the same technology this is found in many of the present general purpose FIS computers/microprocessors such as the present generations computers built using the present generations of x86 type microprocessors.

Also, this best mode application of this new type of computer built around the general purpose FIS processor unit of claims (2) and (6) is that this system will be able to operate under several different modes (i.e. kernel mode and application mode). What mode the system is working under has a direct effect as to the ability of a program that is sending instructions to the said general purpose FIS processor unit to change the addressing it is using. That is, if the system is in application mode, any attempt to move outside of a given page of addressing of RAM will lead to an exception and an interrupt being sent to this processor unit. Therefore in the application mode, only those instructions that allow for movement within a given page of RAM will be accepted as viable instructions. That is, any other type of move instruction sent to this new type of general processor built in accordance with claims (2) and (6) will cause an interrupt signal to be sent to this new type of general processor. Or put another way, any other type of move instruction other than the in-page move instructions will interfere with the smooth execution of a given application program. However in the kernel mode, the processor can change any of the addressing values for any of the four sets of addressing/accessing subsystems for any of the RAM or I/O systems in this new computer system, as shown in FIG. 26,any way, including jumping from one page of RAM to another.

A second thing that needs to be understood about the process of changing the addressing values of the various RAM systems is that despite the fact that the RAM within this new computer system built around the new general purpose FIS processor unit of claims (2) and (6) will be broken up into multiple systems, as explained above and shown in FIG. 26, all of these various sequences of RAMs will, for addressing purposes, be treated as one long continues sequence of RAM. In order to do this in this best mode application, to treat these various RAM systems as one long RAM sequence, the three most significant bits of the total thirty-two bits used for the total address value for the RAM (this best mode will be built to handle up to four billion by 128 bits of RAM) will be used within this new general purpose FIS processor unit of claims (2) and (6) to determine which of the RAM systems to access (the word “access” is used here in a different way than in the discussion given above in how the 128-bit output from this said RAM will be able to be broken up into either 8-bit words, 16-bit words, 32-bit words, 64-bit words or 128-bit words; depending upon how a given page of RAM is being used).

Now in order for this new general purpose computer system to change the page being accessed by one of the four addressing systems in one of the RAM systems, the first thing that needs to happen is that the computer be in the kernel mode. Now if the operating system is controlling this said computer system, then by default the said computer system will be in this said kernel mode. If on the other hand, this said computer system is in the application mode, then the application running in this mode will need to send an instruction to this new general purpose FIS processor unit of claims (2) and (6) to convert to the kernel mode. But when this said general purpose FIS processor converts to this mode, it will also return control of the computer system to that part of the operating system that then will change the page within RAM for the application that was running.

So regardless of the way that this said computer system comes to be operating within the kernel mode, the way the program running under kernel mode will change between pages of RAM is the same. First, the program that is doing the page changing will choice which of the four addressing/accessing systems found within each of the RAM and I/O system that needs to be modified. The way that the master controller determines this is by which of the four page changing instructions is sent to it. Each of these four page changing instructions directs the master controller to change the page value for one of the four addressing/accessing systems for a given RAM system.

As for which of the RAM systems is to be changed, that will be embedded within the addressing value that will be used to change the page. As mentioned above, the three most significant bits of the addressing value will be used within this said new general purpose FIS processor unit to determine which of the RAM systems is to be accessed.

And the exact process by which this new general purpose FIS processor unit of claims (2) and (6) will change a given page is as follows. The master controller will first receive a given paging instruction from the program being run. And based upon which of the four possible paging instructions is received, the “Primary Bit-Slice Feedback Programmed Memory System” will enter into one of four processor-program sequences. The only difference between these four sequences will be which of the four addressing systems within the given RAM system will be triggered to change.

Now there will be two different sets of RAM paging instructions. The difference between them will be based upon where the page value will come from. In the first set of RAM page changing instructions is one where the new page value will be the next value found in the next location within the program RAM system. And in this set of paging instructions, when the first clock pulse is sent from the master controller's clock to the “Primary Bit-Slice Feedback Programmed Memory System”, the “Fundamental Control Memory System” sets up its output control lines to direct the programming RAM system to advance its active addressing/accessing system by one. In this way, it will be able to access the new page value from this memory system. Then on the second clock pulse from the master controller's clock, the “Fundamental Control Memory System” triggers the clock system for the program RAM system while holding the values on its output control lines steady. In this way the program RAM system is able to output the necessary addressing page value.

On the other hand, in the second type of RAM page changing instructions, the addressing page value will be coming from a location found in one of the other RAM systems, one of the data RAM systems. The way this new addressing value will be obtained is to have the “Fundamental Control Memory System”, on the first clock pulse from the master control clock, enable the appropriate RAM system to place the necessary addressing page value on one of the three data transfer subsystems of the “Data Input/Output Bus.” The choice of the appropriate RAM system will be determined by which of the various RAM page changing instructions is sent to the master controller by the program being run.

Then once the appropriate addressing value has been output on the appropriate data transfer subsystem of the “Data Input/Output Bus,” the three most significant bits of the addressing page value will be taken in by the “Fundamental Control Memory System.” The “Fundamental Control Memory System” will then use these three bits to determine which one of the various RAM systems are to be accessed so as to change its appropriate addressing system. Then with the next clock pulse from the master controller's clock, the “Fundamental Control Memory System”, upon receiving the next feedback number, will trigger the clock system for the appropriate RAM system. Upon receiving the correct control value from the output control lines from the “Fundamental Control Memory System” and also having its clock set into action, this said appropriate RAM system will then take the given value on the correct data transfer subsystem of the “Data Input/Output Bus” and place it as the new value in the proper RAM page addressing memory in the appropriate addressing/accessing subsystem.

Then on the next master controller's clock cycle, the “Fundamental Control Memory System” directs the RAM system that is providing the addressing page value to step forward one so as to obtain the remaining part of the addressing page value. Once this has been done, the “Fundamental Control Memory System” directs the said RAM system that is changing its page value to take in the last part of the page value.

But while all of this is happening, the said appropriate RAM system that is changing its RAM page value will also zero out the twelve least significant addressing bits for its RAM addressing and also set the accessing system that is used to access the 128 bits of data output (this accessing system having been explained above) as a series of words (be that word 64 bits long, 32 bits long, 16 bits long or 8 bits long) to the least significant word. In zeroing out the twelve least significant addressing bits and accessing the least significant word, the active addressing/accessing subsystem for the given RAM system being changed is effectively moving to the beginning of the new page.

This is the means by which the page being addressed for any of the addressing/accessing subsystems for any of the RAM systems can be changed. However, if in this changing of pages, this new general purpose FIS processor unit of claims (2) and (6) attempts to access a page that does not exist in the RAM of the given RAM system. That is, this new general purpose FIS processor unit attempts to address outside the total sequence of RAM for the given RAM system being changed—then the given addressing/accessing RAM system for the given sequence of RAM will send a non-maskable interrupt to this said general purpose FIS processor unit; an interrupt signal that will indicate to the master controller that an error has occurred in the addressing/accessing process. Upon the “Fundamental Control Memory System” receiving this said unmaskable interrupt, the “Fundamental Control Memory System” will then direct the “Primary Bit-Slice Feedback Programmed Memory System” to access the appropriate interrupt program sequence found within the operating system. At that point, the handling of this error becomes a function of the operating system.

This establishes how this best mode application of this new type of computer built around the general purpose FIS processor unit of claims (2) and (6) will change RAM pages. The second aspect of addressing/accessing RAM is the ability to move about within a given page of RAM. When moving about in a given page of RAM, there is one factor that must be kept in mind; and that is that the output of the RAM is a total of 128 bits wide. Yet this 128-bits of output can, under various circumstances, which were explained earlier, be broken up into a number of different sized words: that is, 128-bit word, 2 64-bit words, 4 32-bit words, 8 16-bit words or 16 8-bit words. So as a result of handling the RAM in this way, the RAM can, in effect, be viewed as a variable sized matrix of information. As a variable matrix, the amount of words being stored within the overall matrix, which in turn is determined by the word size and the page size, will change. In the case of using all 128 bits of output as one word, a given page of information will, in this best mode application, be 4 k long. When a word size is 64-bits, then a given page of information will be 8 k long. For 32-bit sized words, the page becomes 16 k, and for 16-bit words, 32 k. Finally, for 8-bit words (such as an ASCII text page), the total page becomes 64 k.

But to accessing the RAM as a variable matrix will mean that each of 128 bits of output for each memory location within the said RAM will, under most circumstances, need to be broken down into smaller words. Under many situations, these multiple output words from RAM will need to be accessed in a sequential fashion. To do this there will be, as explained above, a separate accessing circuit within each of the RAM systems. By placing this type of accessing circuitry within the various addressing/accessing subsystems for the various RAM systems, it will free up this new general purpose FIS processor unit of claims (2) and (6) from having to keep track of which word embedded in the 128-bits output is needed for the execution of the next instruction. All that this said new general purpose FIS processor will need to do to access any given word within a given page of RAM is to send a given “addressing value” to the necessary RAM system. It will be this latter system that will go through the process of determining where within the variable RAM matrix a given word is and then serving up the correct data as needed.

And in this type of variable RAM matrix system, all that the programs that will ever run this new general purpose FIS processor unit of claims (2) and (6) will need to do in order to make proper use of this variable RAM matrix systems is to indicate to each of the RAM systems how each of their various pages will be treated; are they to store and output 128 bits words, 64 bits words, 32 bits words, 16 bits words or 8 bits words. And as for setting up these various RAM systems in this way, there will be a set of word size instructions that a program that is setting up a RAM page, generally that of the operating system, will use to direct the master controller to do this.

Also, once the said general purpose FIS processor unit and the said programs that will be run on it have made the decision as to how a given page of RAM will be used and formatted, they then must adjust their tracking of how many words can be stored in each set up page: 4 ks worth of 128-bit words, 8 ks worth of 64-bit words, 16 ks worth of 32-bit words, 32 ks worth of 16-bit words or 64 ks worth of 8-bit words.

Now as for moving about within a given variable matrix page of RAM, there will be a large number of instructions to accomplish this. But once the use of a given page has been determined-be it a 128-bit word page, a 64-bit word page, a 32-bit word page, a 16-bit word page or an 8-bit word page-the instructions for moving about within a given page will be the same regardless of what the size of the word is; again, this will be true because of the fact that the accessing of the words will be handled automatically by the accessing component of one of the four addressing/accessing systems to be found in each of the various RAM systems.

Now as for the instructions to move about within a page, to begin with, there will be a set of instructions that will direct the various RAM systems to move 1, 2, 4, 8, 16 or 32 word locations forward or backward within a given page. This is the first set of small step move instructions to be found in this best mode application of this device. However, if there is a need in the near future for any other small step addressing/accessing instructions with other stepping sizes, such as five or seven, because of the simple beauty of this type of general purpose FIS processor, one based on the claims (2) and (6), these small stepping functions can be easily added to the system. All that needs to be done is to add the necessary programming to the “Primary Bit-Slice Feedback Programmed Memory System” and the “Fundamental Control Memory System” and then make sure that all of the various addressing/accessing systems for all of the various RAM systems can respond to the new control values that the master controller can send to it, and that is it. As for how long it will take to carry out these types of small step addressing/accessing instructions, all of them, regardless of the magnitude of move, will be completed within four cycles of the master controller's clock.

The second type of addressing/accessing change that is possible in this best mode application of this new type of general purpose computer is those that involve an absolute move within a given page. That is, a sixteen bit word (of which 12 bits will be used for a 128-bit word page, 13 bits will be used for a 64-bit word page, 14 bits for a 32-bit word page, 15 bits for a 16-bit word page or 16 bits for an 8-bit word page) will be passed to one of the various RAM systems. Then the active addressing/accessing subsystem for that given RAM system that is undergoing the addressing/accessing change will take that sixteen bit word and translate it into an absolute location within the given page. When this set of addressing/accessing instructions is combined with the set of instructions that allow for a change from one page to the next, this computer system then has the ability to access any memory location within RAM; of course, this full translation of location within a given RAM system can only be done when the said computer system is in the correct mode: that of the kernel mode and/or Real mode.

The third way in which a change of address/access within a given page of RAM can be achieved is by relative addressing. As for how these instructions work, it begins by having the master control first direct the RAM system that is to be changed to output its present address/access value for the page that it is in. Then the master controller then directs one of the other systems, most likely the program RAM system, to output an offset value. Then these two numbers—the present addressing/accessing value the said RAM system and the offset value—will be passed through the integer adder. Then the product of this integer addition is passed back to the active addressing/accessing system for the RAM system that is undergoing an addressing/accessing change. Upon receiving this value, the given RAM system that is undergoing change will handle this number in the same way that it handled the absolute address change; plugging the value directly into the active addressing/accessing subsystem.

And as for the offset value, it will be in a twos complement form. And if it is not in a twos complement form, it will be passed through the twos complement form before being passed to the Integer Adder. As will all distinctions within a FIX general purpose processor, the way the offset value is to be handled will be determined by the given instruction sent to this said FIX general purpose processor.

And thus being able to add these said two numbers together (the offset and the previous page addressing value) and then loading the result back into the appropriate addressing/accessing subsystem within the appropriate RAM system, this computer is able to offset the addressing/accessing value for any given RAM system.

Executing Comparison

As for carrying out a given set of comparisons (i.e. 16 8-bit comparisons, 8 16-bit comparisons, 4 32-bit comparisons, 2 64-bit comparisons or 1 128-bit comparison), the master controller of this new overall general purpose FIS computer must contend with the same two operational aspects in carrying out a comparison as it did with executing one of the many different types of integer additions. And the first of these is that of proper controlling and stepping through of the that of the RAM that is providing the data to the comparator.

As for the actual execution of a comparison of a given set of numbers (i.e. 16 8-bit comparisons, 8 16-bit comparisons, 4 32-bit comparisons, 2 64-bit comparisons or 1 128-bit comparisons), the master controller will trigger the bit-slice controller unit for the Comparator in the same manner as it triggers the bit-slice controller unit for the Integer Adder; setting the proper values on its output control lines and then releasing the clock for the bit-slice feedback memory controller for the ALU component to be used.

Then the final aspect of how the master controller directs the carrying out of one or more sets of comparisons is in the order in which this said master controller actually triggers the various systems, from changing the addressing and access to RAM to that of triggering the Comparator. And the order in which this is done is the same as that of the Integer Adder, but with one modification.

And that modification is that the result produced by the Comparator is a simple set of truth values; values that tell whether or not the various numbers that were compared were the same or not; or whether one number was greater than the other. And in general, this new type of computer built around the general purpose FIS processor unit of claims (2) and (6) has only one use for these truth values, to pass them on to the master controller so that the master controller can use them in performing conditional jumps. But rarely is there a need to save these truth values to RAM.

So as a result of how the output of the Comparator will normally be used, that of being the first step in the two step process of a conditional jump, the master controller will, in its most common use of the Comparator, need not trigger one of the RAM systems within the “Rest of General Purpose FIS Computer” to take and store the resulting output of the said Comparator.

But it should be stated that if there is, for whatever reason, a need to save into RAM the truth values from the Comparator, that there will be within the instruction set of this best mode application of this new type of computer built around the general purpose FIS processor unit of claims (2) and (6) an instruction that will direct the master controller to do just this; to save to one of the data RAM systems the result from the comparison. And to carry this out, all that will be done different from that of the standard compare instructions is to activate the output buffer for the Comparator so that the truth values can be placed on one of the data transfer subsystems of the “Data Input/Output Bus.” Then an additional step in the processor-program sequence will be added so that one of the data RAM systems shown in FIG. 26 will be directed to take in these truth values and then step forward to the next memory location.

Executing Twos Complement

Now as for carrying out the Twos Complement function, the initial sequence by which the master controller will do this is nearly identical to that of performing an integer addition. The only difference is in the initial steps of this process. For the Twos Complement unit will only need one set of numbers (i.e. 1 128-bit number, 2 64-bit numbers, 4 32-bit numbers, 8 16-bit numbers or 16 32-bit numbers) to be sent to it rather than two sets of numbers used by the Integer Adder. So as a result of this, the master controller will need to only activate the output buffer for one data RAM systems, and if necessary the said RAM systems active addressing/accessing subsystem, to provide data to the Twos Complement.

Also, once the Twos Complement Unit has completed its task, its output can be used in one of two ways. The first is that, as explained in how this new general purpose FIS processor unit of claims (2) and (6) will carry out subtractions, the output from the Twos Complement Unit can be sent directly to the Integer Adder; so as to complete a subtraction. The second use of the Twos Complement Unit is to simply convert one or more sets of numbers to their negative counterpart and then stored back into RAM. And so in this case, the output from the Twos Complement Unit is sent to one of the data RAM systems for storage rather than being incorporated into an integer subtraction. In this latter case, the sequence of actions carried out by the master controller will be very much the same as that of the sequence used in performing one or more sets of integer additions.

Also it must be noted that the use of this Twos Complement Unit, like the use of the integer Adder, can be run as part of a block instruction; that is, a whole sequence of numbers can be converted to their twos complement in one long sequence, a sequence that will be coordinated out by the master controller. And the way that the master controller would do this is to use the same basic method as it applied in carrying out of a block of integer additions. That is, the master controller will use its hold register/small memory circuit to count through the number of sets of numbers that need to be converted. The only difference between a block of integer additions and block of twos complement conversions is that in the latter process, the Twos Complement unit will be triggered each time rather than the Integer Adder.

Executing Incremention/Decremention

The process by which a given word or set of words (2 64-bits words, 4 32-bits words, 8 16-bits words or 16 8-bits words) will be incremented or decremented will be achieved in this best mode application of this new computer constructed around this new general purpose FIS processor unit of claims (2) and (6) by a process nearly identical to that of carrying out any of the other various integer addition instructions. The only difference that will exist between these two classes of instructions is that rather than having both sets of numbers fed to the Integer Adder from two of the various data RAM systems, one of the numbers will come from a specially constructed ROM; a ROM that, when instructed by the master controller, will output either the appropriate set of positive ones or the appropriate set of negative ones out over one of the two data transfer subsystems for the “Data Input/Output Bus” that is feeding data to the Integer Adder. But other than this change in the source of one of the data streams fed to the Integer Adder, the process of incrementing or decrementing of a given number will, from the prospective of the master controller, be identical.

Executing Right/Left Shifting-Right/left Rotation

The master controller's utilization of the Right/Left Shifting-Right/left Rotation Unit will follow the same pattern as that of the Twos Complement. The primary difference between the use of these two components of the ALU by the master controller is in the code that is send to each of these units. The code sent to the Shift Right/Left Rotate Left/Right Unit will not only need to tell its bit-slice feedback memory system the size of the numbers to be modified: 1 128-bit number, 2 64-bit numbers, 4 32-bit numbers, 8 16-bit numbers or 16 32-bit numbers. But the code must also tell this said bit-slice feedback controller whether the process is to be a shift left arithmetic, shift right arithmetic, shift right logical, rotate left through carry, rotate left with branch carry, rotate right through carry or rotate left with branch carry.

And also, like all of the above mentioned executable functions, the master controller will be able to carry out block Shift Right/Left Rotate Left/Right based upon the value taken in by the master controller and stored into its hold register/small memory circuit. But in this case, there will actually be two kinds of block shifts/rotates.

The first of these will allow this best mode application of this new type of general purpose computer built around the FIS processor unit of claims (2) and (6) to either rotate or shift a given set of number a given number of time to either the left or to the right. But to do this, the output from the previous shift or rotate will need to be fed back into this Shift Right/Left Rotate Left/Right unit. And this aspect of this block function is different from all of the other block functions. And the master controller will need to coordinate this interplay of movement of data between input and output of this component of the ALU.

The the second type of block Shift Right/Left Rotate Left/Right is like all of the other block functions. It will systematically take data from a data RAM system, Shift Right/Left or Rotate Left/Right the data once and then place it back into another data RAM system.

But both of these block Shift Right/Left Rotate Left/Right functions will make use of the master controller's hold register/small memory circuit to count the number of actions the master controller is take.

Executing AND, OR or XOR

As explained above, the AND, OR and XOR circuit will not include a bit-slice feedback memory circuit. Rather the master controller's external control lines will be fed directly into a hold circuit that will, in its turn, directly feed into the bit-mapping circuitry of the AND, OR and XOR system. And with this change, the master controller will be in direct control of the bit-mapping circuitry that makes up this component of the ALU. But like the execution of all of the other above discussed instructions, this one will begin by making assure that the necessary data from the appropriate RAM system has been placed onto appropriate data transfer subsystem of the “Data Input/Output Bus.” Once this has been done, the master controller simultaneously triggers the input data hold circuit within the overall AND, OR and XOR circuit and the hold circuit that will hold the control code for the AND, OR and XOR circuit; that code that will be used by the AND, OR and XOR's bit-mapping circuitry to determine which of these three types of functions is to carry out: AND, OR or XOR.

At this point the “Primary bit-slice feedback Programmed Memory Systems” for the master controller will pass through an adequate number of non-action or null states (a null state being one where the “Fundamental Control Memory System” does not output any “active” signals to any of the systems and subsystems of this new type of general purpose computer). And this passing through of a number of null states will allow the bit-mapping circuitry for the AND, OR and XOR to have time to complete its calculation; that is, to properly settle out. And in all likelihood, having the master controller pass through just one null state will be enough to allow this said bit-mapping circuitry to complete its task.

Finally the master controller, in the next clock cycle after the last of these null states will cause the master controller to enable the AND, OR and XOR circuit to output its result onto the appropriate data transfer subsystem of the “Data Input/Output Bus.” Then after this has been accomplished, the master controller will direct the correct RAM system, the RAM system that is to store the result, to take up and store the data.

Then the final steps in the execution of an AND, OR or XOR instruction, the master controller sees to the stepping forward of all of the RAM systems involved in providing data to the AND, OR and XOR circuit, just as it did when executing the first type of single integer addition. Then finally, in the closing step in the execution of this AND, OR or XOR instruction, the master controller directs the program RAM system to step forward by one and then send the next instruction to itself. At which point the master controller goes on to execute this next instruction.

The master controller will also be able to do block ANDs, ORs or XORS. And to do so, it will follow the same basic procedure that it used in the block integer additions and the block Twos Complement function. It will take in and store into its hold register/small memory circuit the number of shifts/rotations it is to perform. Then after carrying out each of logic functions, the value in this said hold register/small memory circuit will be decremented and the process continued until the said value within this said hold register/small memory circuit reaches the set point of zero; at which point the master controller will then move on to the next instruction.

Executing Bit-Manipulation

The sequence of carrying out a given set of bit-manipulations is the same as the sequence for executing a Twos Complement. The only difference is rather than activating the Twos Complement Unit, the proper code to carrying out a given set of bit-manipulations is sent to the Bit-Manipulation component of the ALU and then it is triggered into action. But the basic pattern of operation for the master controller is the same to carry out a bit-manipulations is the same.

Also, like all of the other functions within this new general purpose FIS processor unit of claims ( 2) and (6), this function of manipulating bits, and sets of bits, can be performed in block mode. And the means by which this is accomplished is the same as all of the other functionality carried out in block mode. A given value is brought into the hold register/small memory circuit within the master controller. Then the master controller will carry out as many sets of bit manipulations as indicated by the initial number stored in the said hold register/small memory circuit.

Closing Remarks

This is a utility patent. And its purpose is to provide protection of the basic technological concepts upon which a whole new series of general purpose FIS computers can be based. Thus, the aim of the best mode application within this patent application is to show and explain to anyone conversant with both the present structure and architecture of the present generations of general purpose FIS processors (those that use logic circuitry to implement its overall functionality) as well as the above mentioned techniques of bit-mapping processes and bit-slice feedback programming that a viable new computer constructed around this new general purpose FIS processor unit of claims (2) and (6) can be created; thus showing that claim (1) has immediate practical utility with regards to providing a new option to the computer industry in how general purpose FIS computer can be built.

And that is what has been shown in this best mode application section; that a fully functional integer based computer system constructed around a general purpose integer based FIS processor unit conforming with claims (1), (2) and (6) can be so created.

Now as for the added functionality that can be found in many of the present general purpose FIS processors constructed from logic gate—such thing as all of the functionality associated with the math-coprocessor: things like integer multiplication and division, floating point arithmetic and trigonometric calculation—all of these added features can, without great difficulty, be created and implemented within a a general purpose FIS processor unit conforming with claims (2) and (6). That is, all of this functionality can be produced by way of bit-mapping processes and bit-slice feedback programming without the need to resort to the use of logic circuitry (i.e. AND gates, OR gates, XOR gates, NAND gates and the like) except, if necessary, with regards to the addressing system of the memory circuits.

But as for satisfying the need for this more advance mathematical functionality within this best mode general purpose FIS computer/processor unit conforming with claims (2) and (6) being presented in this best mode application, they will be achieved by applying the techniques used in the all of the past and present integer based processors, such as that of the Z80. That is, integer multiplication and division, floating point arithmetic and trigonometric calculation will be done in this best mode application of this new type of computer through software subroutines and functions that will, for the most part, be a part of the operating system.

And so this then explains in basic terms, and from basic principles, how a series of subsystems and circuits shown in FIGS. 1, 2 and 26, and composed of bit-slice feedback programmed memory circuits as well as bit-mapping processes embedded in memory circuits, can do everything that a fully functional general purpose FIS microprocessor built from a vast multiplicity of logic circuits consisting of and and/or or gates, shift registers, flip-flops and the like can do, and much more.

1-94 (canceled)

95. A processor unit, comprising:
an input/output system;
a computing system coupled with the input/output system, wherein the computing and control systems are substantially comprised of core memory circuits.

96. The processor unit of claim 1, wherein the core memory circuits are cascaded together.

97. The processor unit of claim 1, wherein the core memory circuits are nonvolatile.

98. The processor unit of claim 1, wherein Arithmetic and Logic Unit functionality is provided substantially by lookup tables substantially comprised of core memory circuits.

99. The processor unit of claim 1, wherein the core memory circuits include code to perform arithmetic functions.

100. A computer system comprising:
a processor unit having a computing system substantially comprised of memory feedback microcontrollers (memory-based finite state machines);
an input/output system coupled to the processor unit via one or more data busses; and
a main memory subsystem coupled to the processor unit and the input/output system via said data busses.

101. The computer system of claim 6, wherein the memory feedback microcontrollers (memory-based finite state machines) include core memory circuits.

102. The computer system of claim 6, wherein the memory feedback microcontrollers (memory-based finite state machines) include microinstructions that perform processing functions.

103. The computer system of claim 6, wherein the control circuitry for said input/output system and said main memory subsystem are substantially comprised of core memory circuits.
